(19) United States
(12) Patent Application Publication
(10) Pub. No.: US 2012/0054114 A1
(43) Pub. Date: Mar. 1, 2012

(54) Method and system for projecting regulated development outcomes

(76) Inventor: Theodore G. Sorensen, Los Altos, CA (US)

(21) Appl. No.: 13/066,472

(22) Filed: Apr. 15, 2011

Related U.S. Application Data
(60) Provisional application No. 61/343,142, filed on Apr. 22, 2010.

(51) Int. Cl. G06Q 50/16

(52) U.S. Cl. 705/306; 705/315

(57) ABSTRACT

A method and system are provided to aggregate real estate data, apply one or more factors based on regulations associated to a real estate development or redevelopment, analyze the projected cost of the development or redevelopment of the real estate in view of the applied factor(s), and determine the economic feasibility of a development or redevelopment project.

### CROSS-REFERENCE TO RELATED PATENT APPLICATION

This application relates to U.S. Provisional Patent Application No. 61/343,142 filed on Apr. 22, 2010, entitled METHOD AND SYSTEM FOR PROJECTING REGULATED DEVELOPMENT OUTCOMES, which is hereby incorporated herein in its entirety by this reference.

### BACKGROUND OF THE INVENTION

1. Field of the Invention

The present invention relates generally to development or redevelopment of real estate and, more particularly, to a method and system for determining the economic feasibility of a real estate project in view of constraints imposed by governmental building regulations. One example of the present invention provides a method and system for aggregating real estate data, applying one or more factors based on regulations associated to the real estate development, analyzing the projected cost of the development or redevelopment of the real estate in view of the applied factor(s), and determining the economic feasibility of the development or redevelopment project. Another example may also determine the effect of changes in those regulations on the development potential of specific parcels. This information can be used to simulate one or more development scenarios of a district, city, or county. From this data, and the projected development scenario, revenue streams can be projected for government unit needs.

2. Description of the Prior Art

Today, the pain point is that cities or other governmental entities spend hundreds of thousands of dollars to revamp their vision of real estate development or redevelopment or to define what they want their city or other region to look like. Then they wait 10 to 15 years to “give it a chance” to work. Often, this approach does not work, and they start the process over again.

By way of example, Menlo Park, Calif. has just spent $750,000 to examine its options, and those options have no chance to work. As it is, it will undoubtedly make changes, but it will likely get no viable result.

The problems faced by Menlo Park are not unique to cities and counties or other governmental entities across the United States that regulate real estate development or redevelopment projects. Thus, it would be desirable to provide a method and system which overcome the above problems that may be encountered by planners who oversee real estate development and redevelopment projects. It is to this end that the present invention is directed. The various examples of the present invention have many advantages by providing a method and system to assess the economics of potential real estate projects in consideration of the regulations that apply to such projects to ascertain whether or not they are economically workable.

### SUMMARY OF THE INVENTION

One example of the method and system in accordance with the present invention provides many advantages in resolving economic feasibility problems encountered by governmental regulators and ultimately by potential developers in connection with planning a development or redevelopment project, which make the method and system in accordance with the present invention useful to governmental planners, as well as developers which would be subject to regulations impacting a development or redevelopment project. One example of the present invention provides a planning method and system that solve the above problems while incurring little cost or risk to planning authorities. With the planning tool in accordance with the present invention, a governmental planner may understand the economics that determine the feasibility of a real estate project that is contemplated and how the economics are affected by regulations that apply to the potential project.

Considered in more detail, one example in accordance with the present invention provides a method and system for aggregating real estate data, applying one or more factors based on regulations associated to a real estate development or redevelopment, analyzing the projected cost of the development or redevelopment of the real estate in view of the applied factor(s), and determining the economic feasibility of the development or redevelopment project. The principles of the present invention can similarly be applied to other types of projects.

The foregoing and other objects, features, and advantages of the present invention will become more readily apparent from the following detailed description of various examples, which proceeds with reference to the accompanying drawing.

### BRIEF DESCRIPTION OF THE DRAWING

The various examples of the present invention will be described in conjunction with the accompanying figures of the drawing to facilitate an understanding of the present invention. In the drawing:

FIG. 1 is an example of an analysis of an individual property in accordance with one example of the present invention to generate the output needed to project development outcomes; and

FIG. 2 is an example of a database and the overall analysis of 25 properties in accordance with another example of the present invention to generate the output needed to project development outcomes.

FIG. 3 is a block diagram of a planning system in accordance with one example of the present invention.

### DETAILED DESCRIPTION OF THE EXAMPLES

By way of example, but not limitation, the real estate development or redevelopment method in accordance with one example of the present invention comprises a plurality of process steps. In terms of creation of the planning tool, creating a property record or database of property records will allow one to “keyboard” the property data. Alternatively, this data may be imported from a current existing database. Preferably, the property record or database is configured in a way that enables the property record or database to be updated. Also, the property record or database is preferably accessible online, which allows data to be updated or the property record or database to be populated remotely. This will also allow testing of the interface and minimize the application development effort.

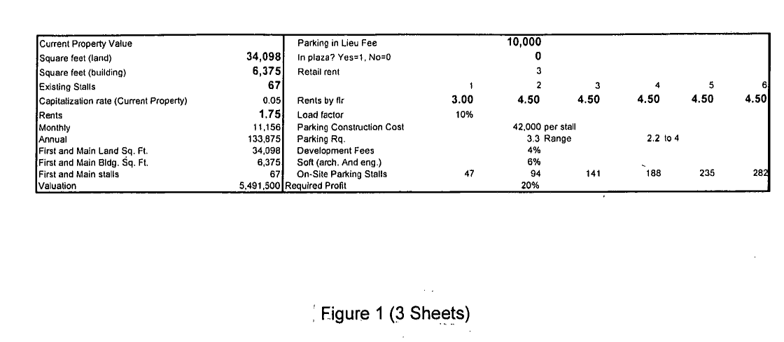

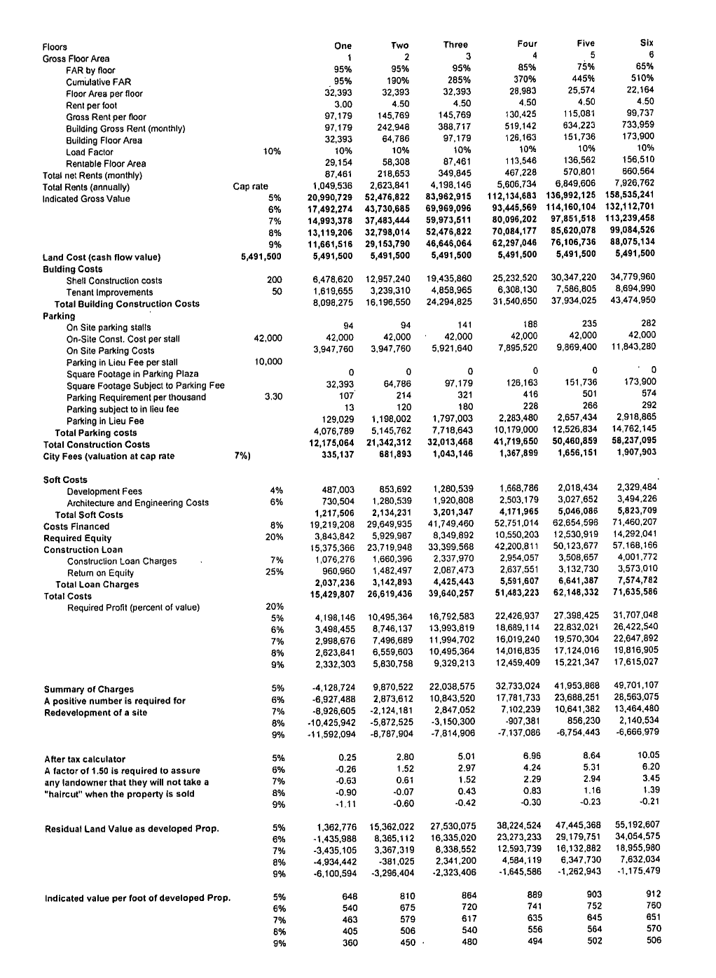

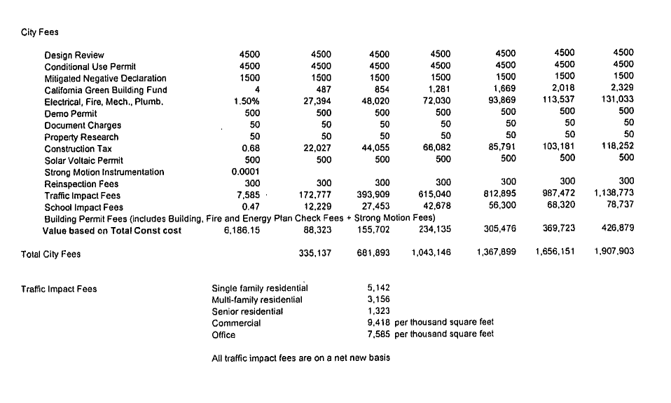

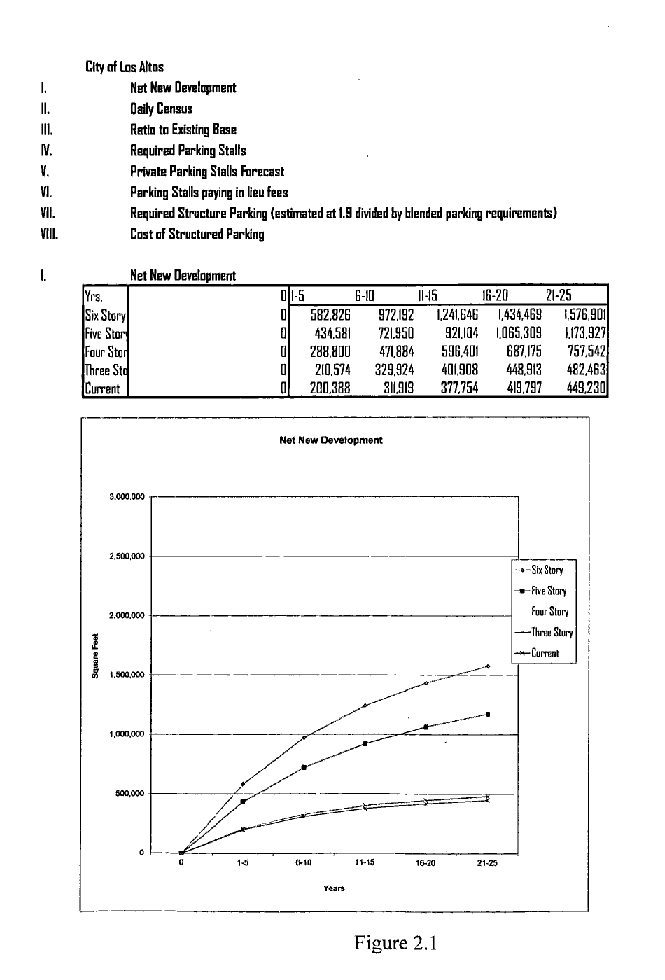

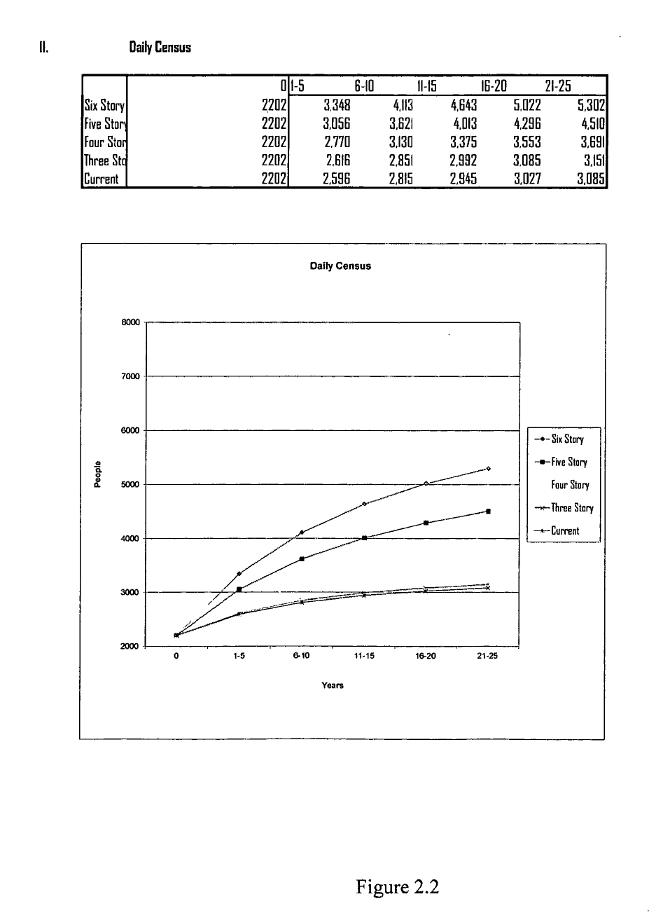

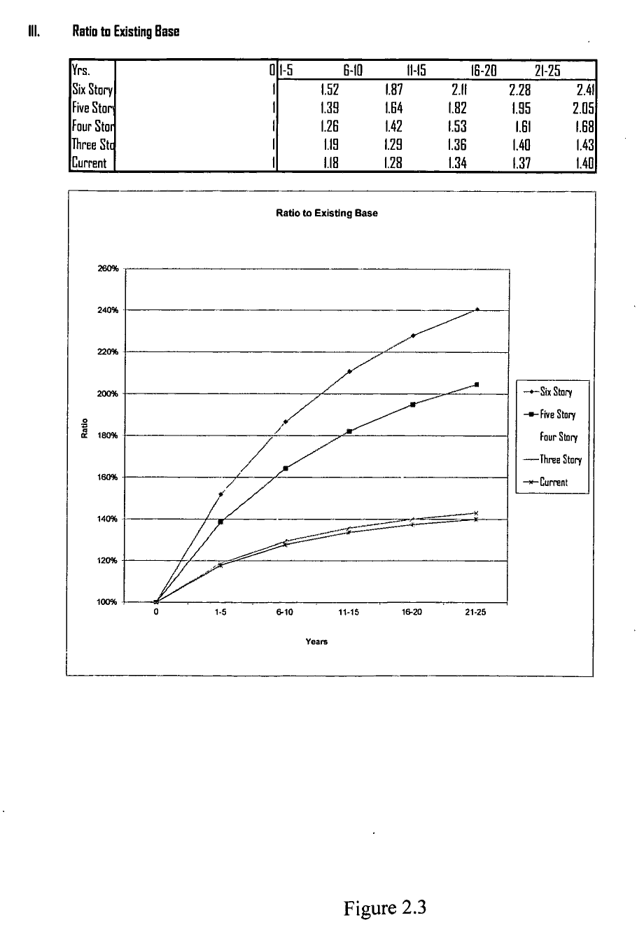

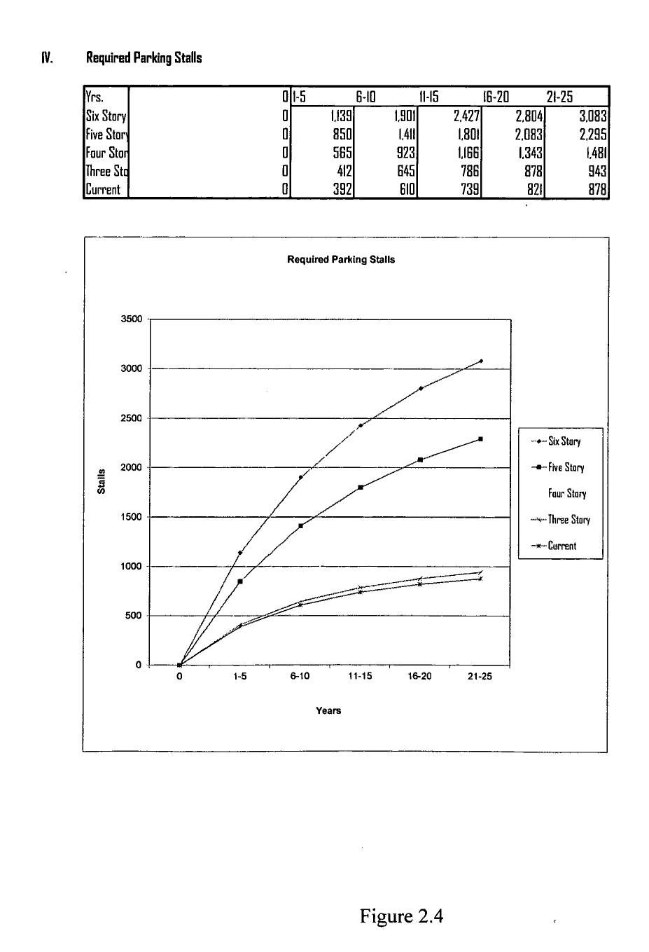

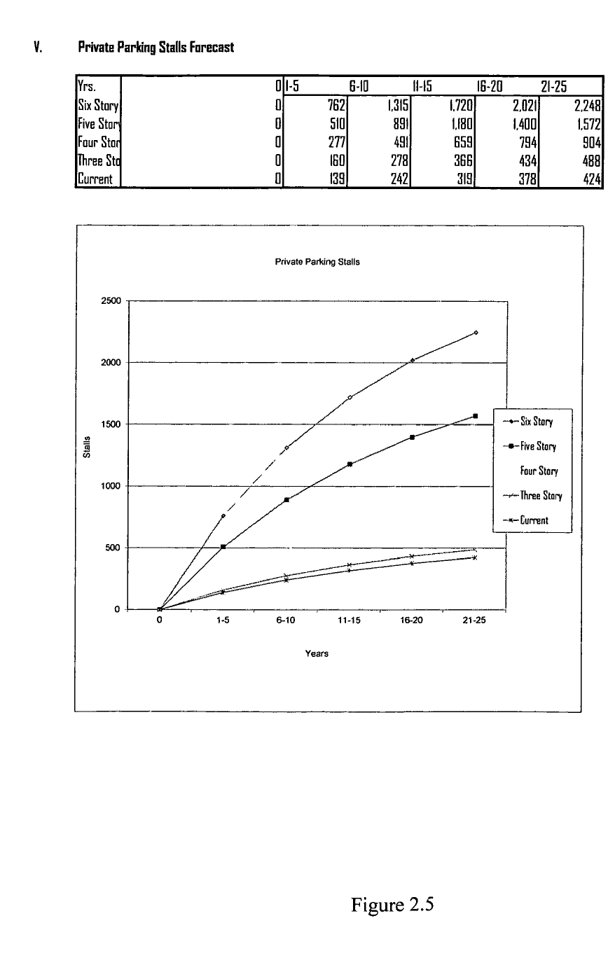

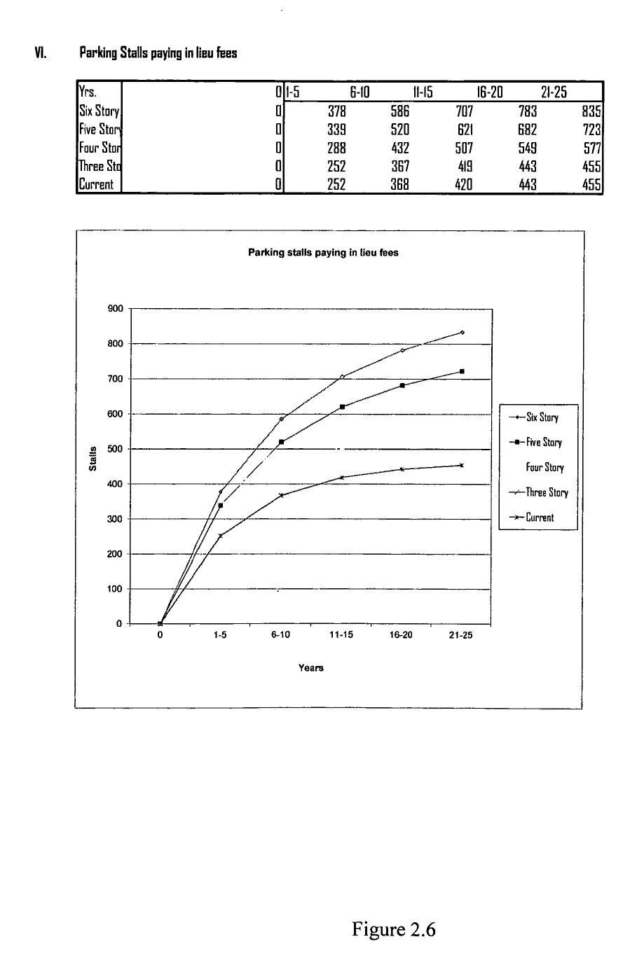

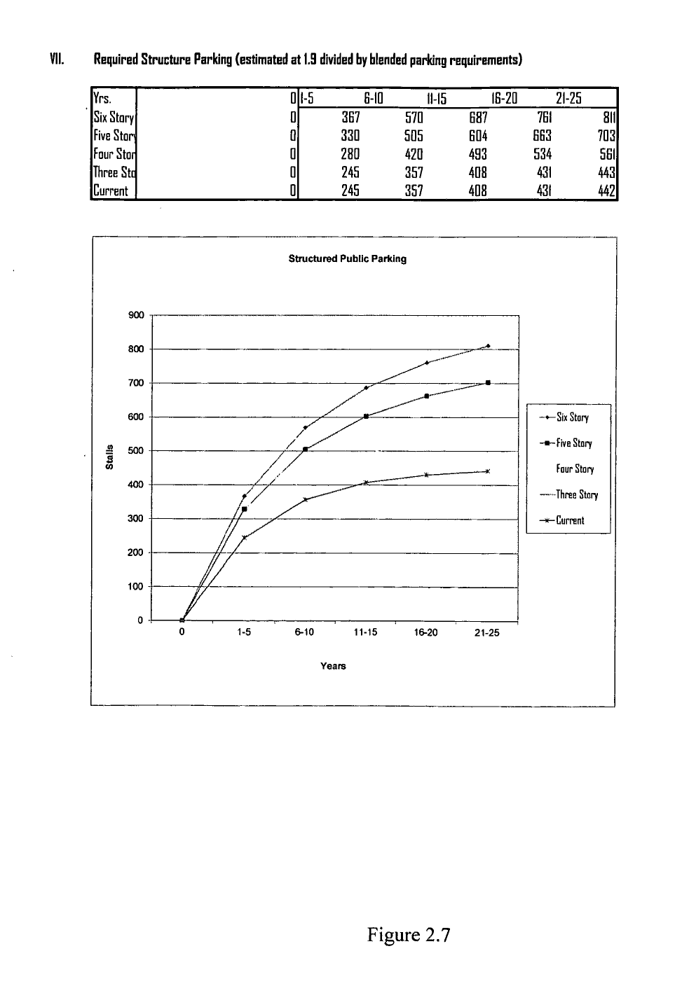

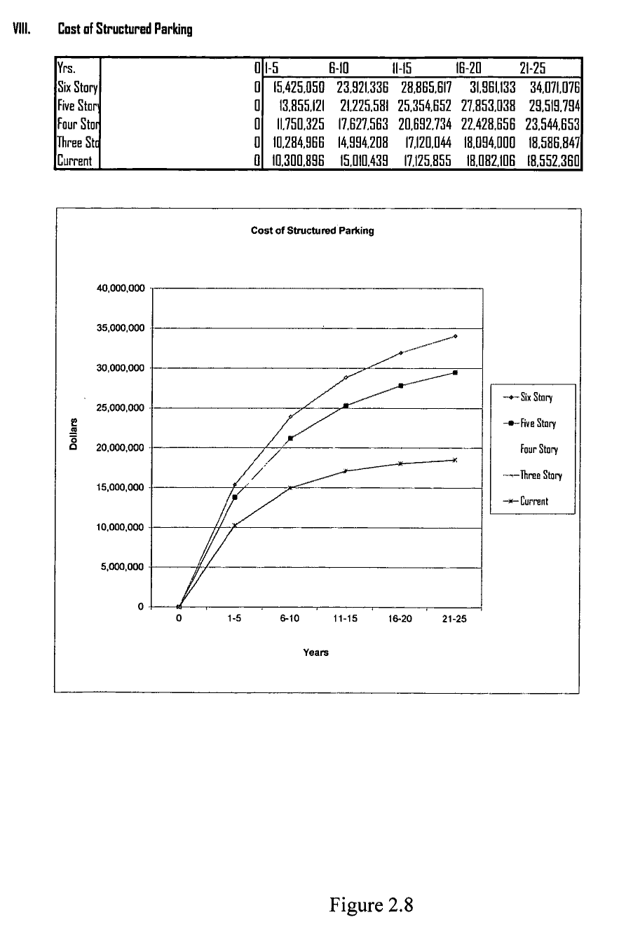

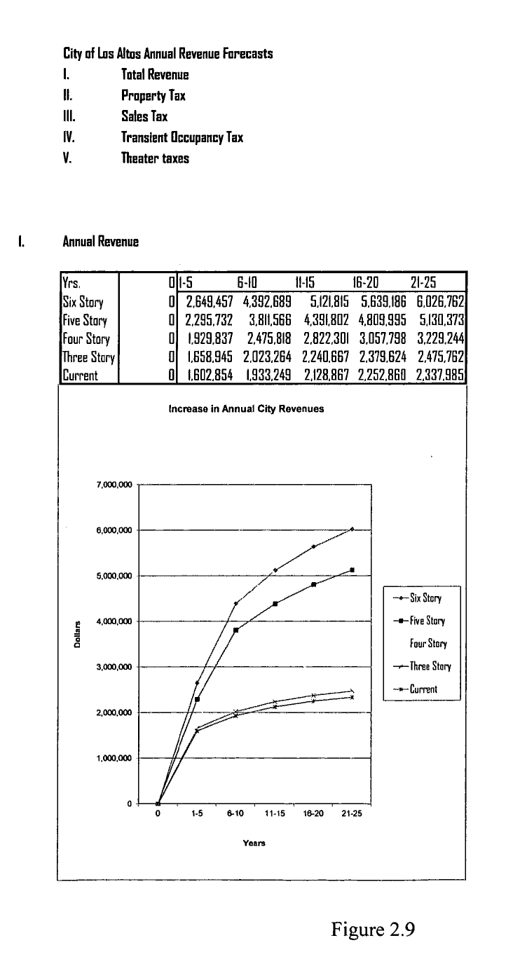

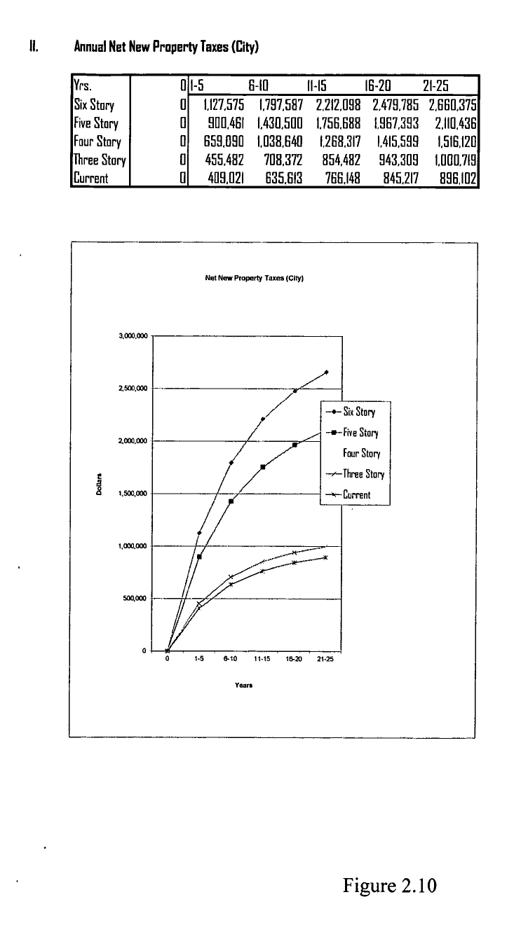

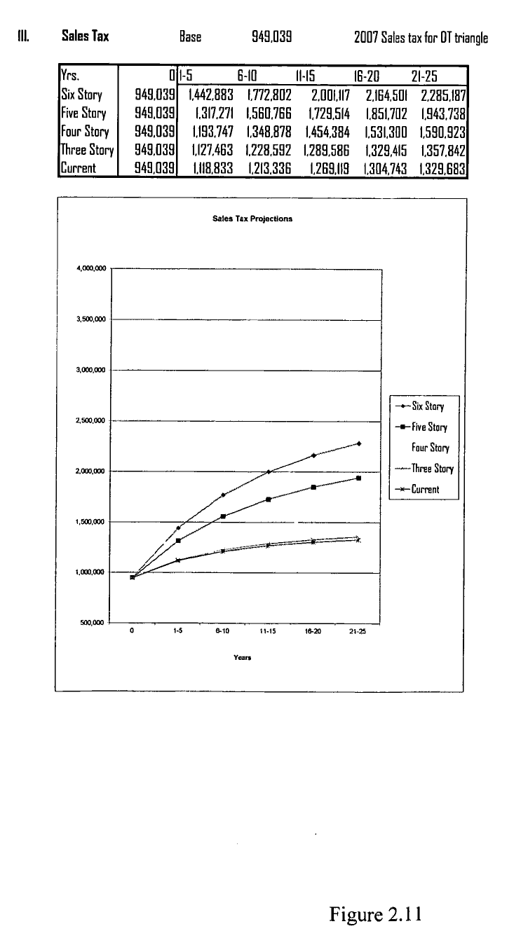

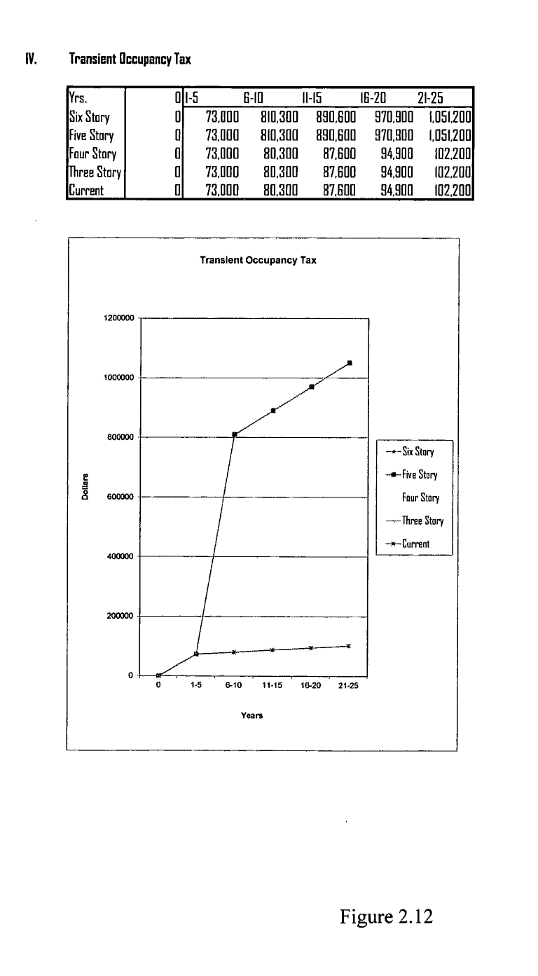

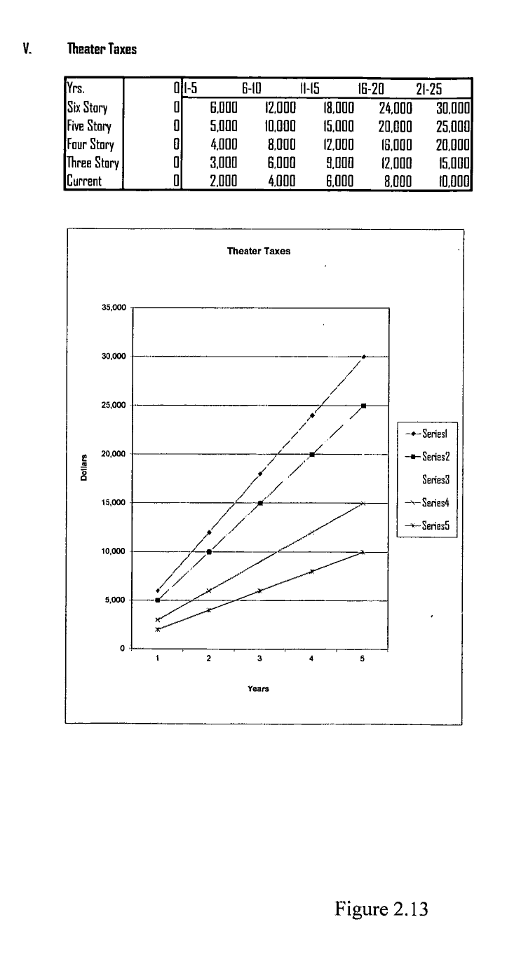

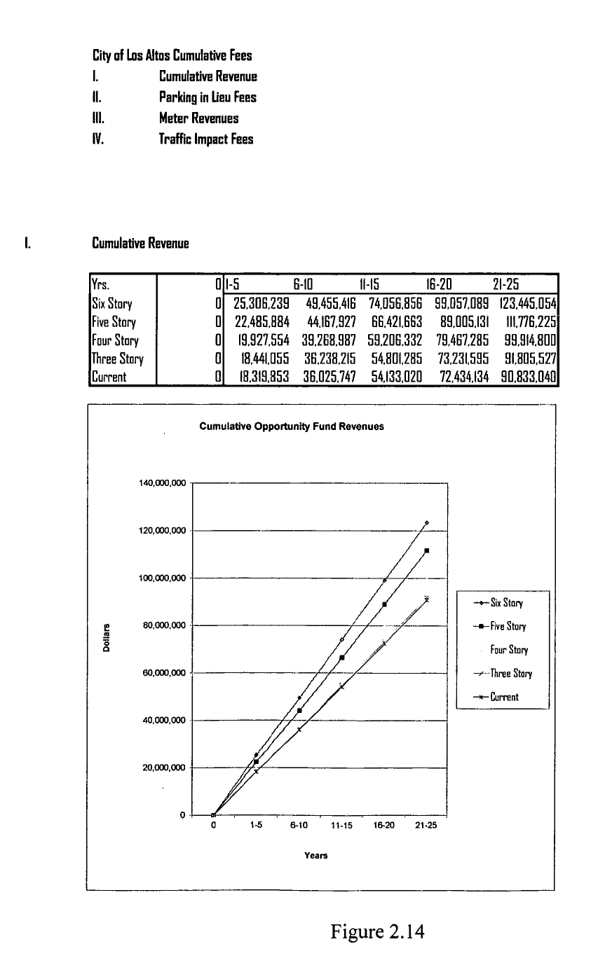

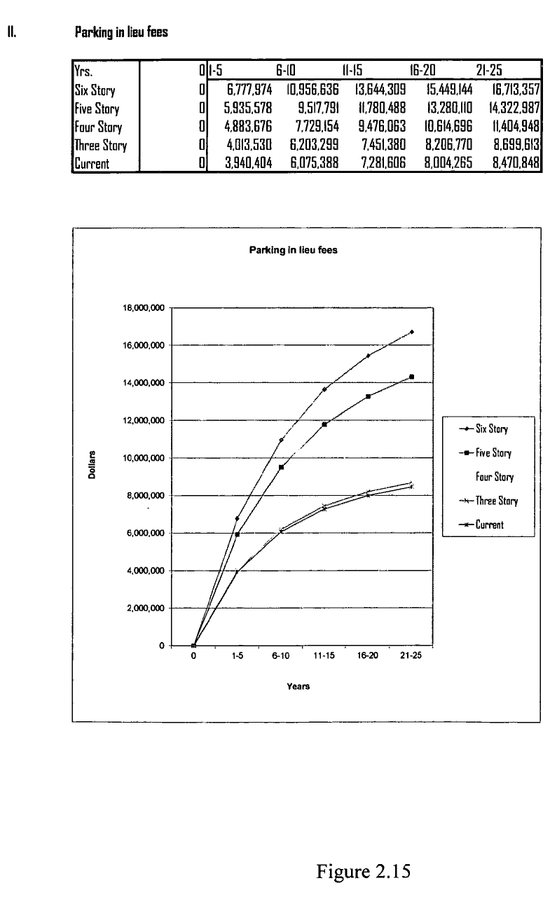

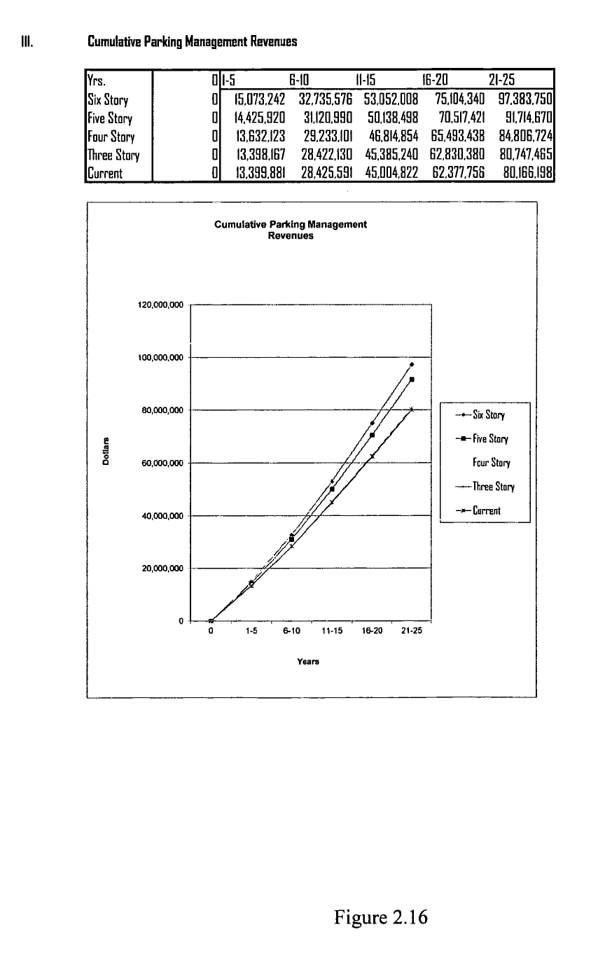

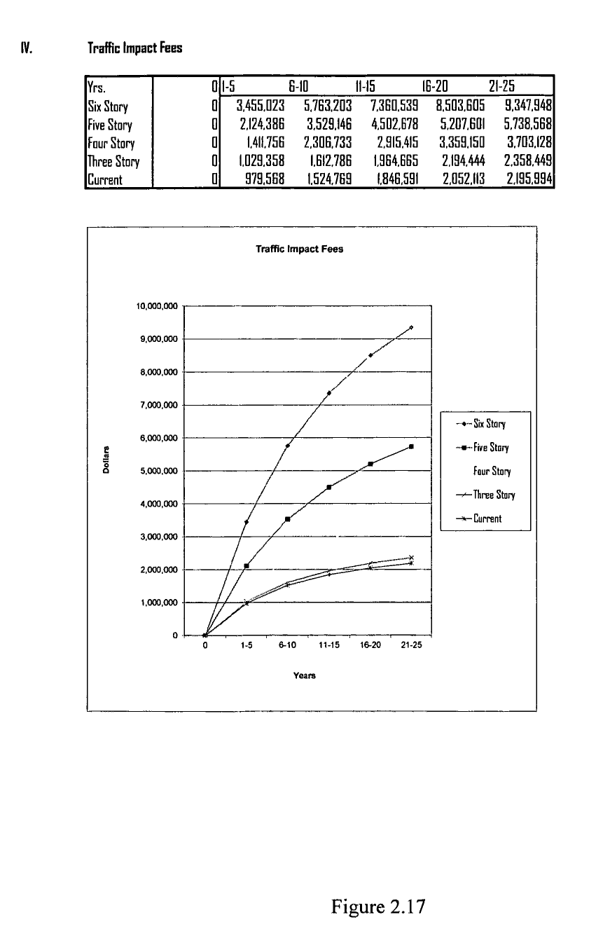

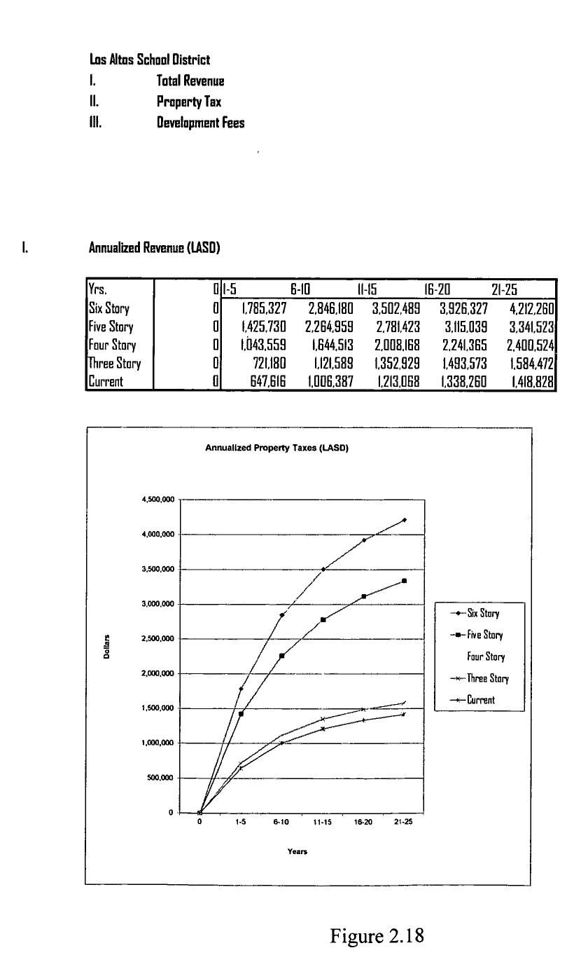

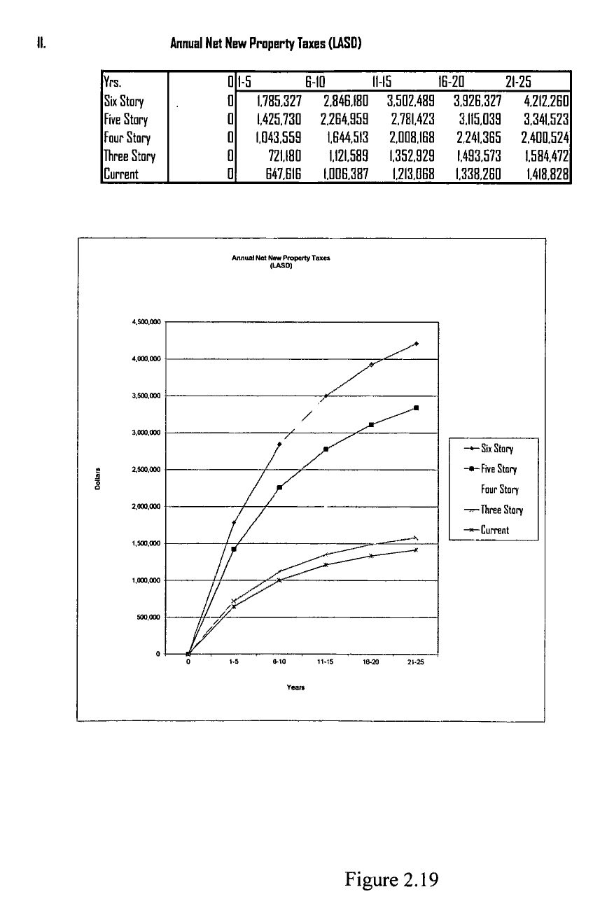

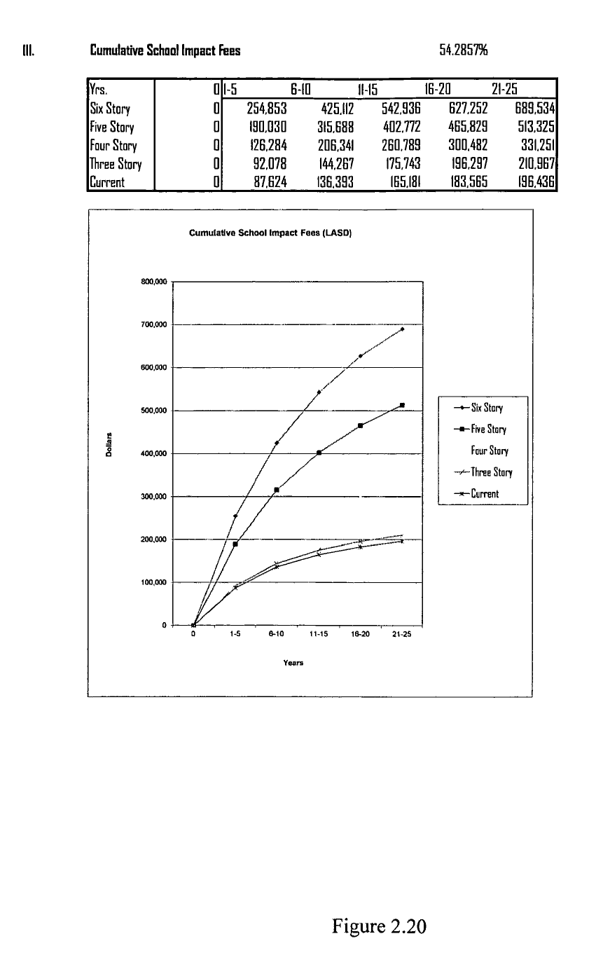

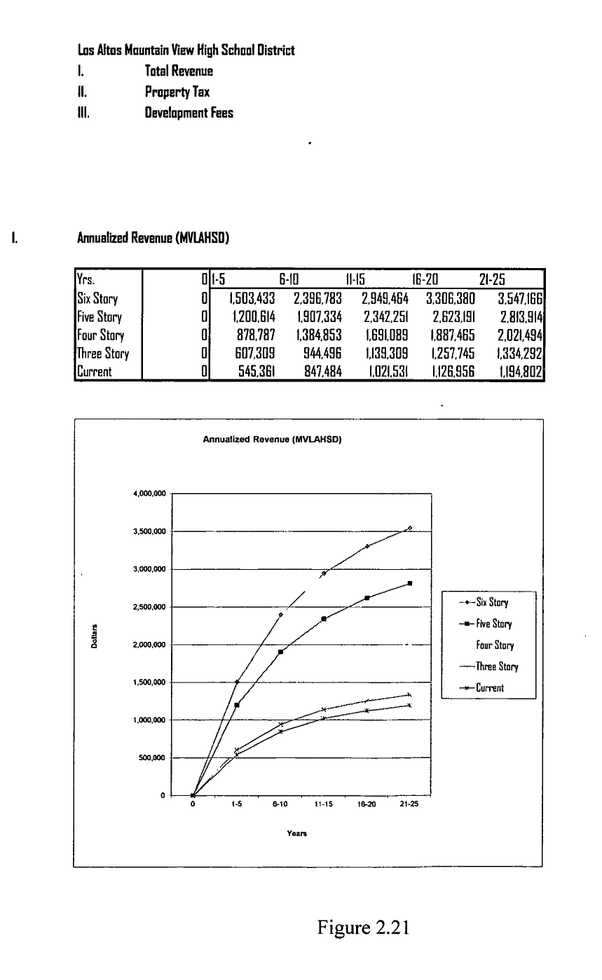

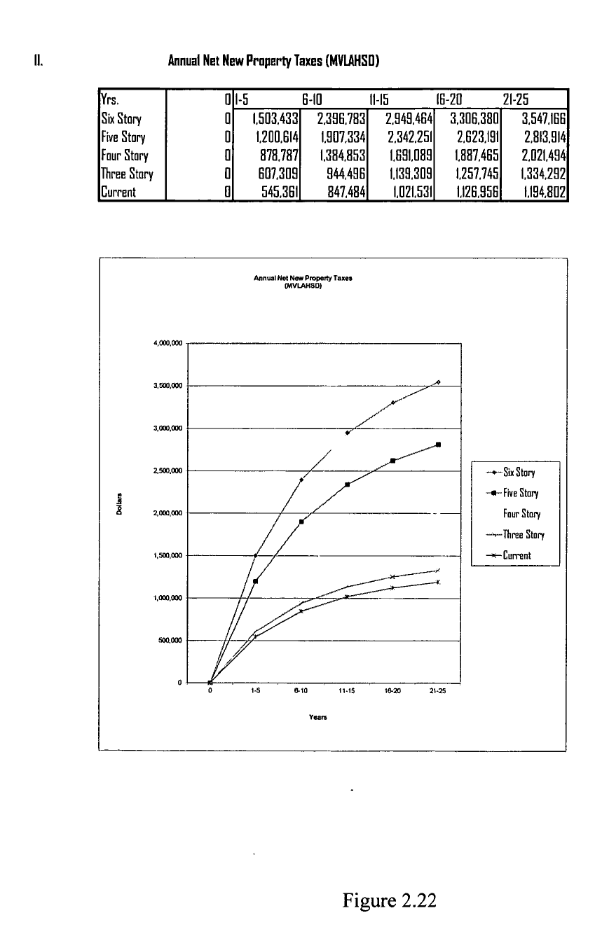

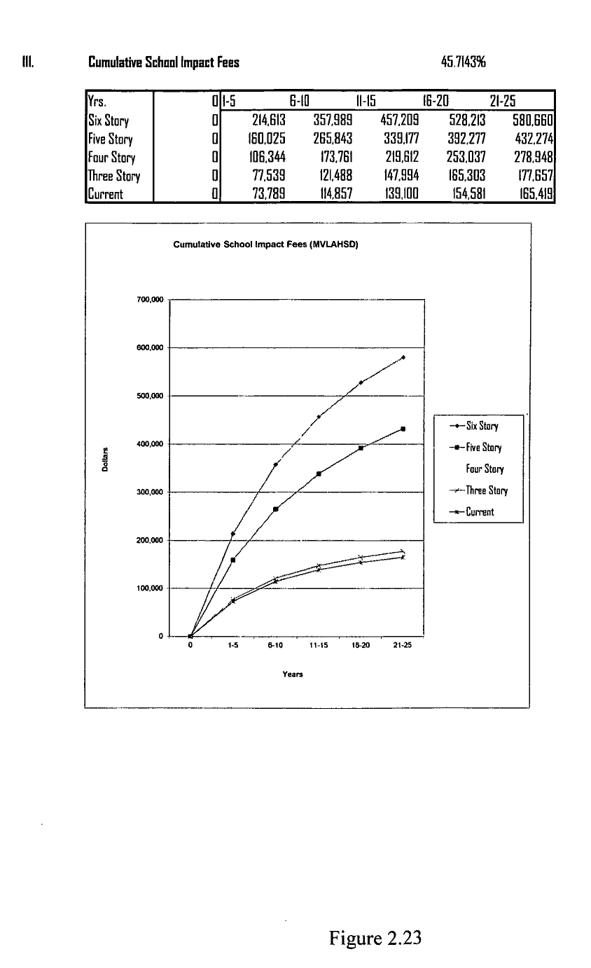

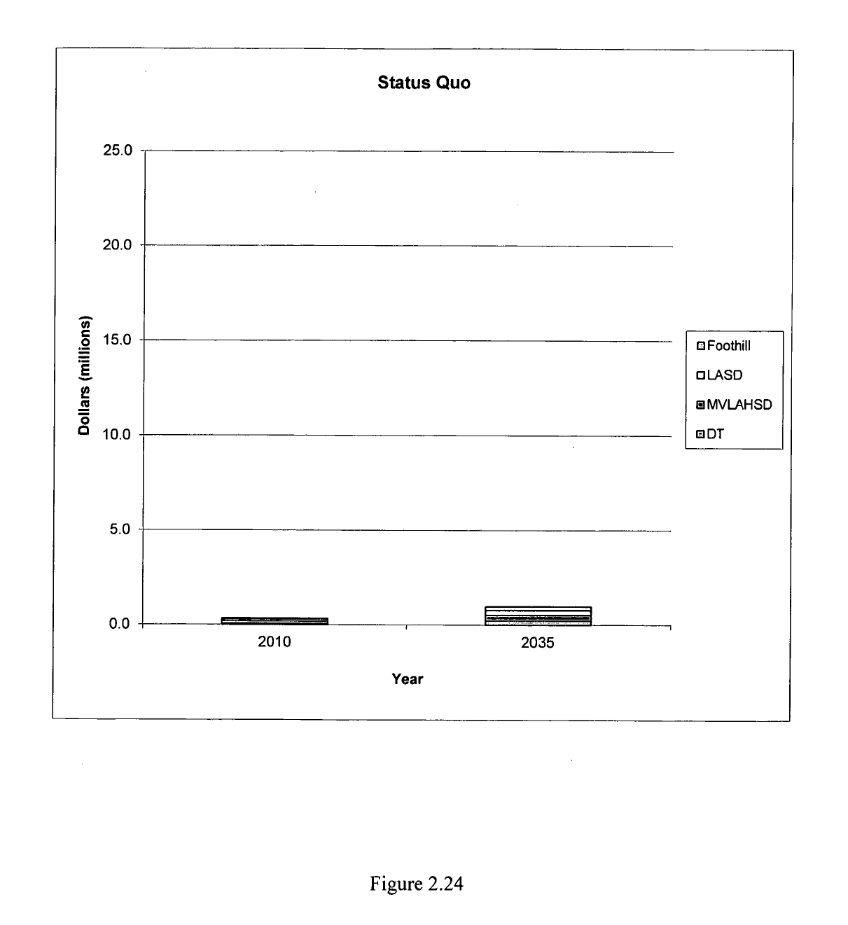

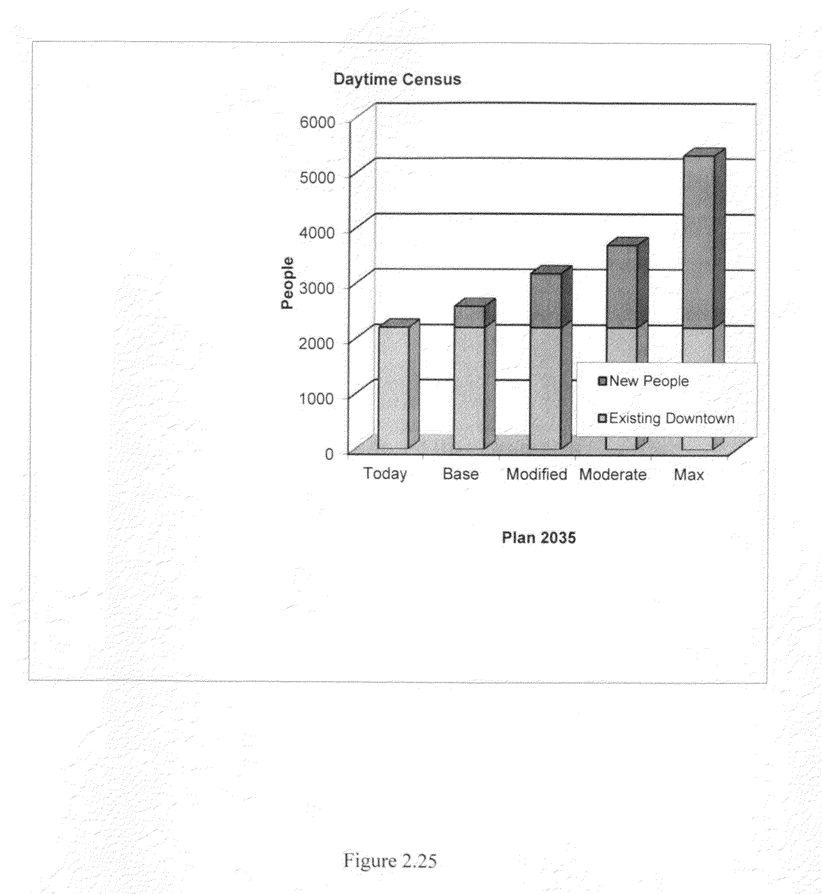

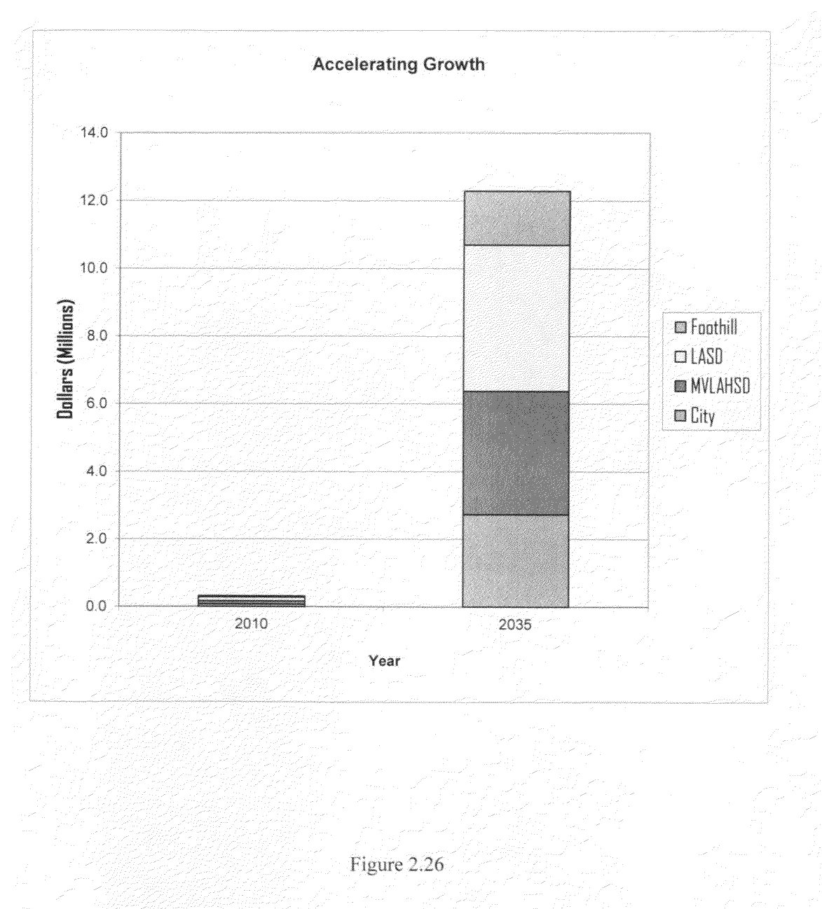

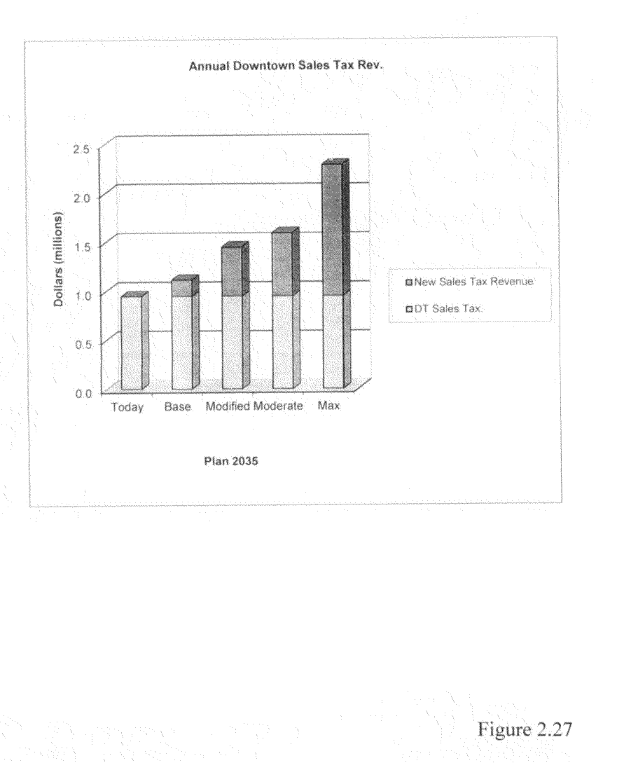

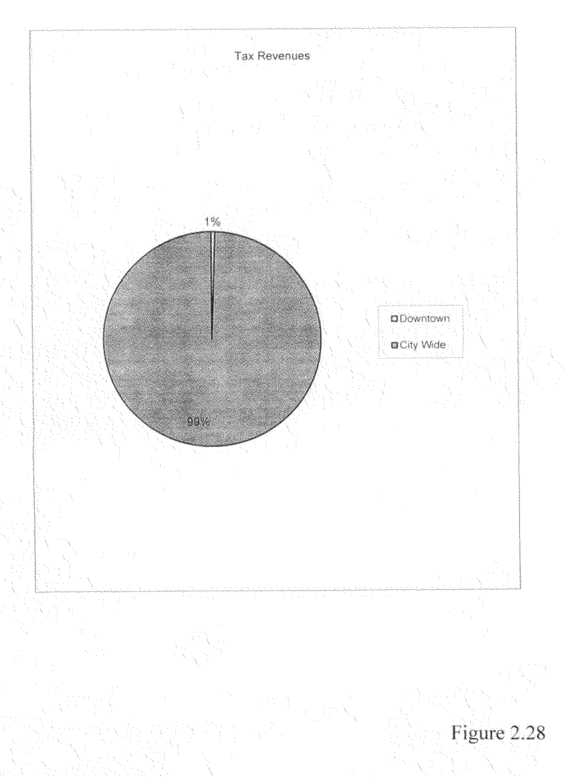

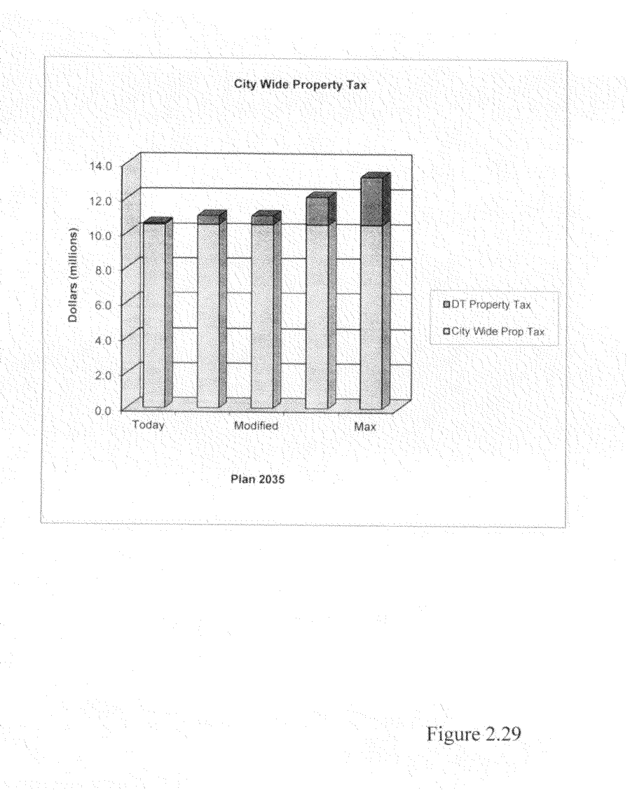

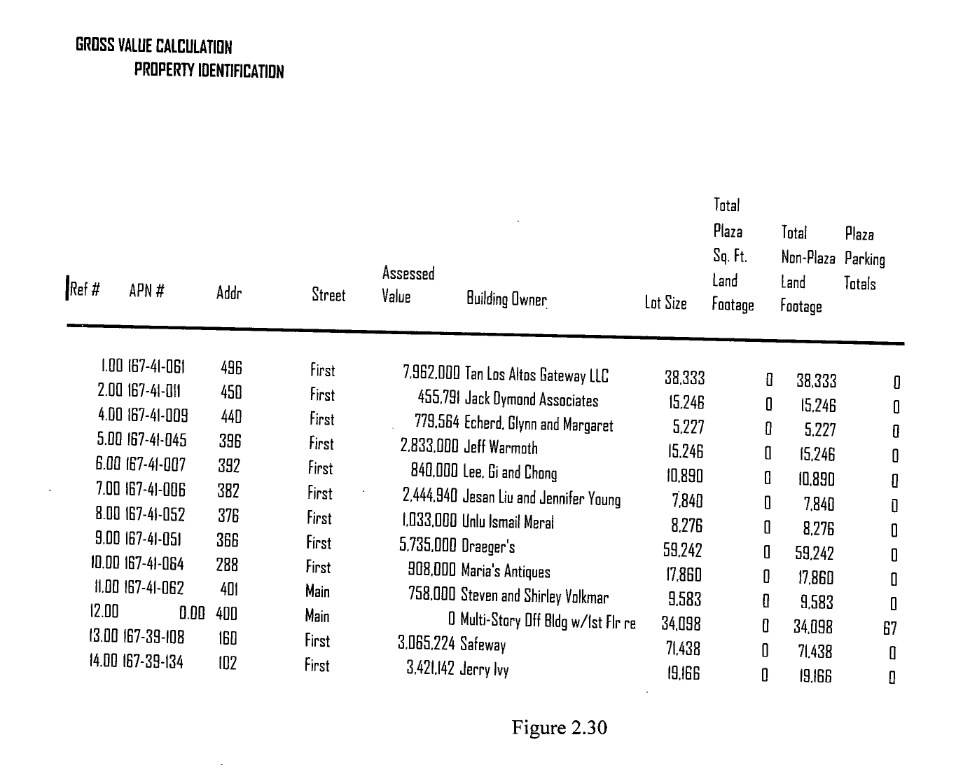

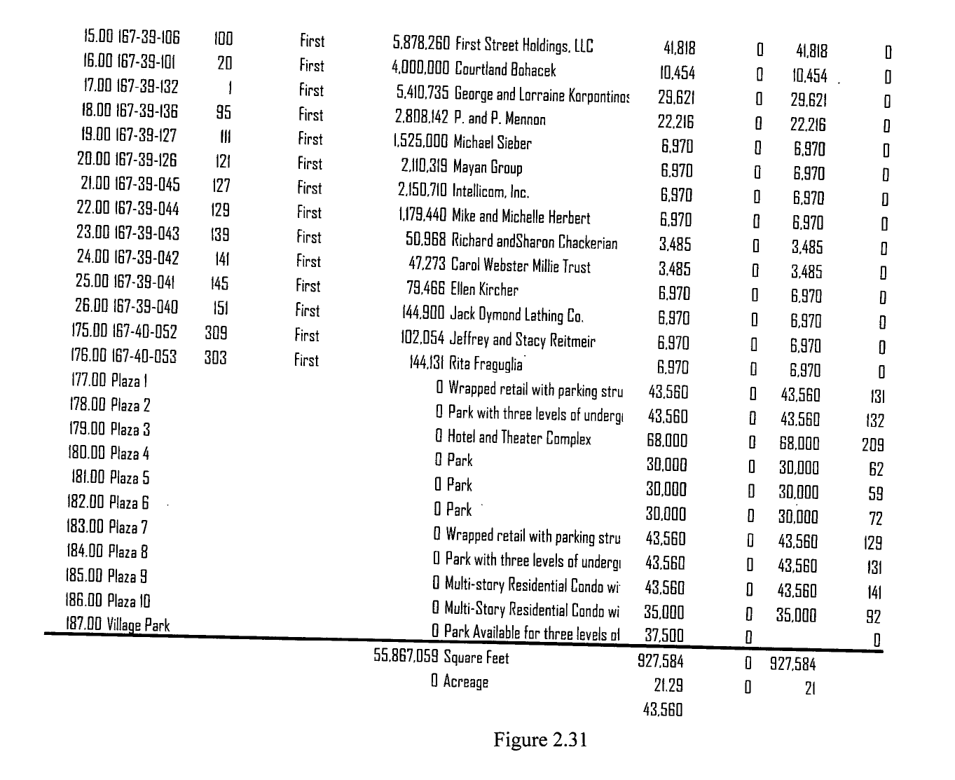

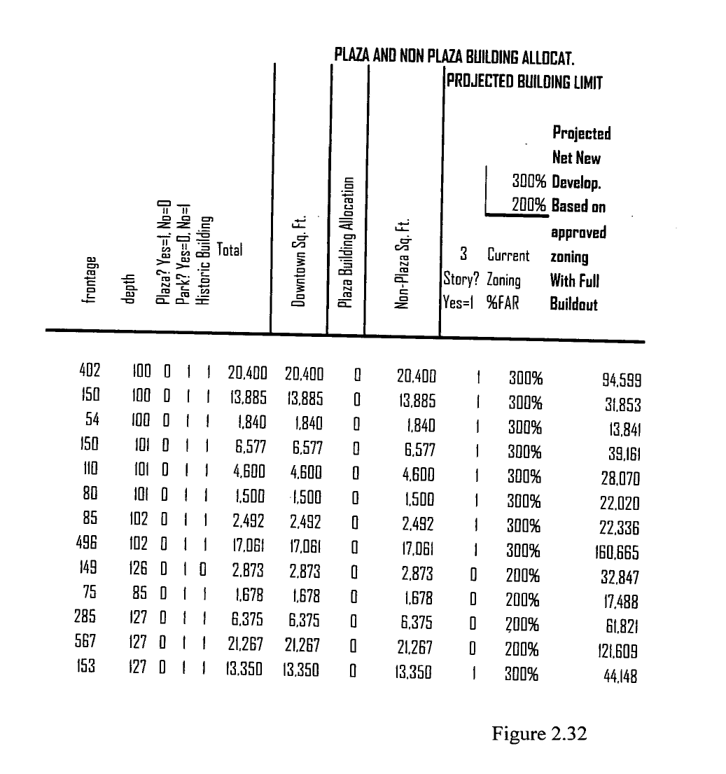

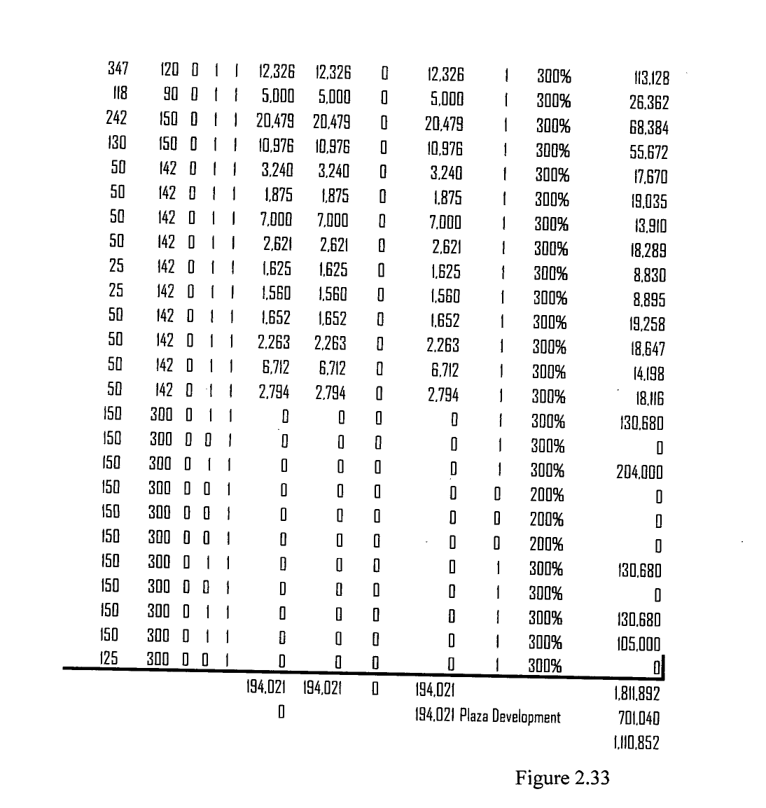

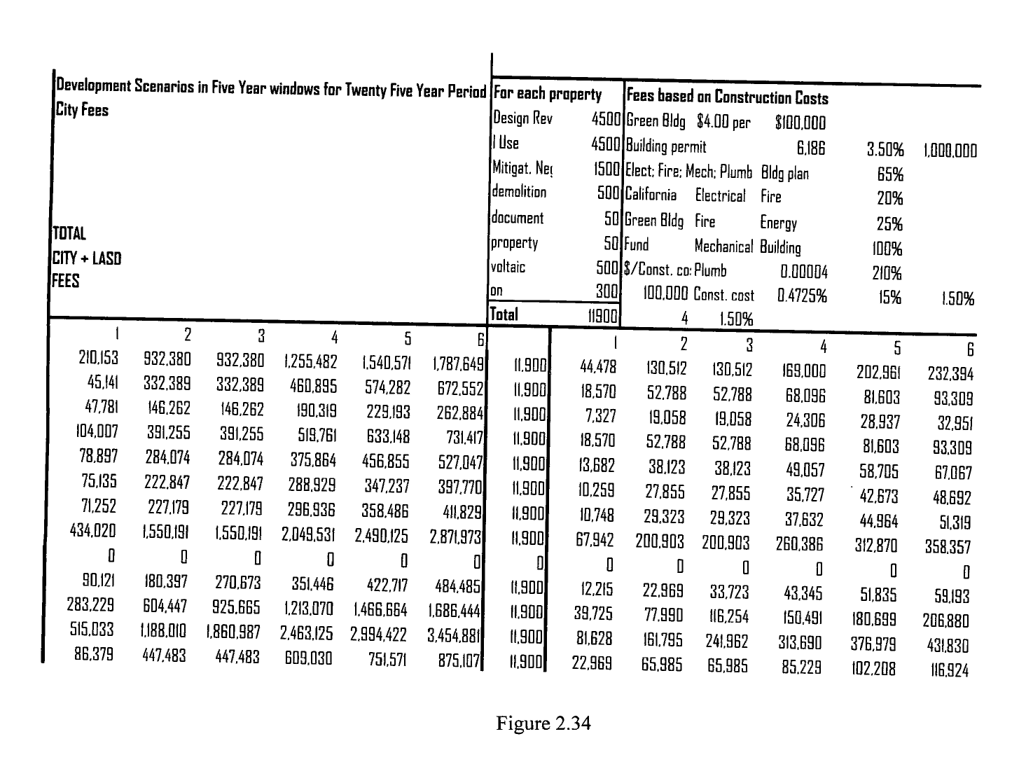

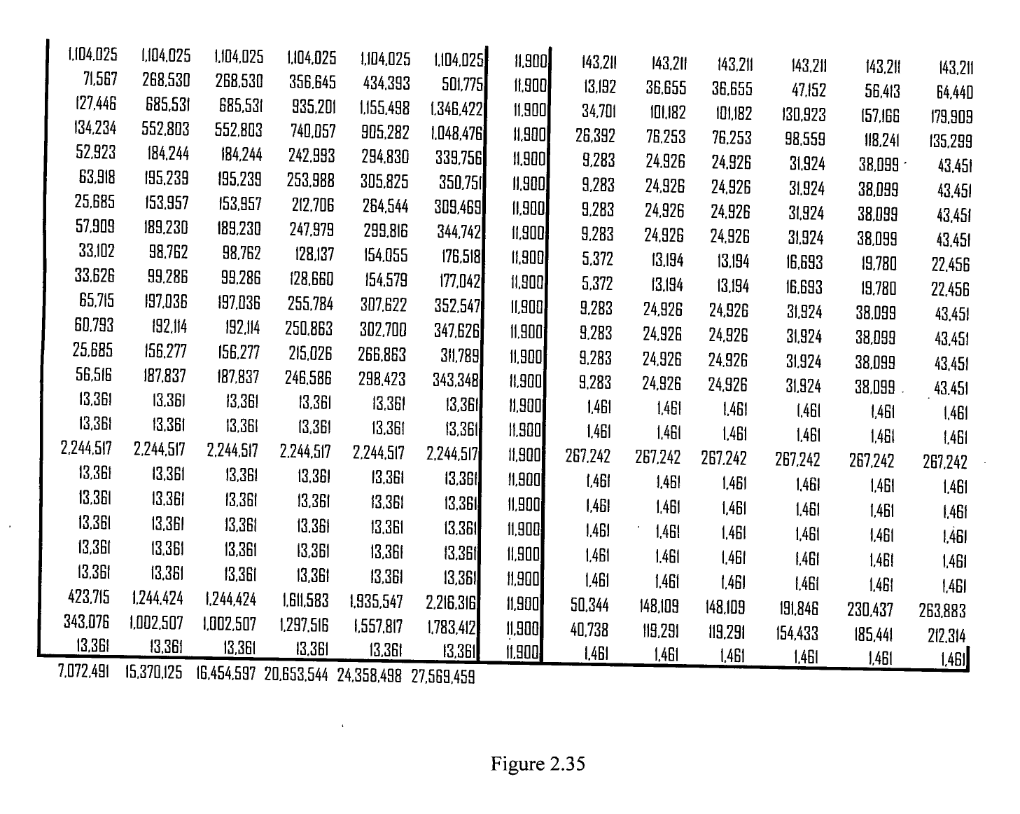

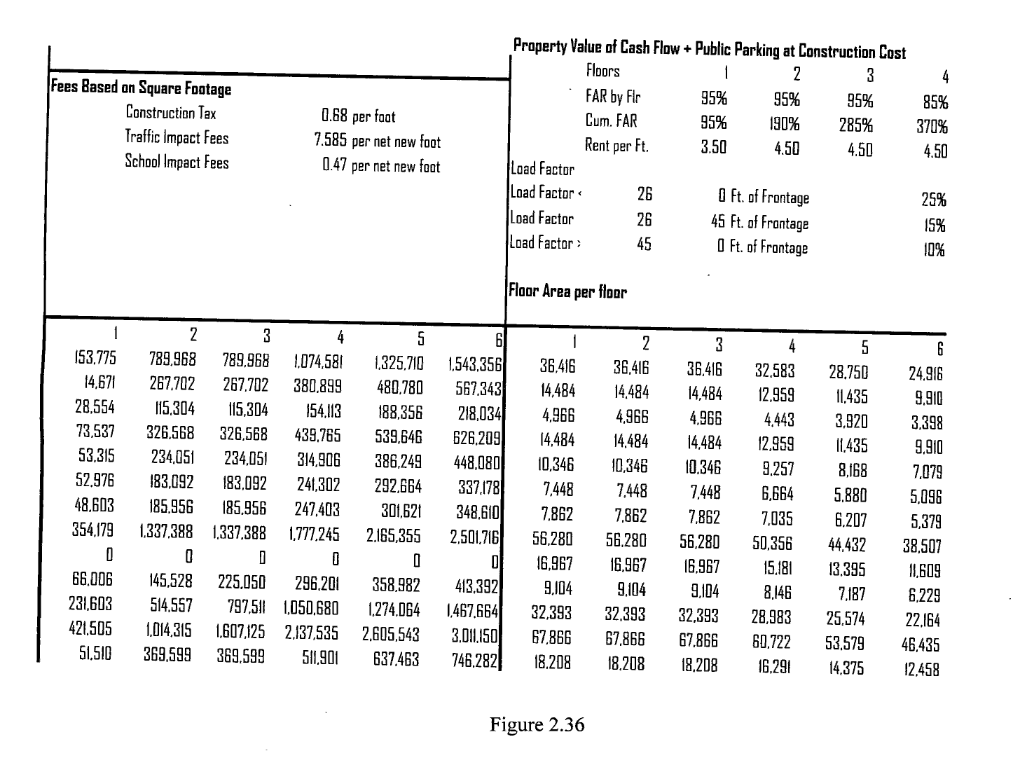

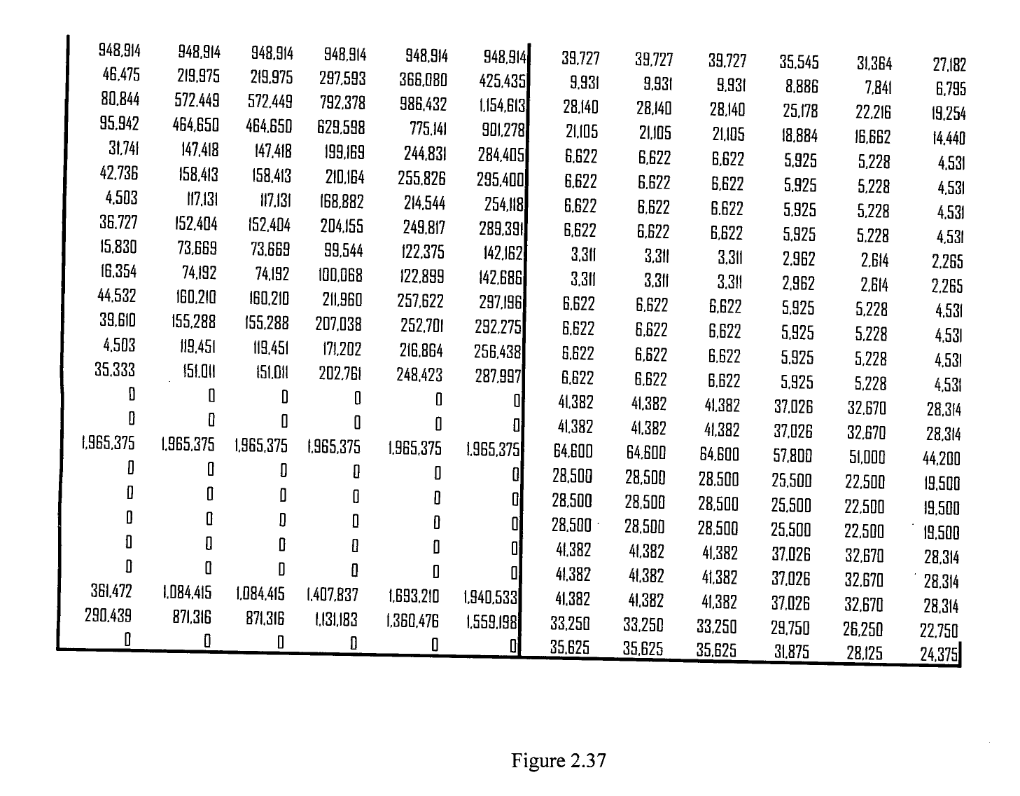

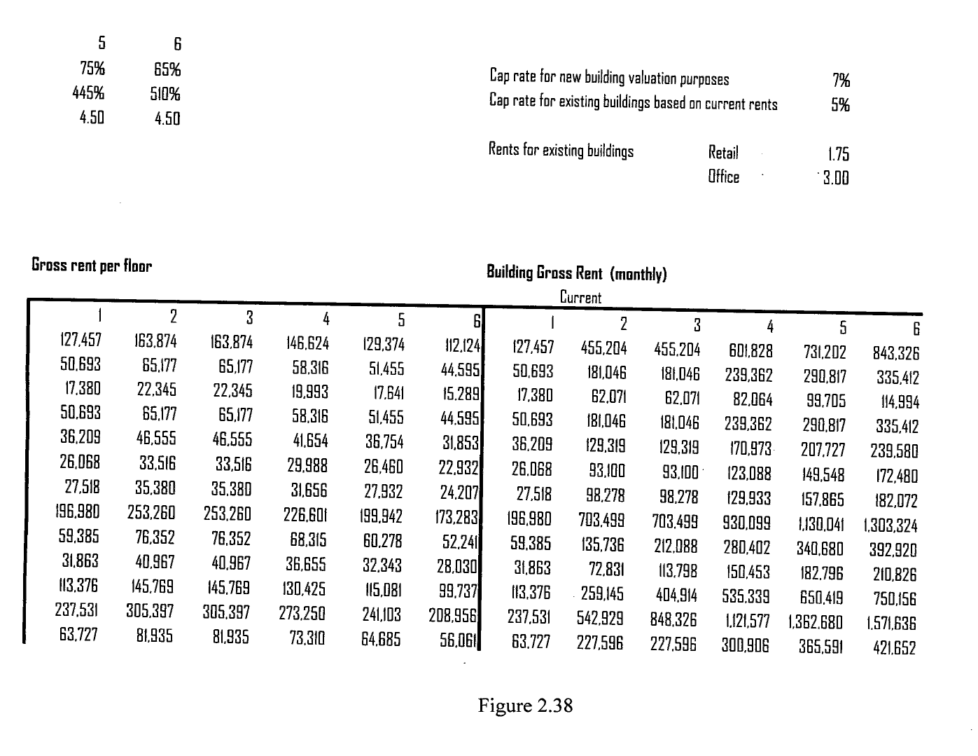

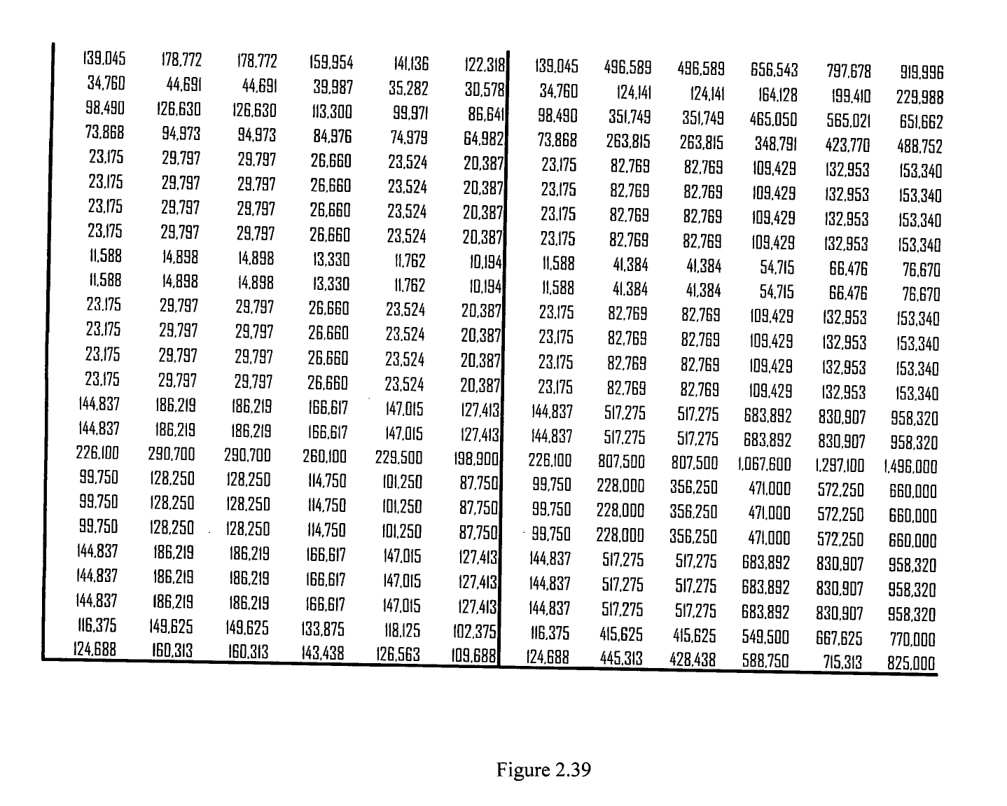

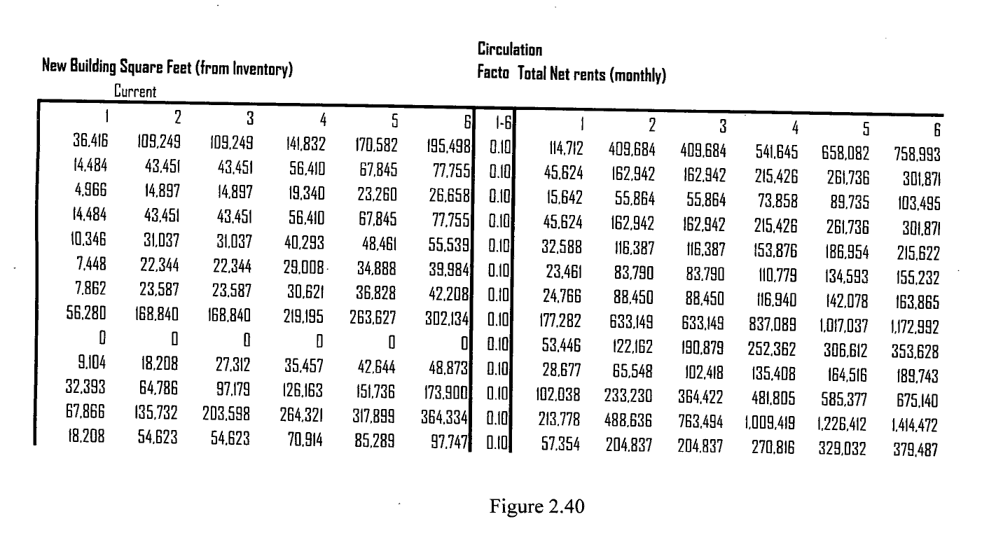

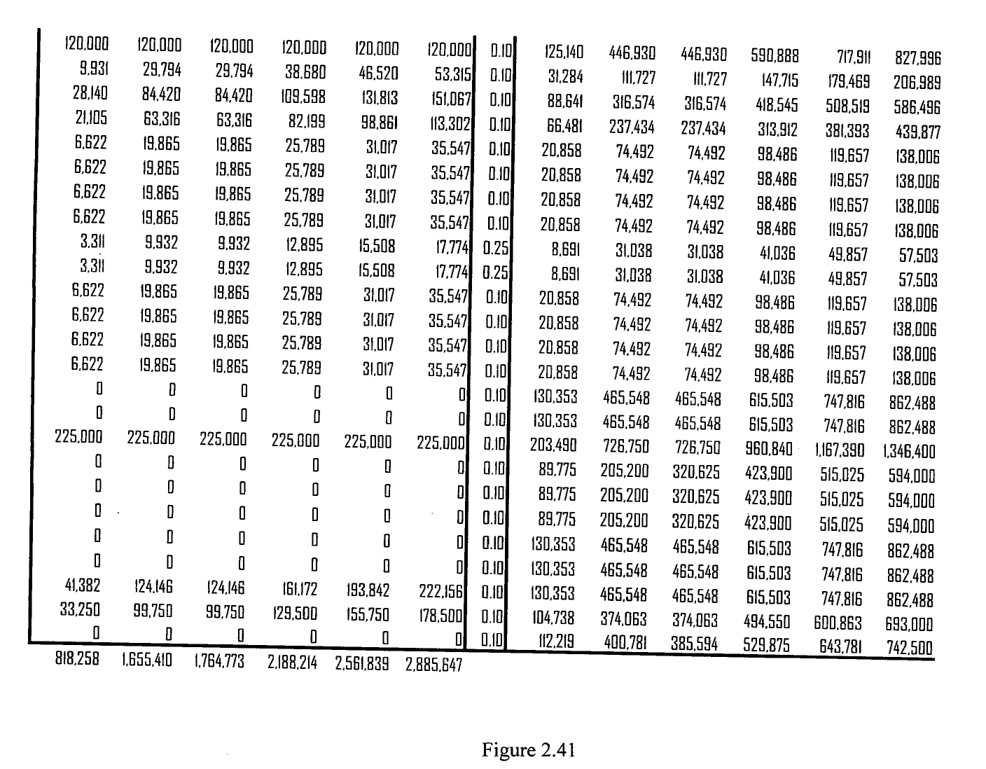

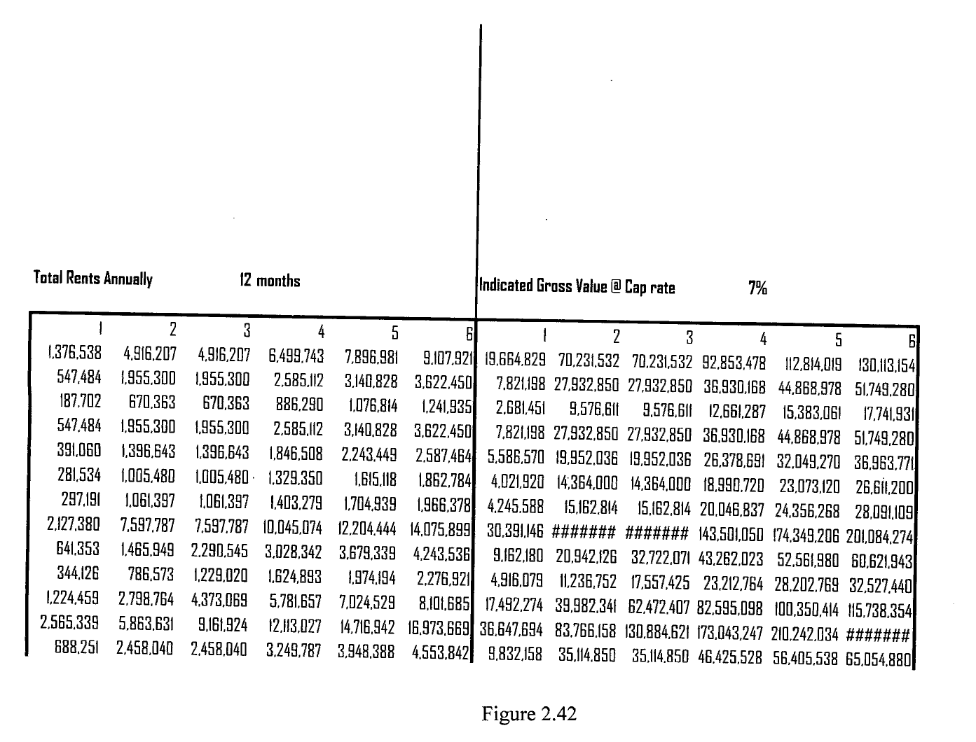

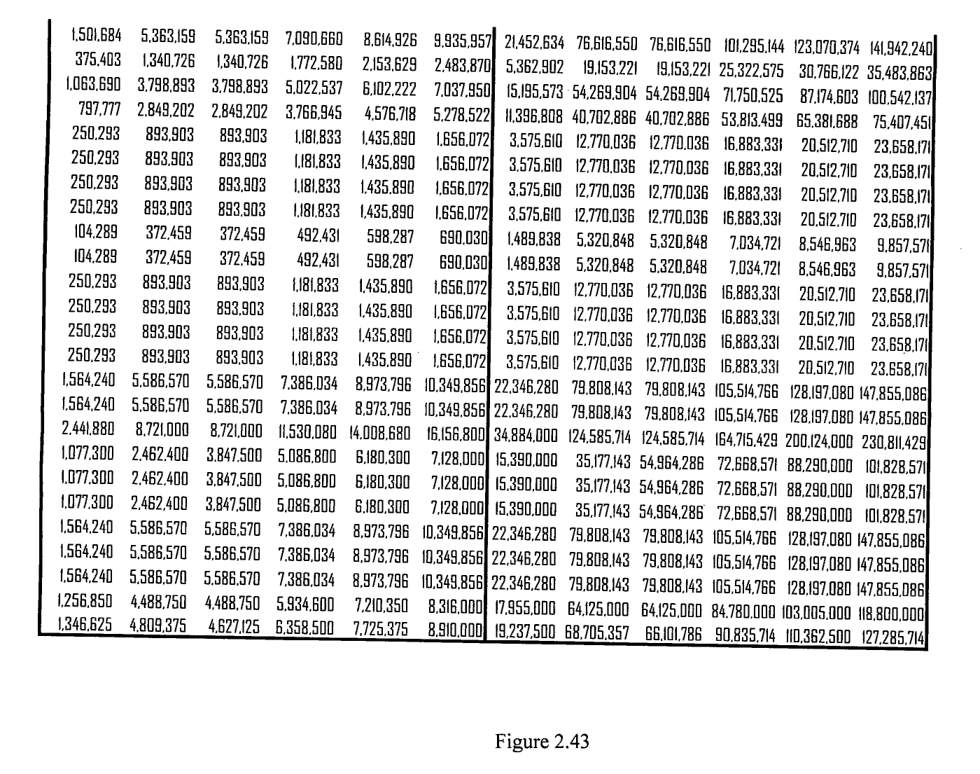

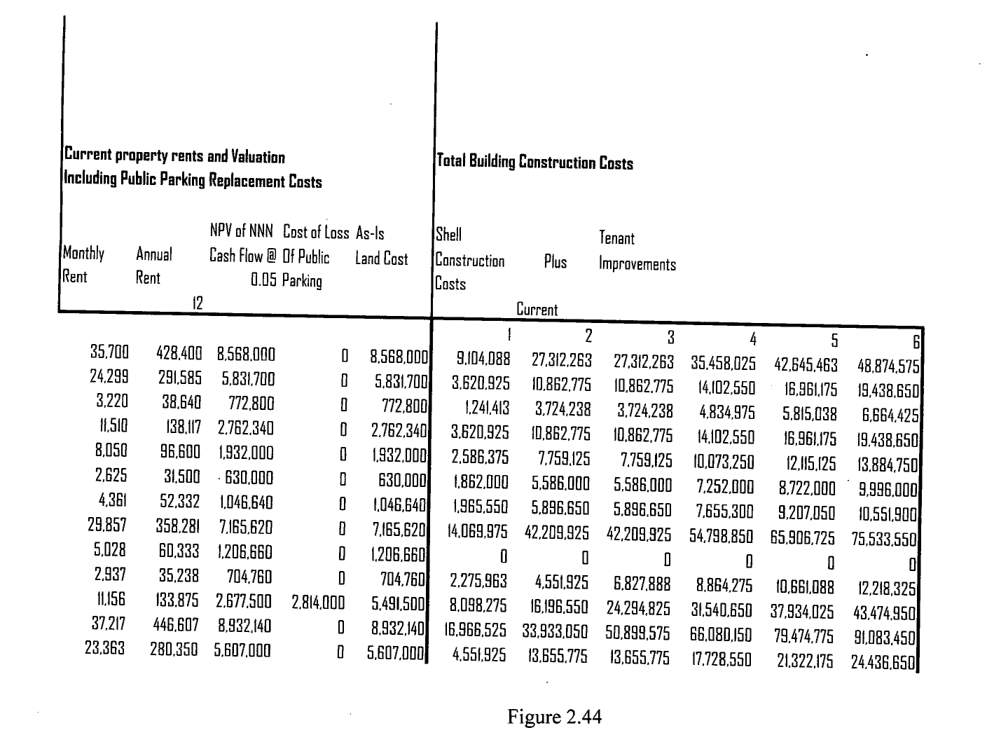

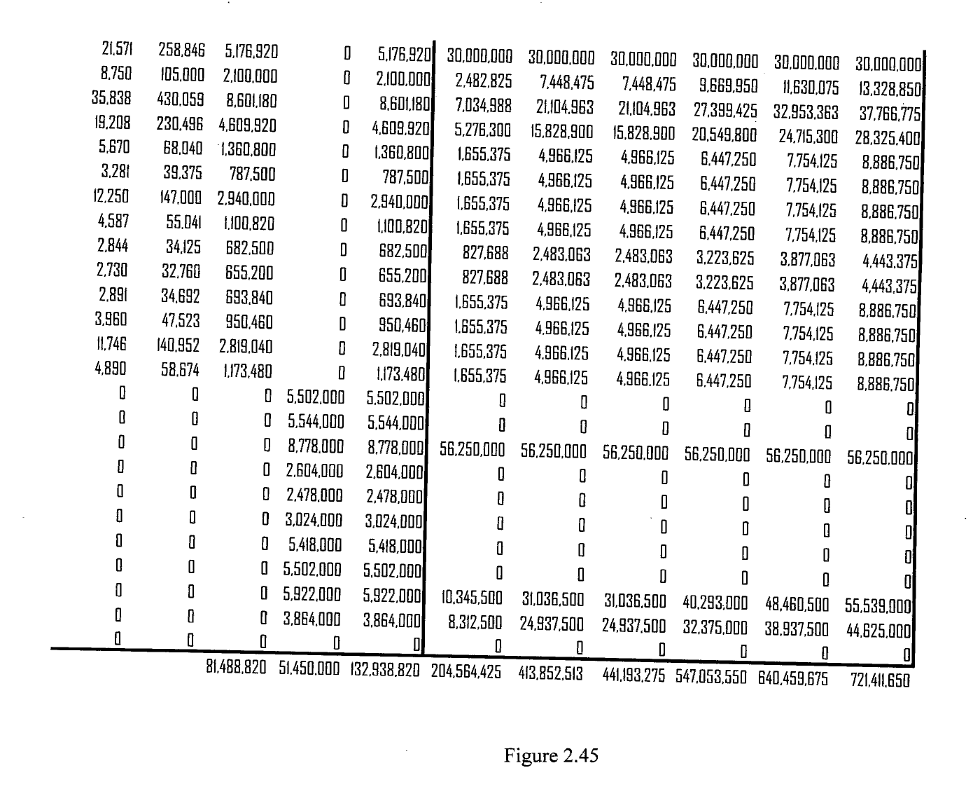

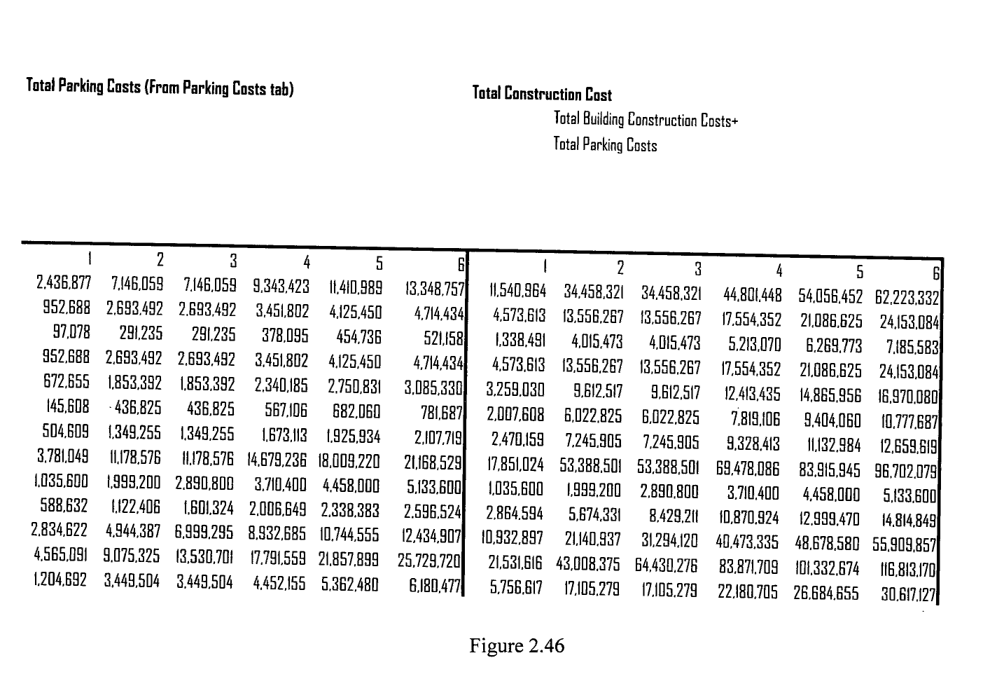

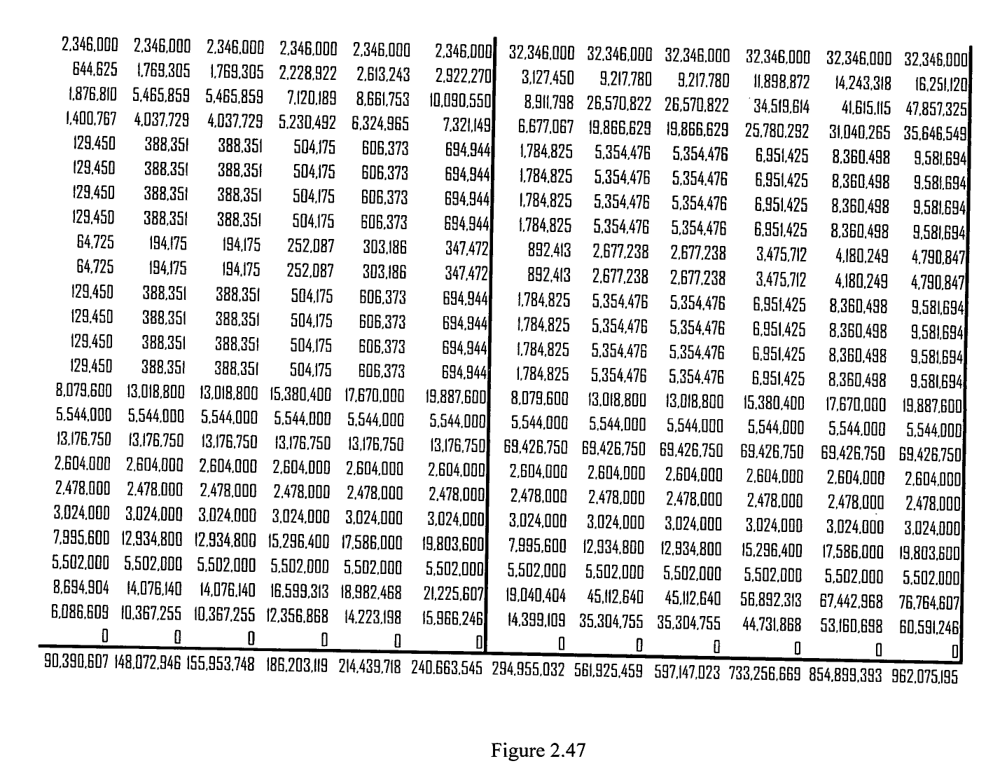

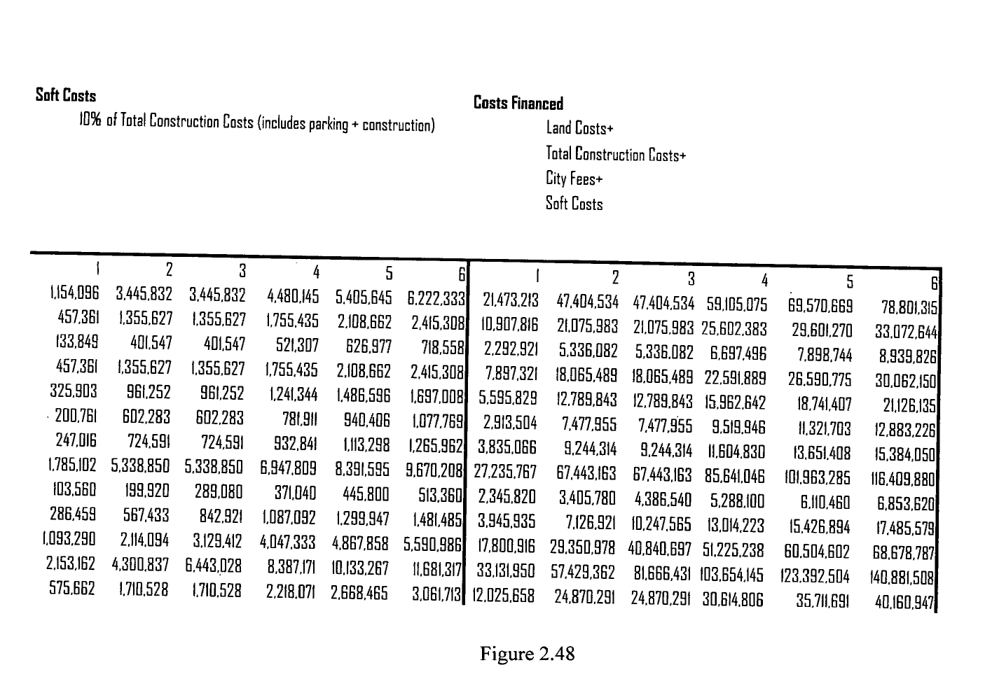

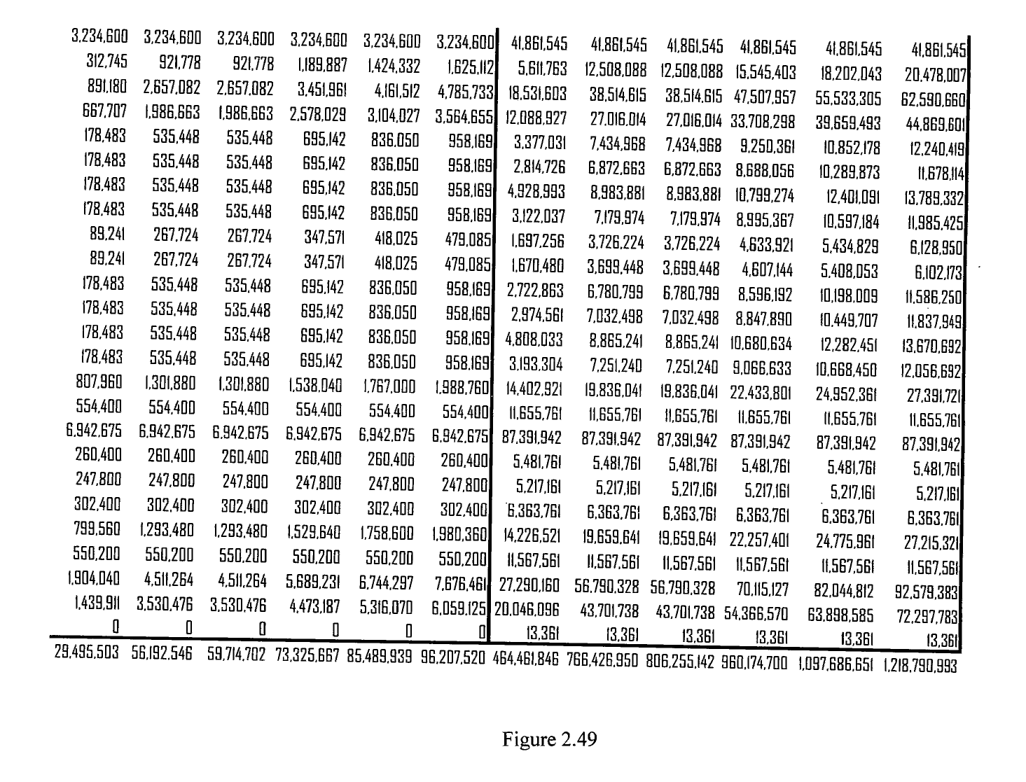

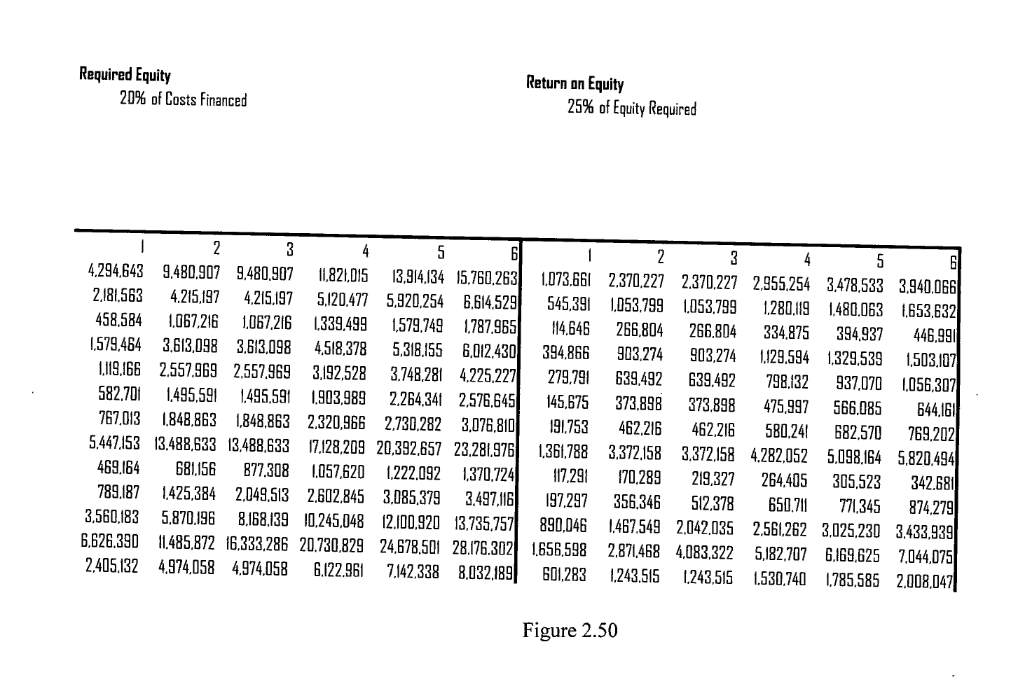

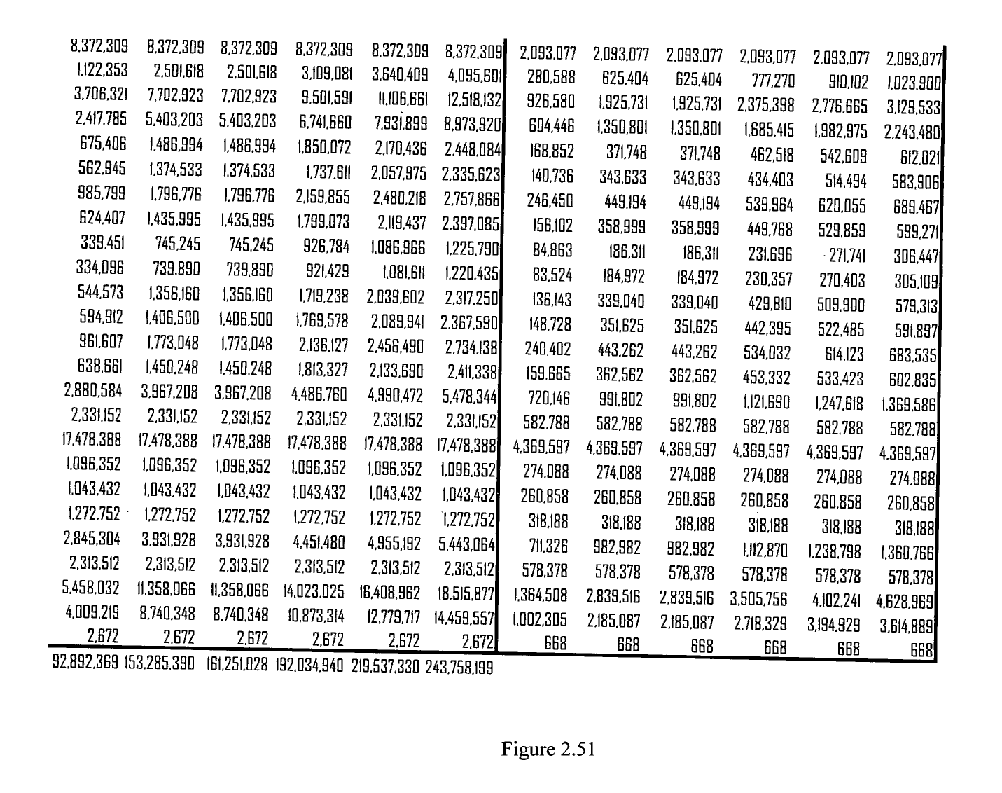

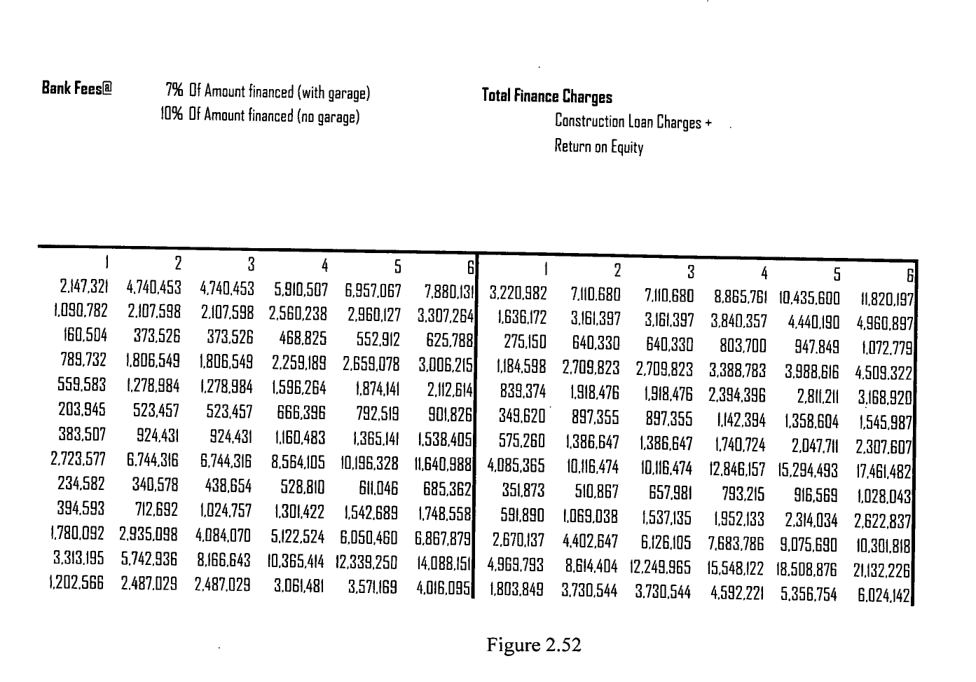

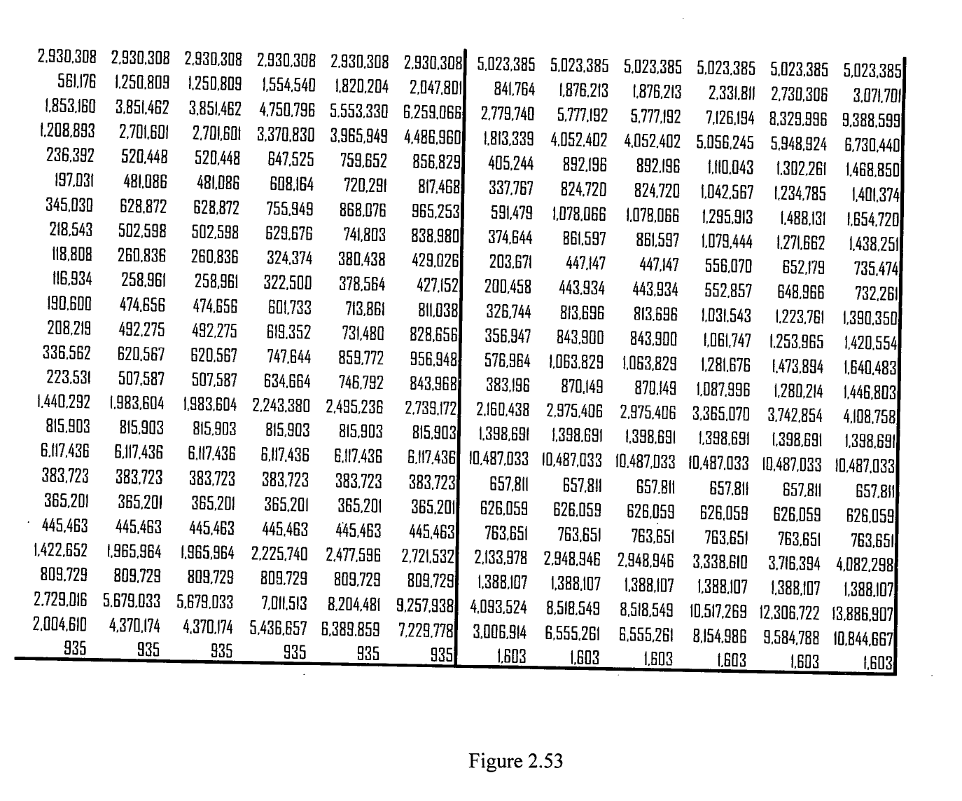

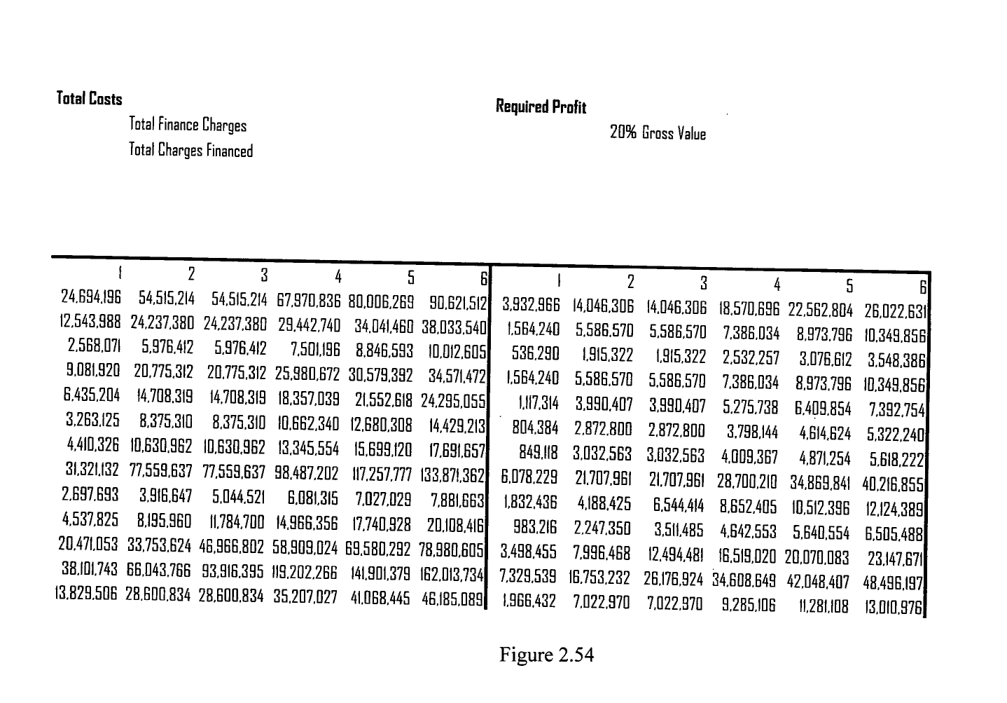

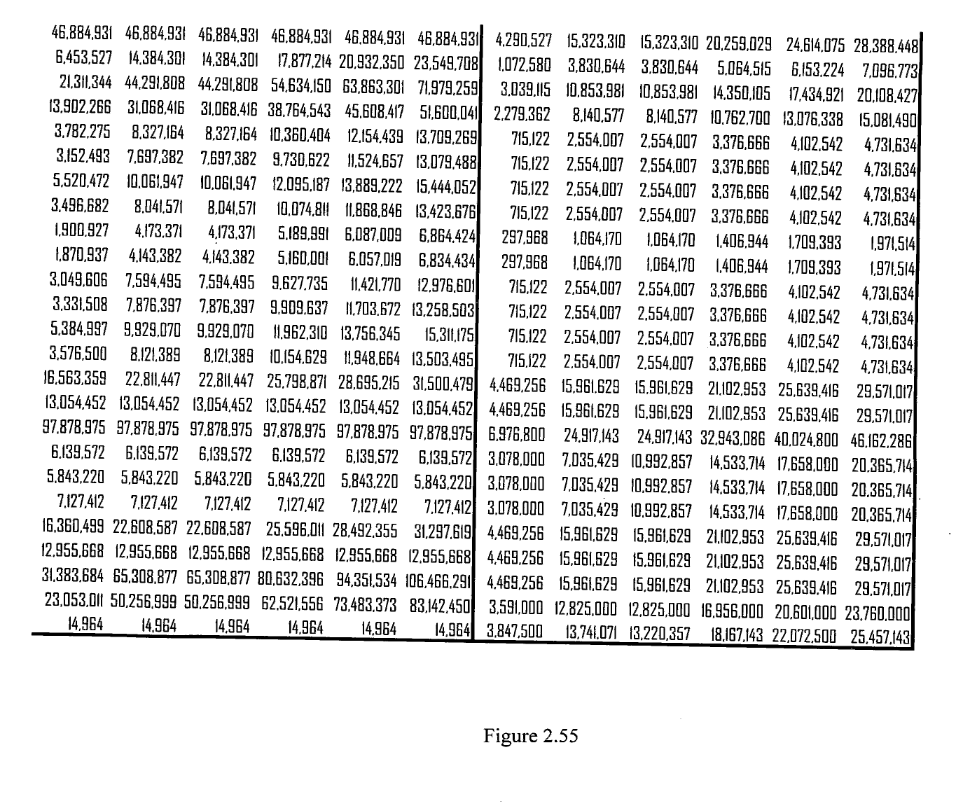

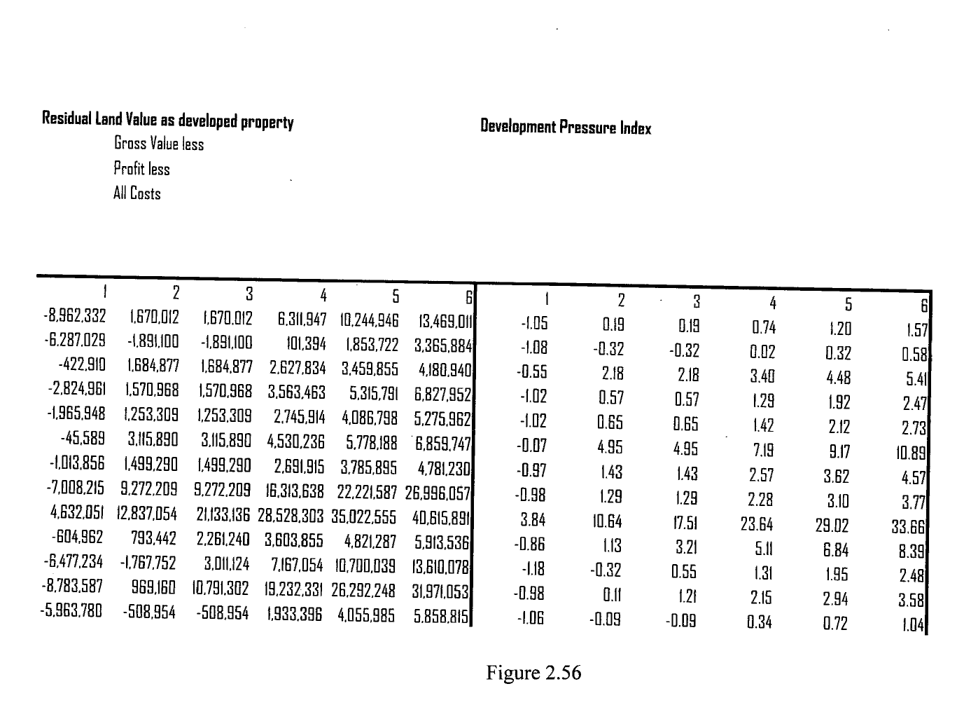

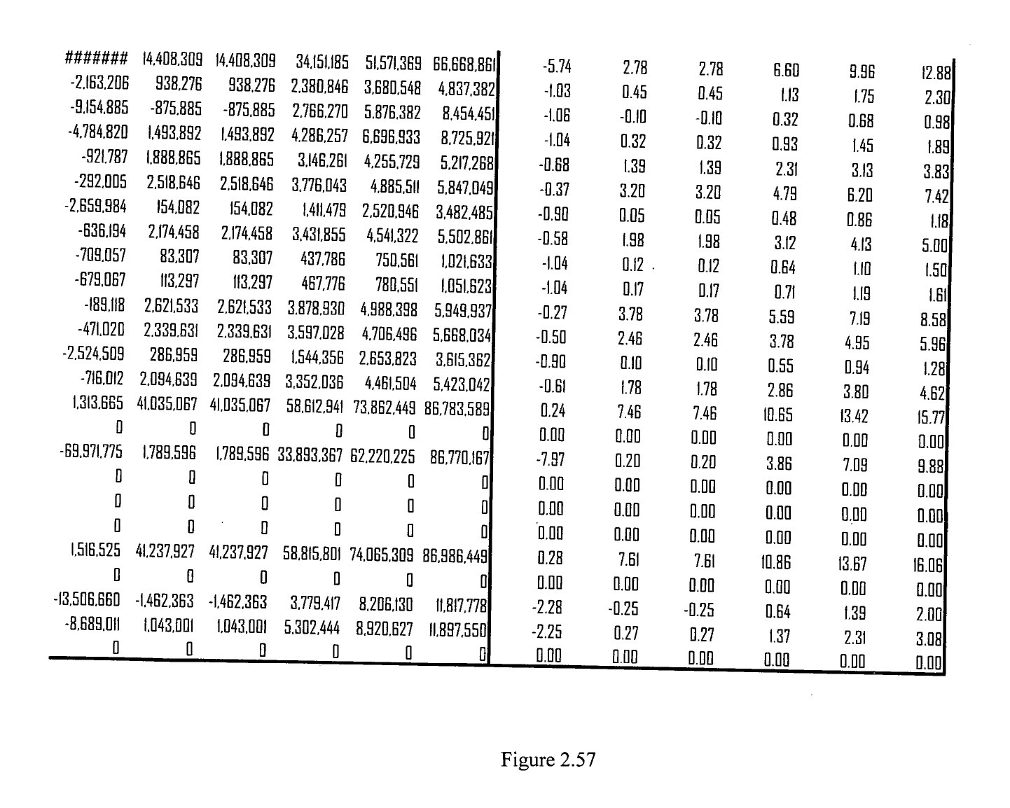

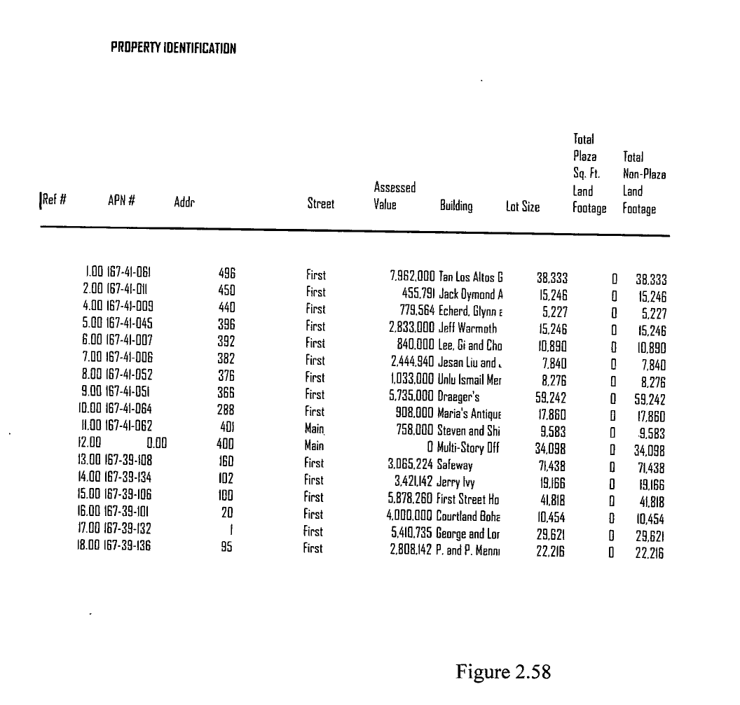

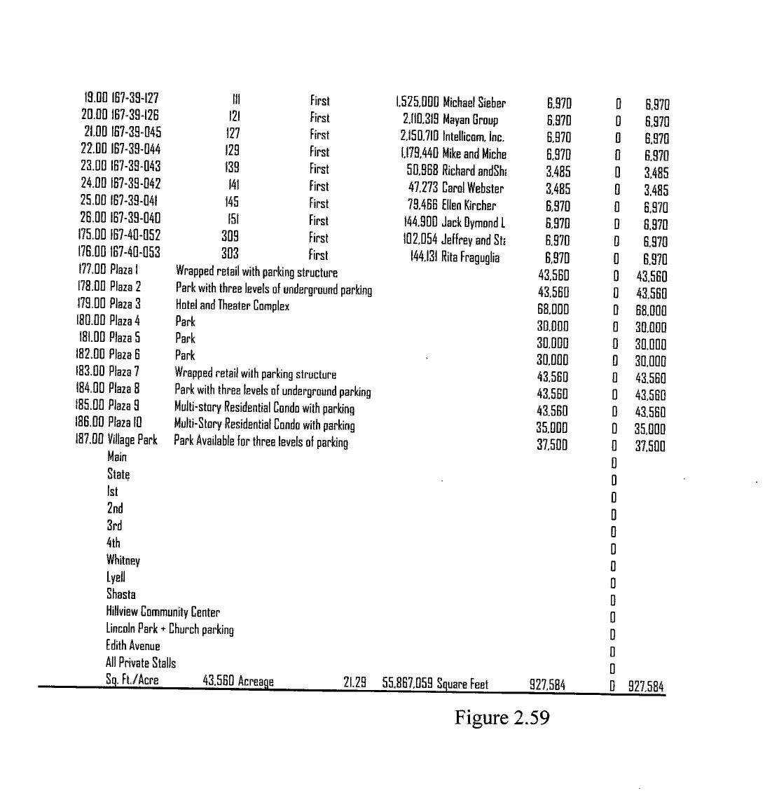

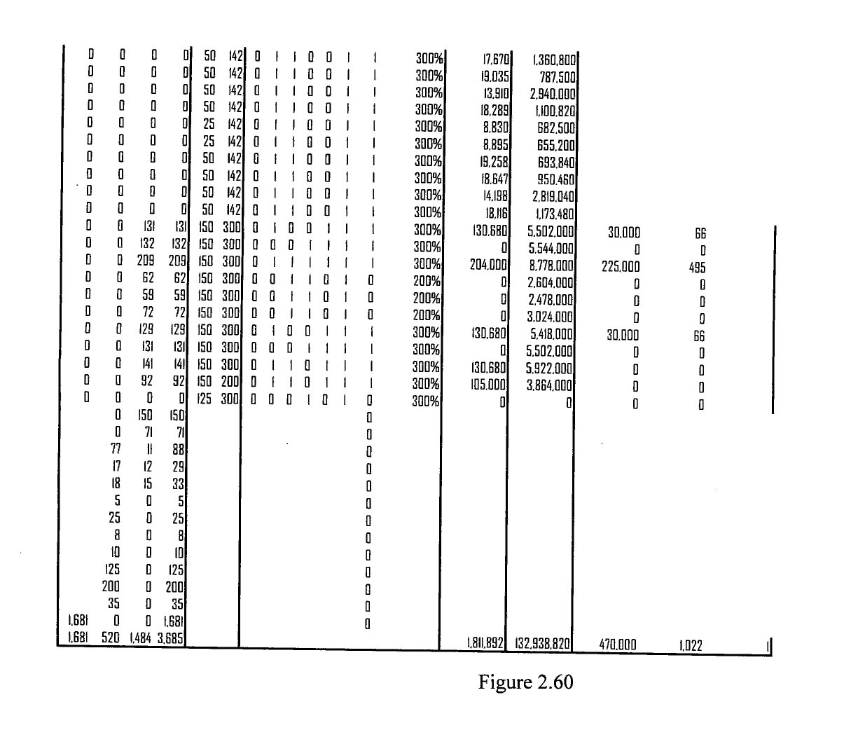

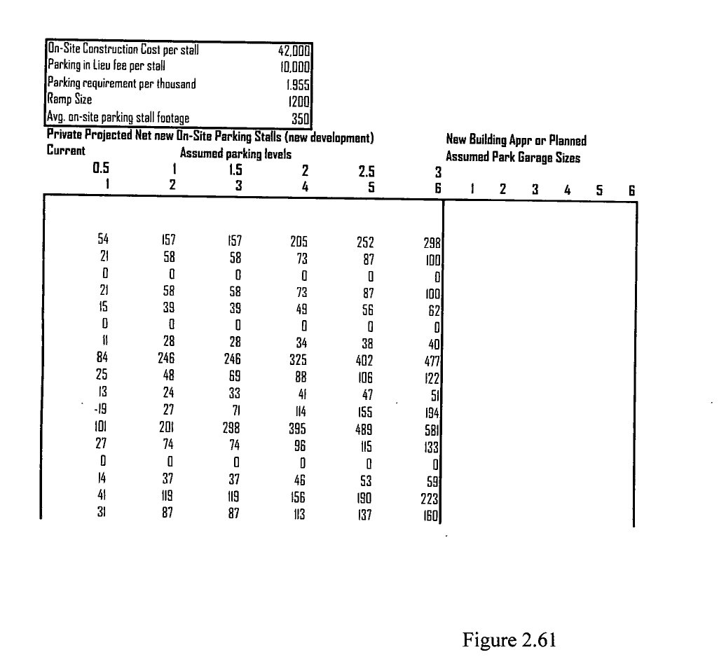

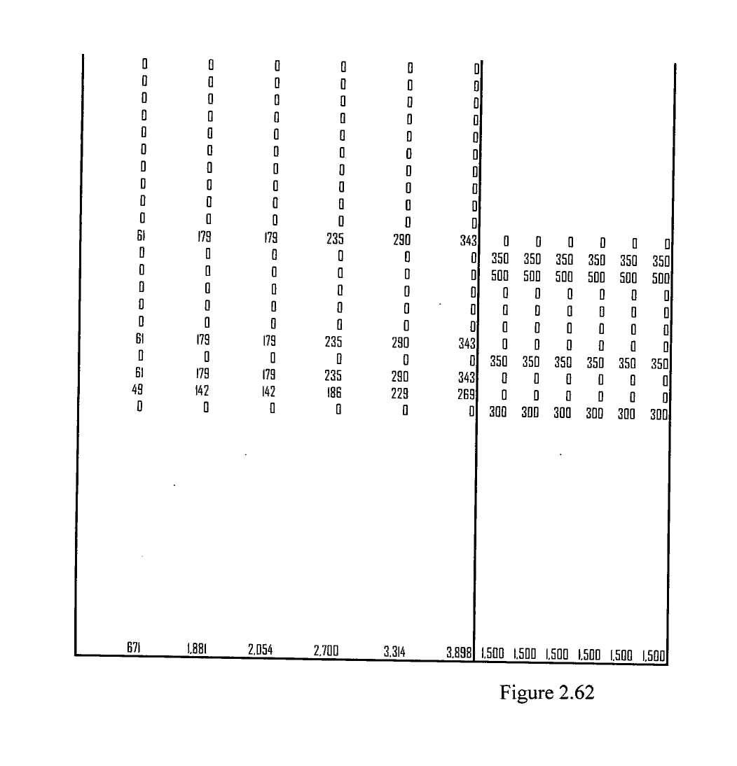

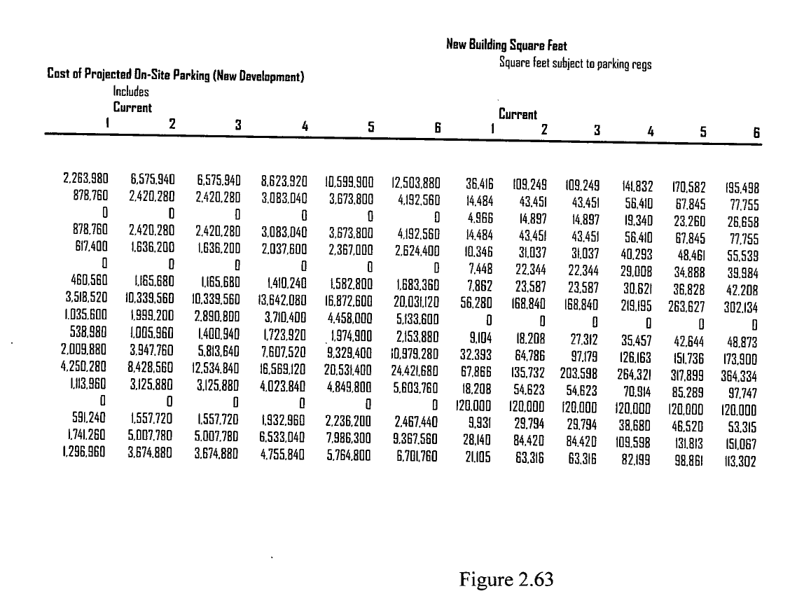

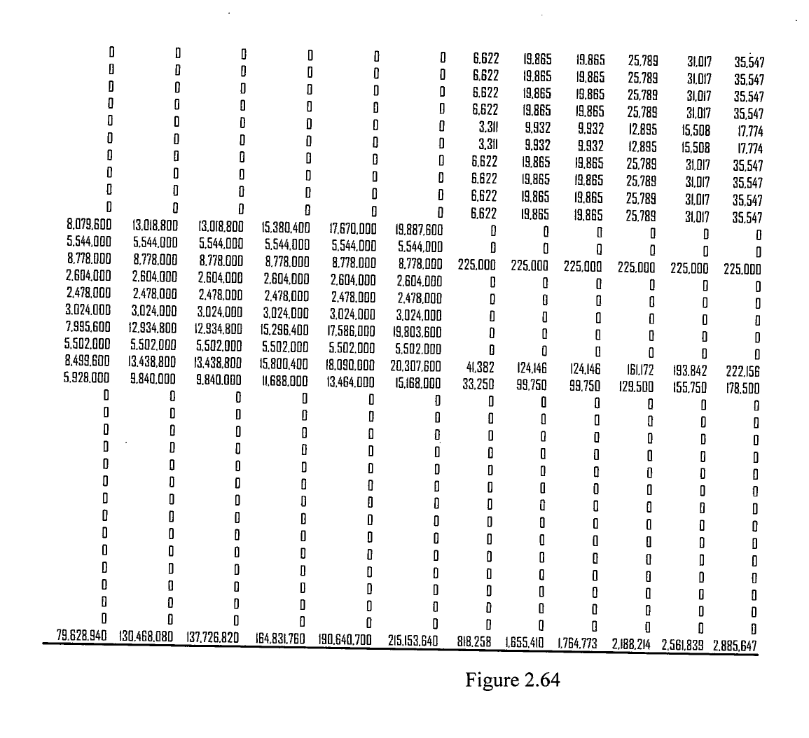

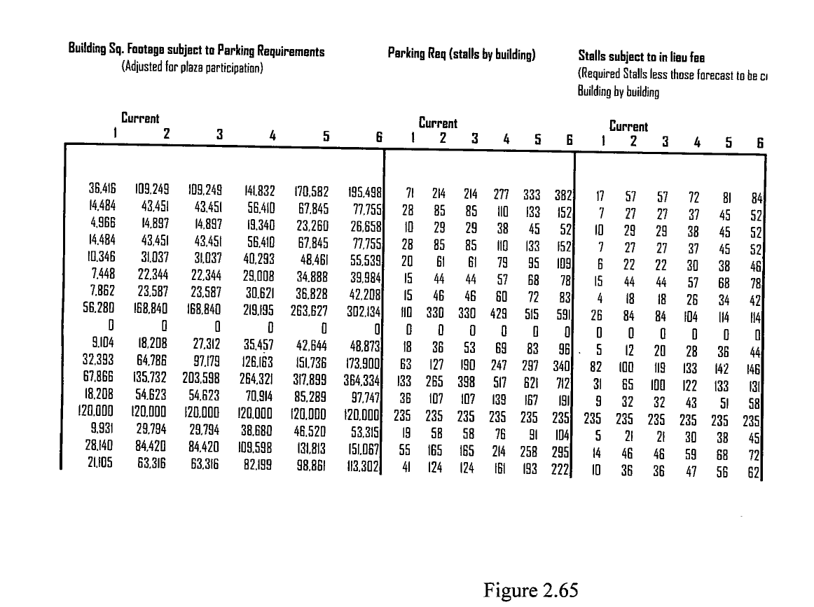

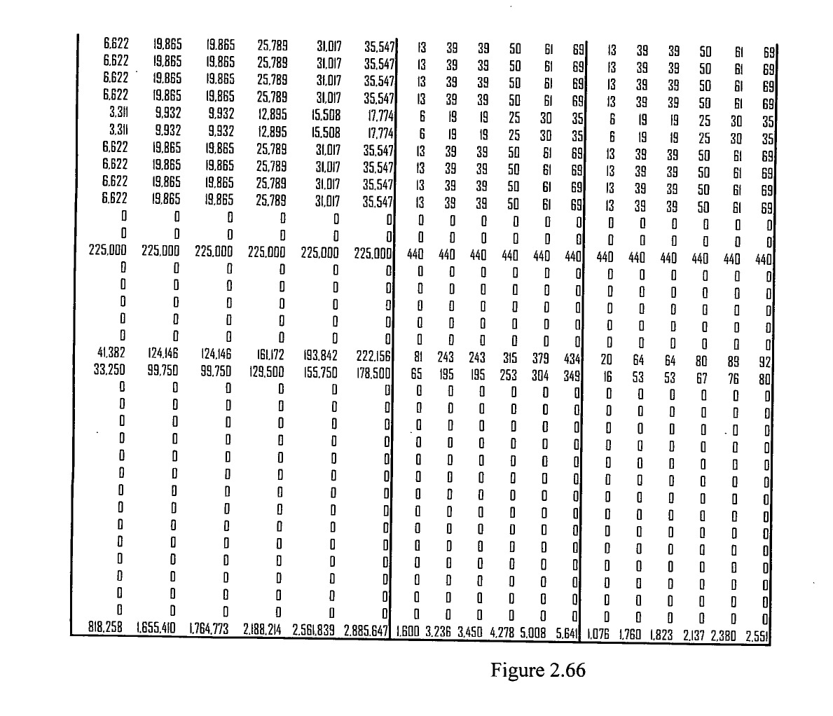

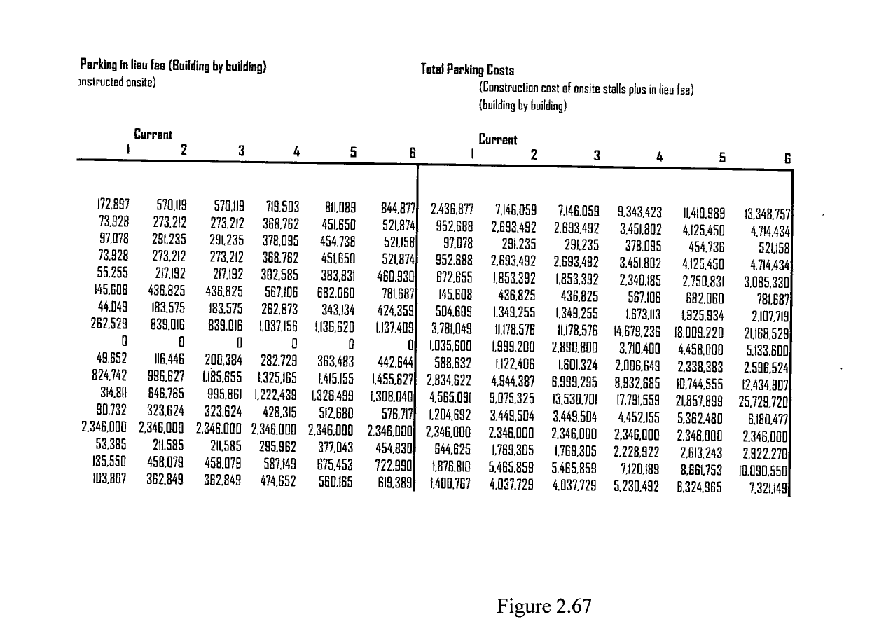

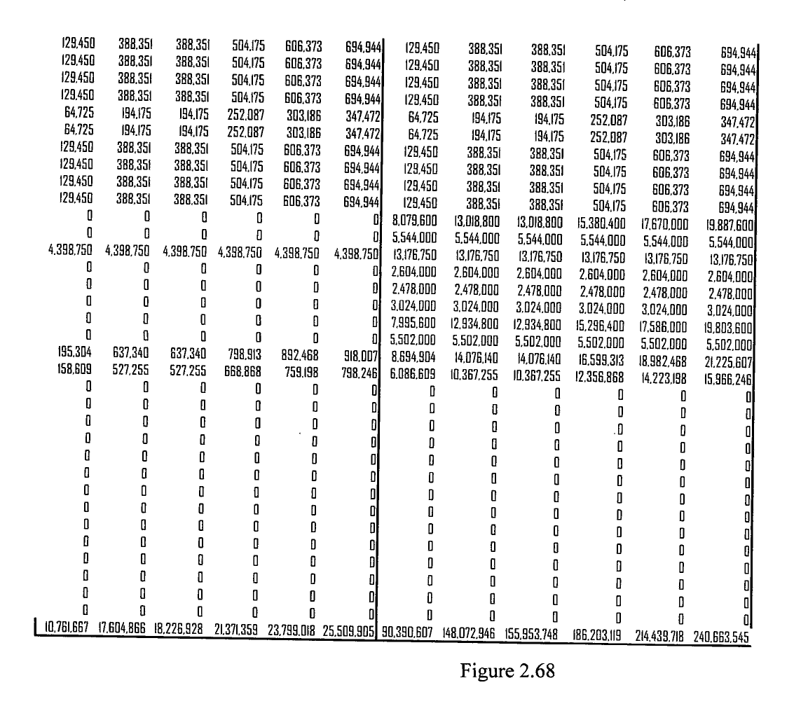

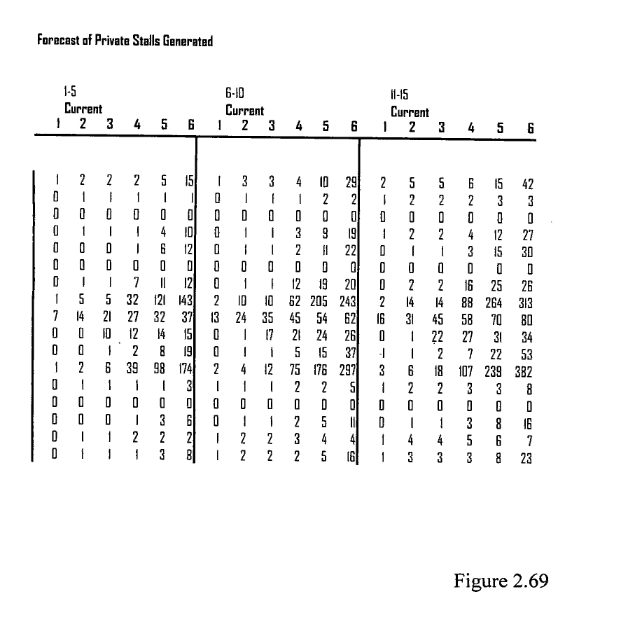

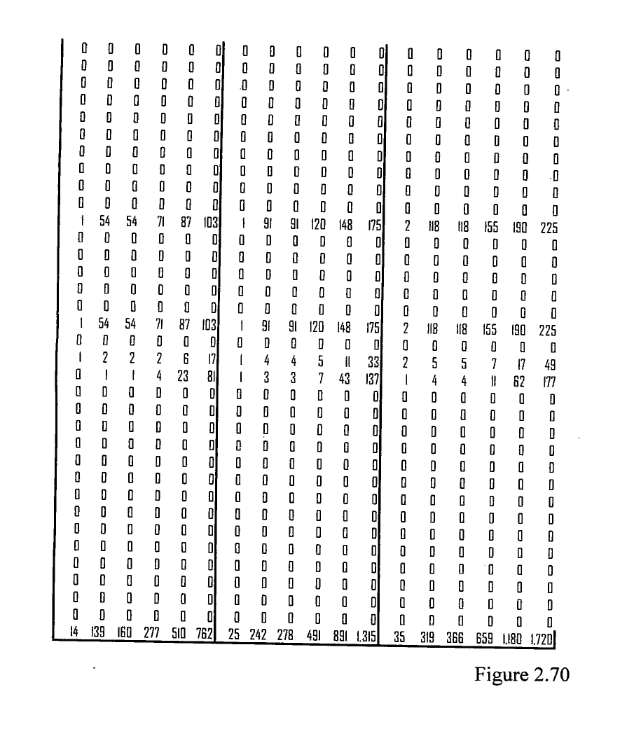

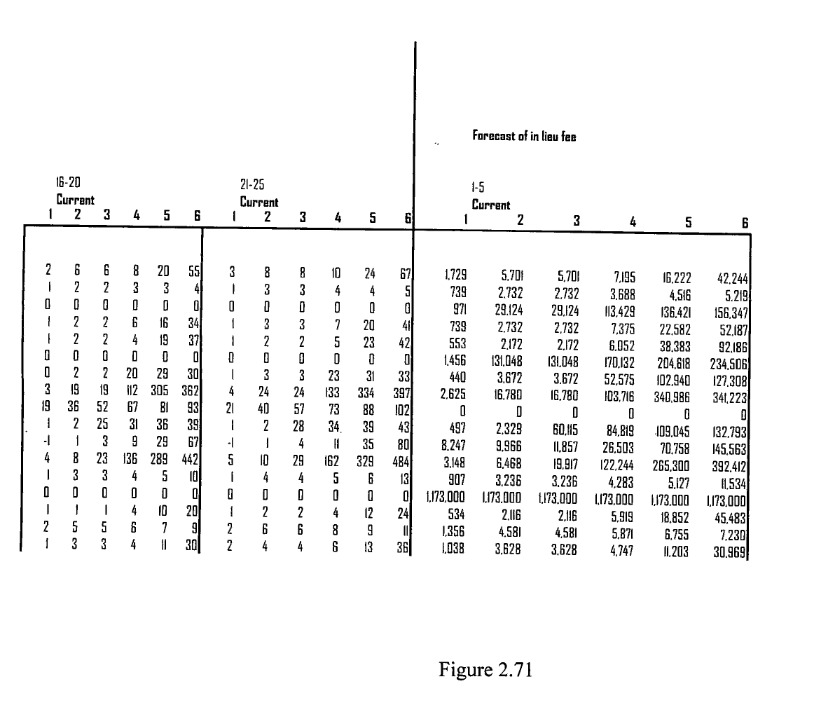

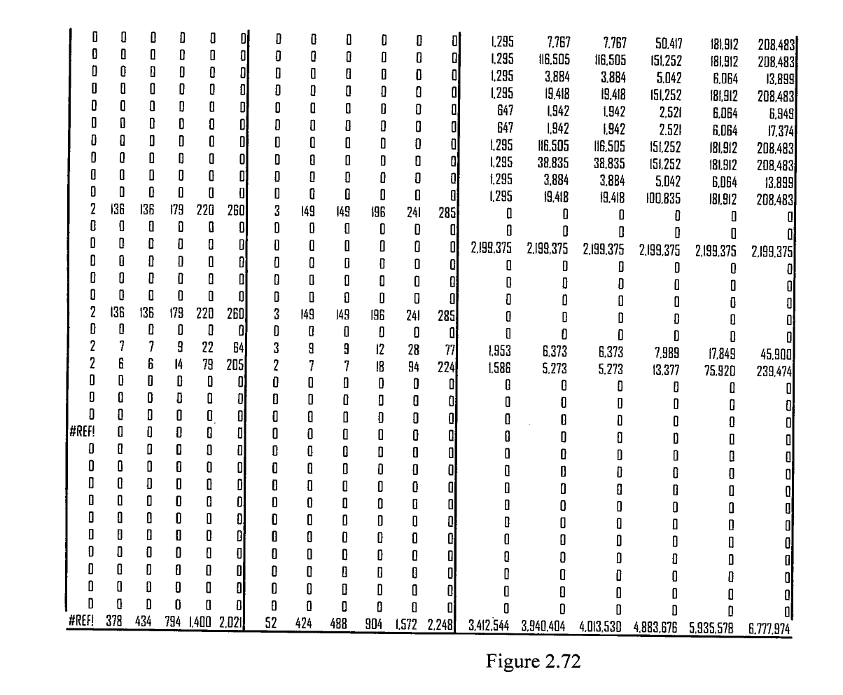

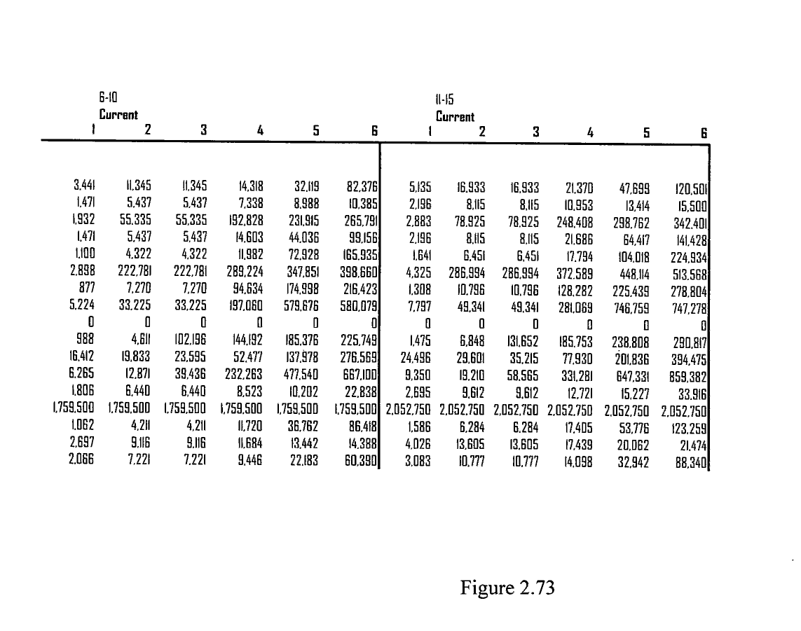

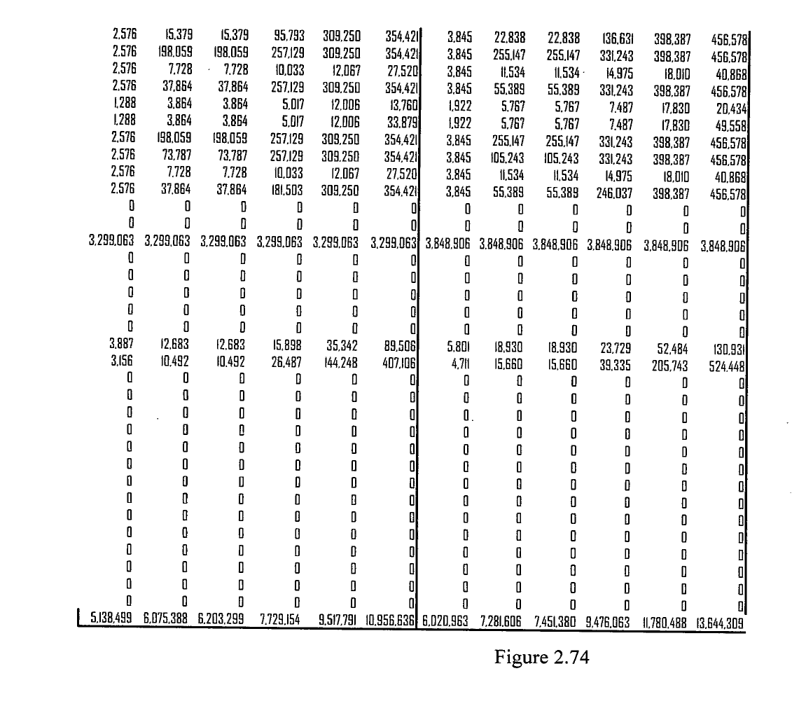

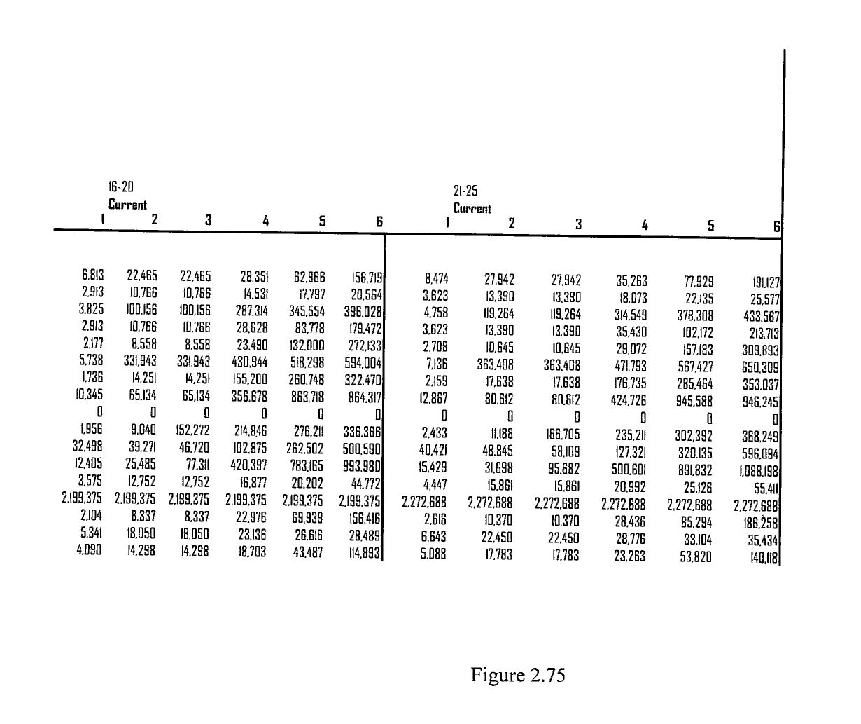

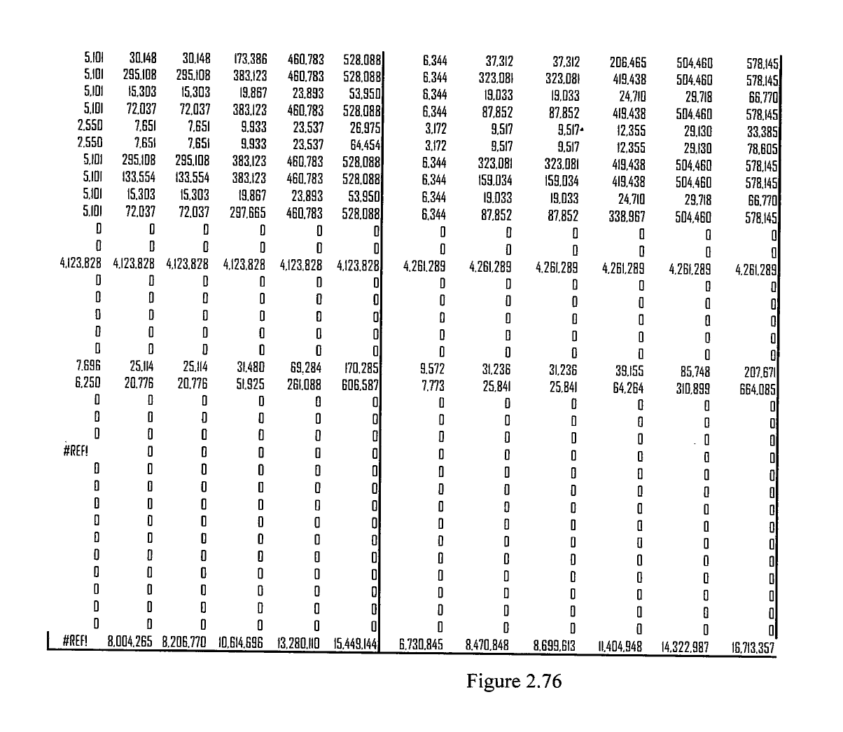

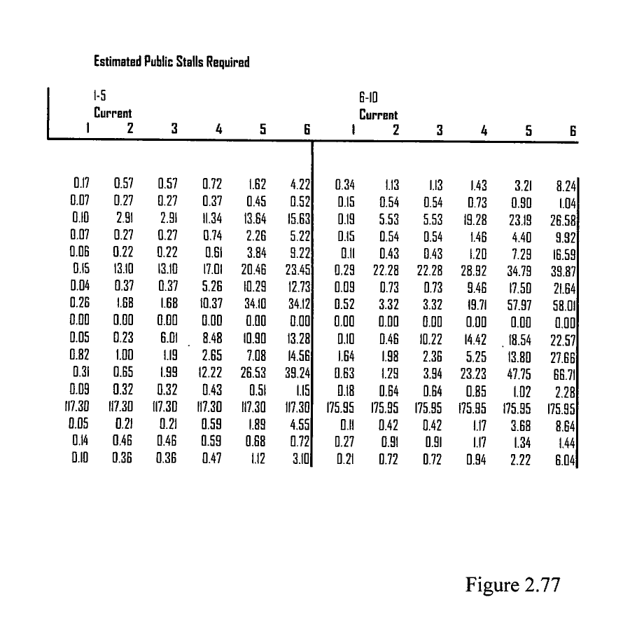

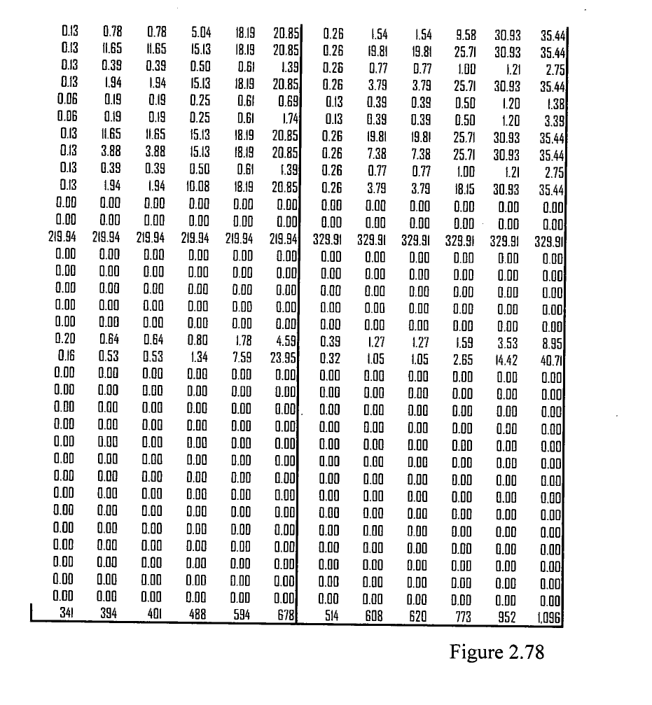

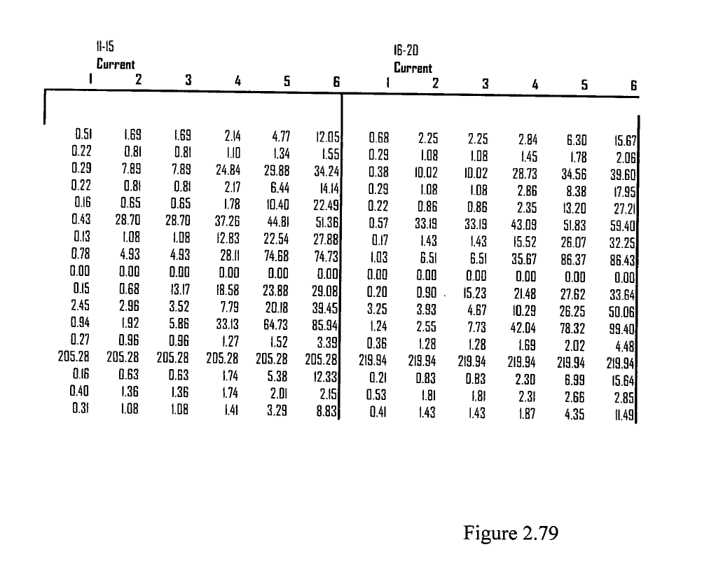

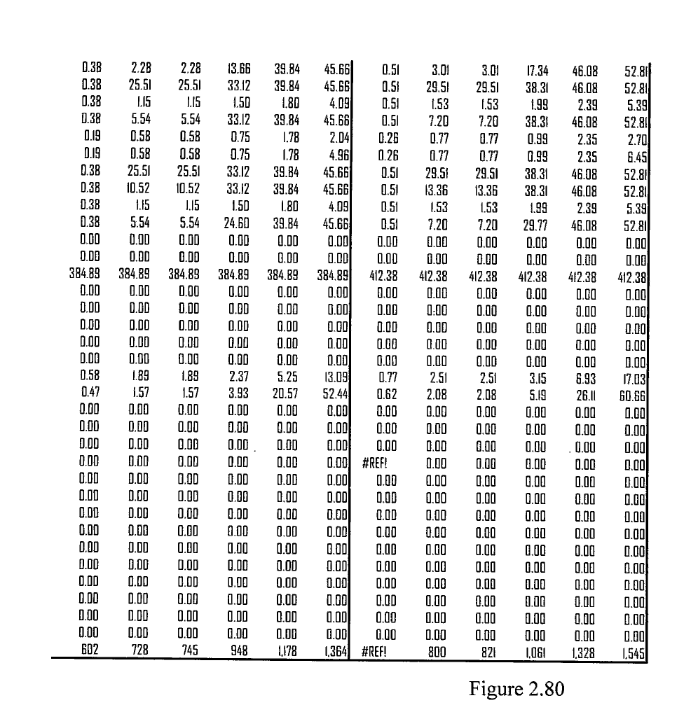

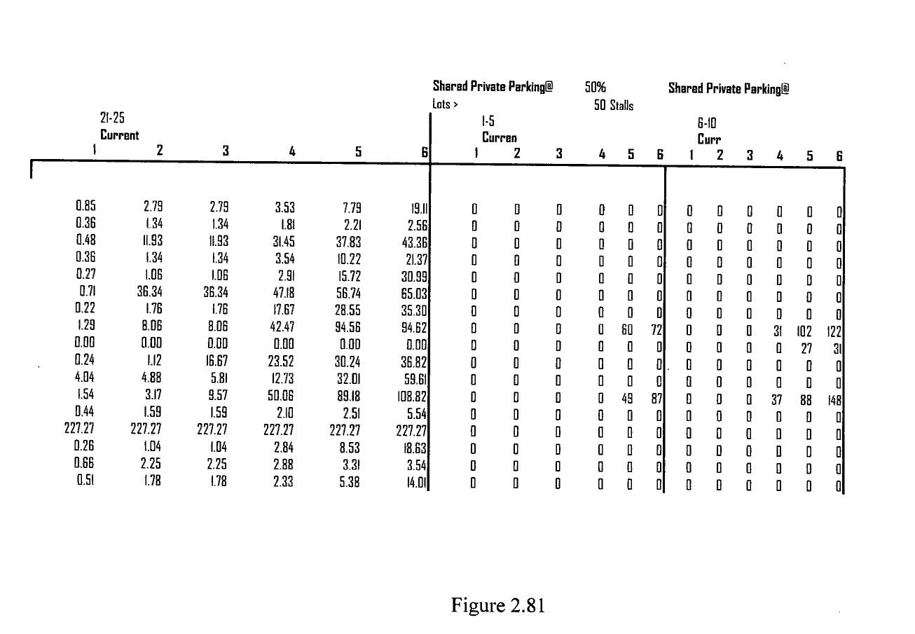

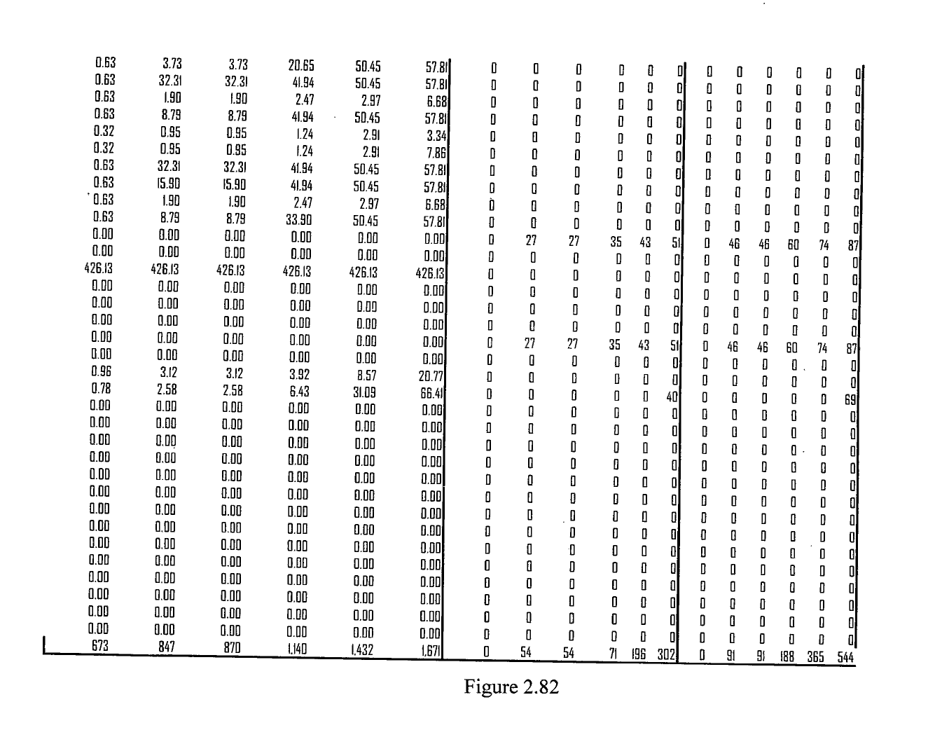

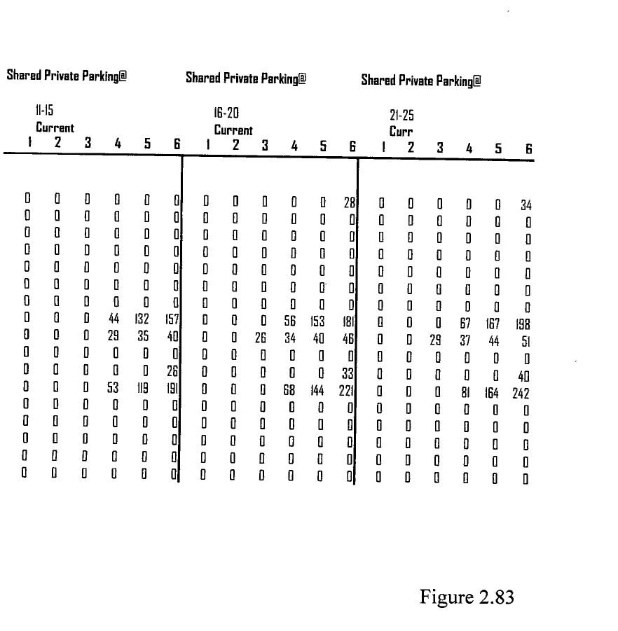

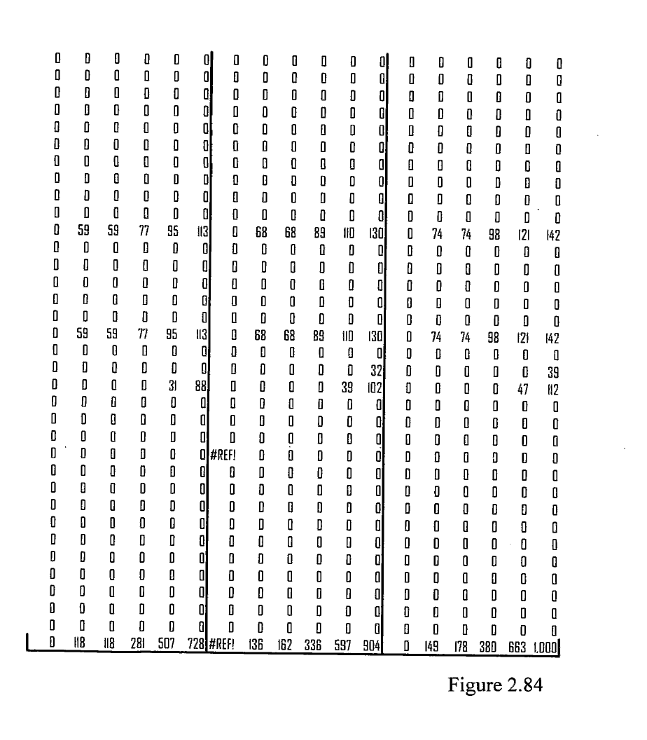

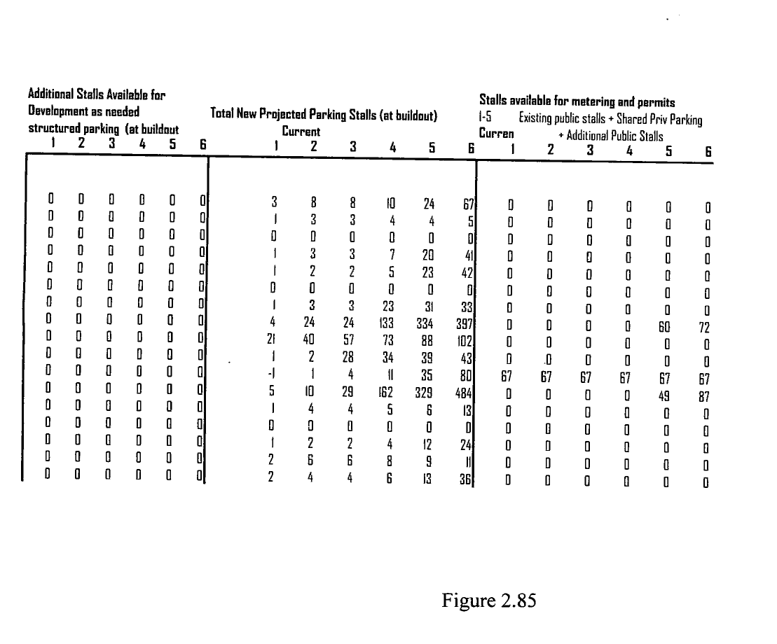

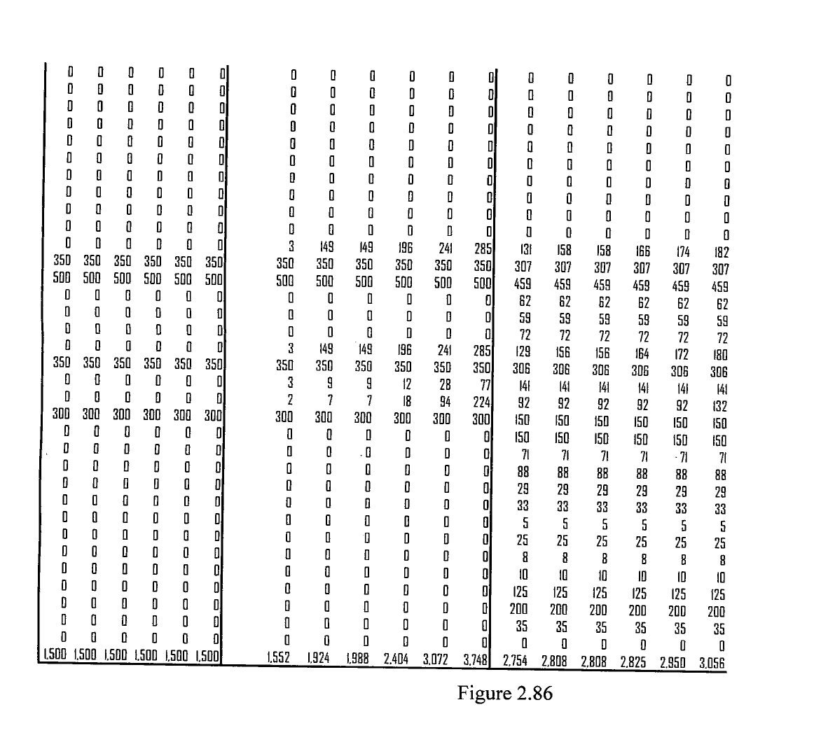

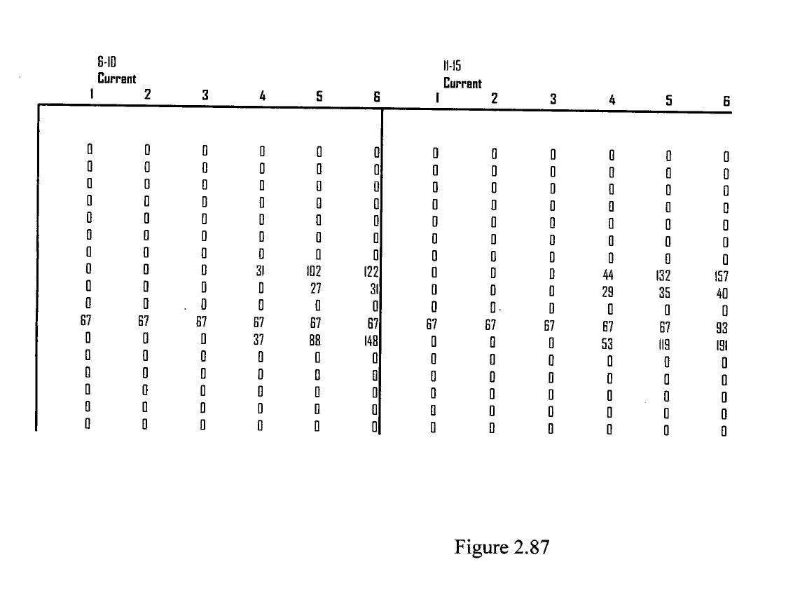

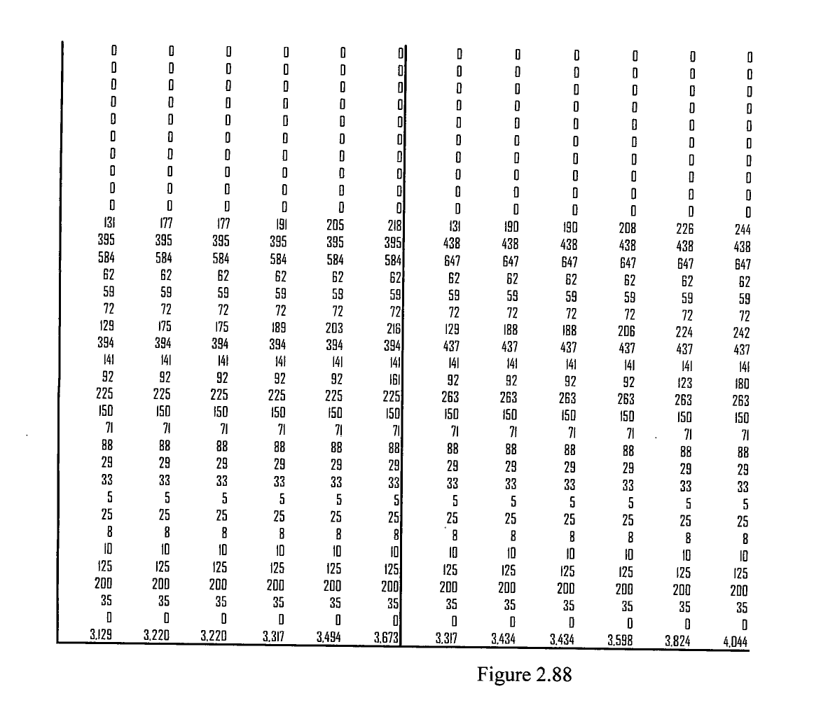

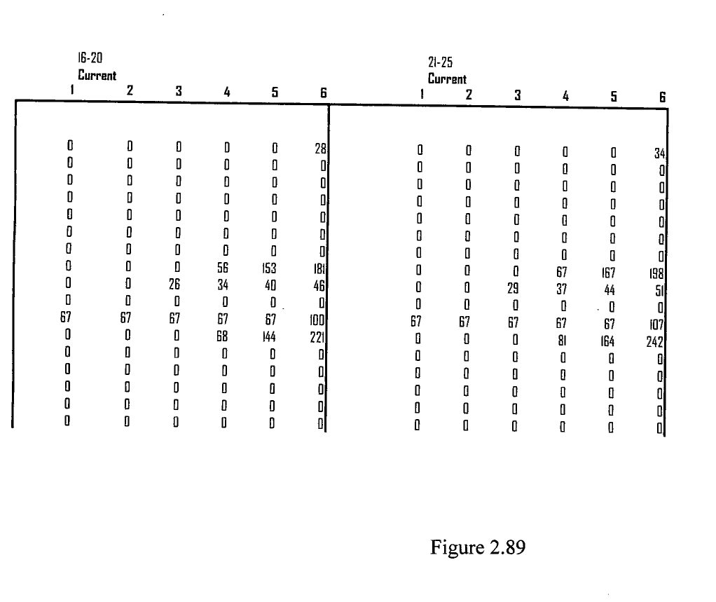

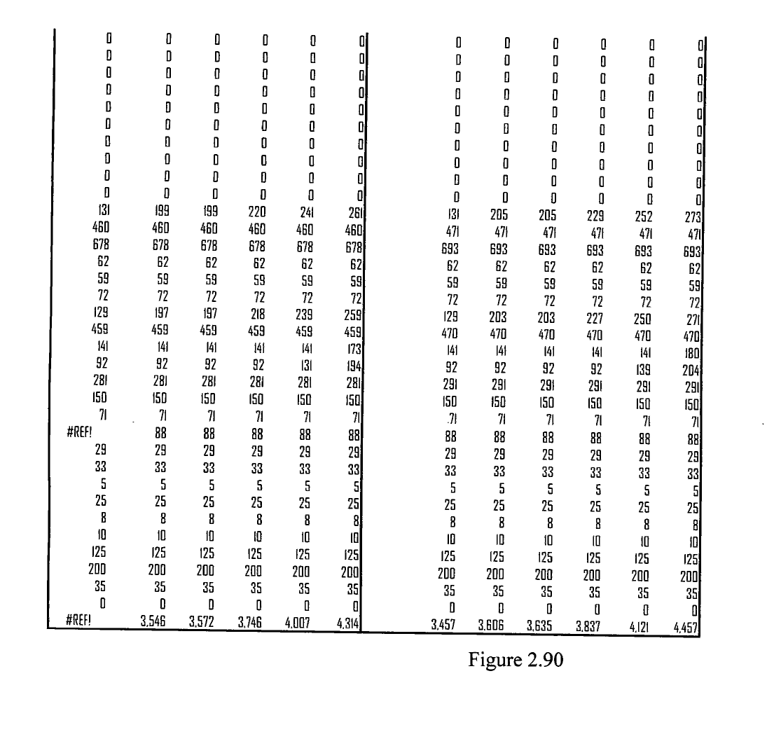

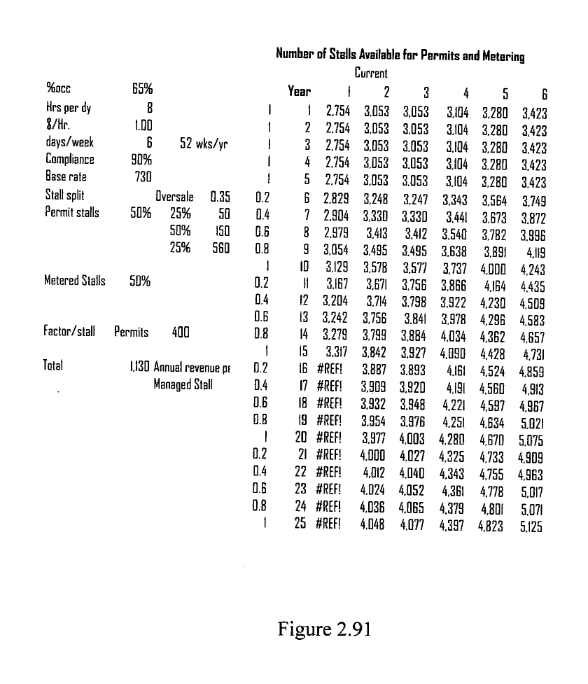

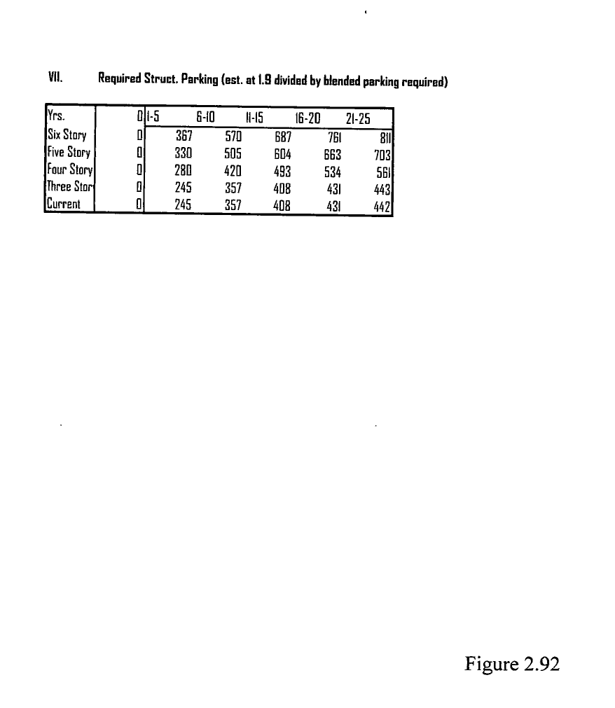

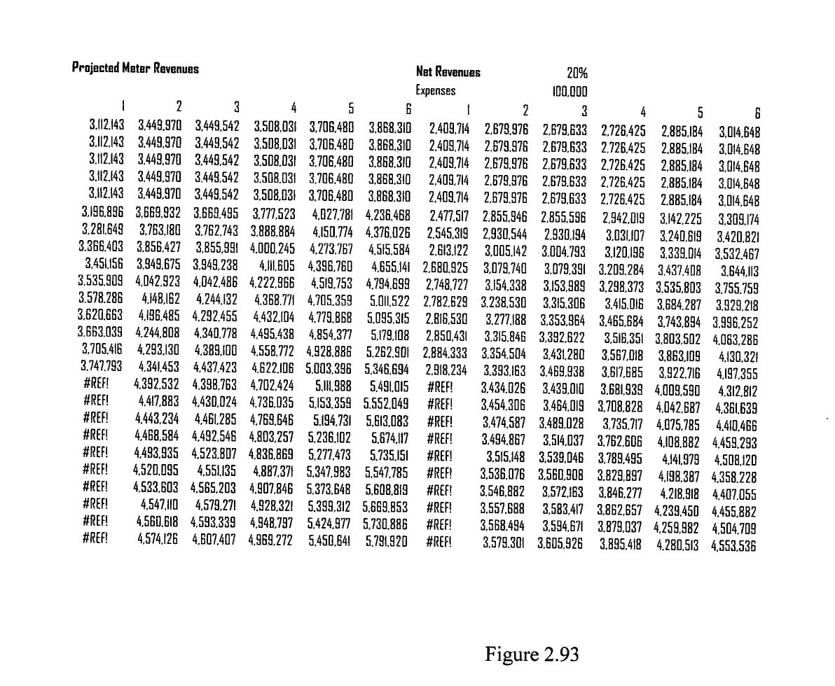

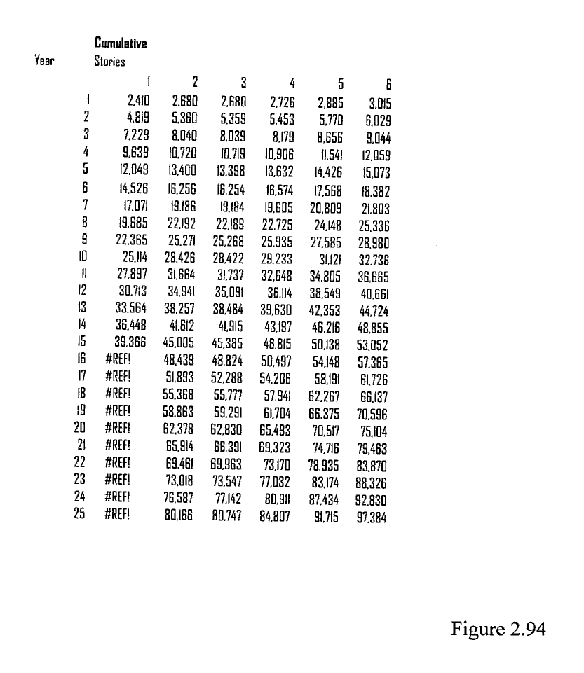

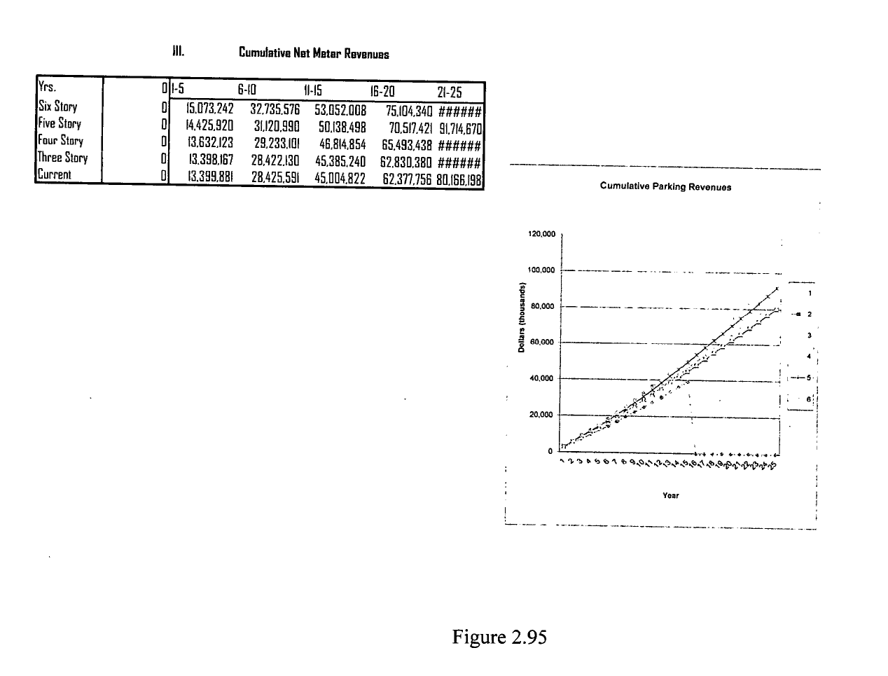

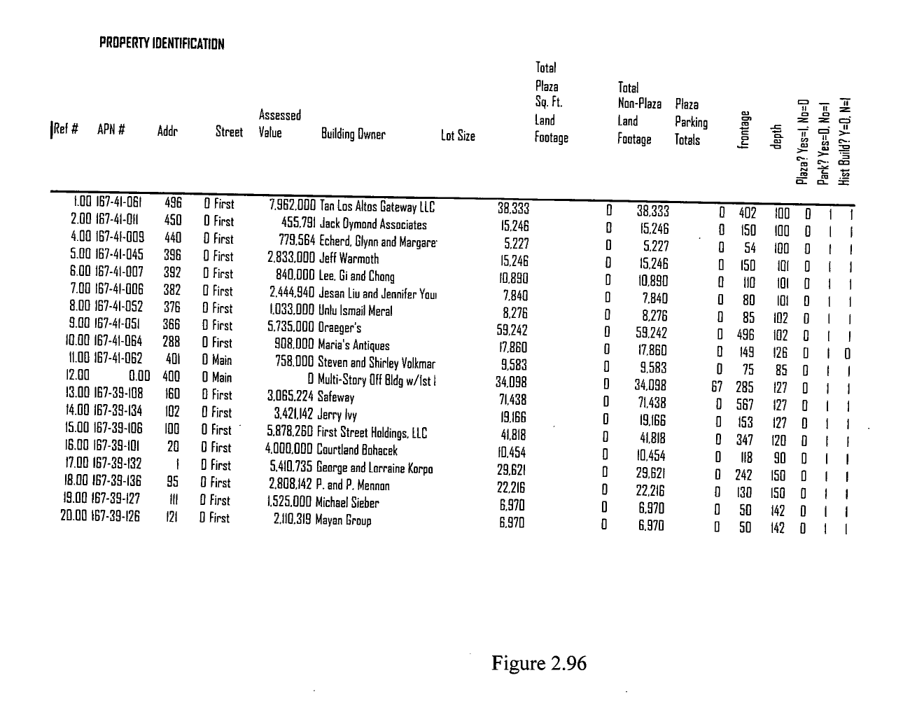

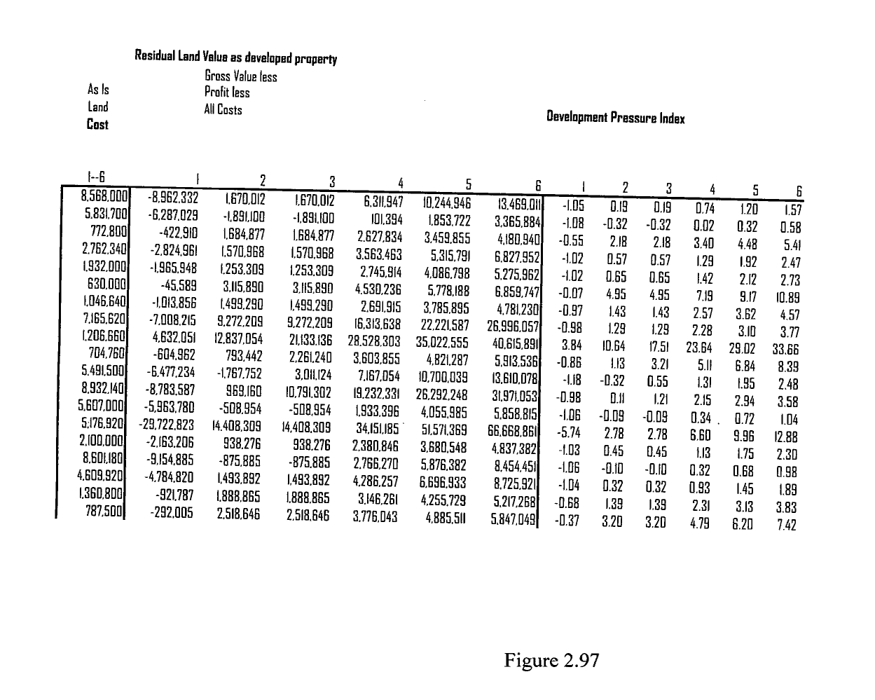

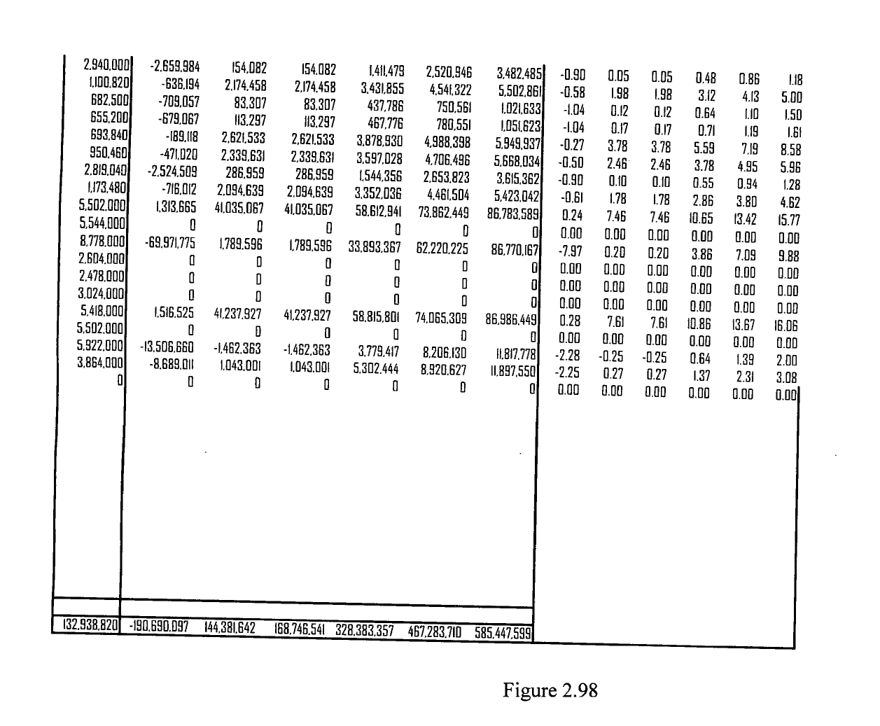

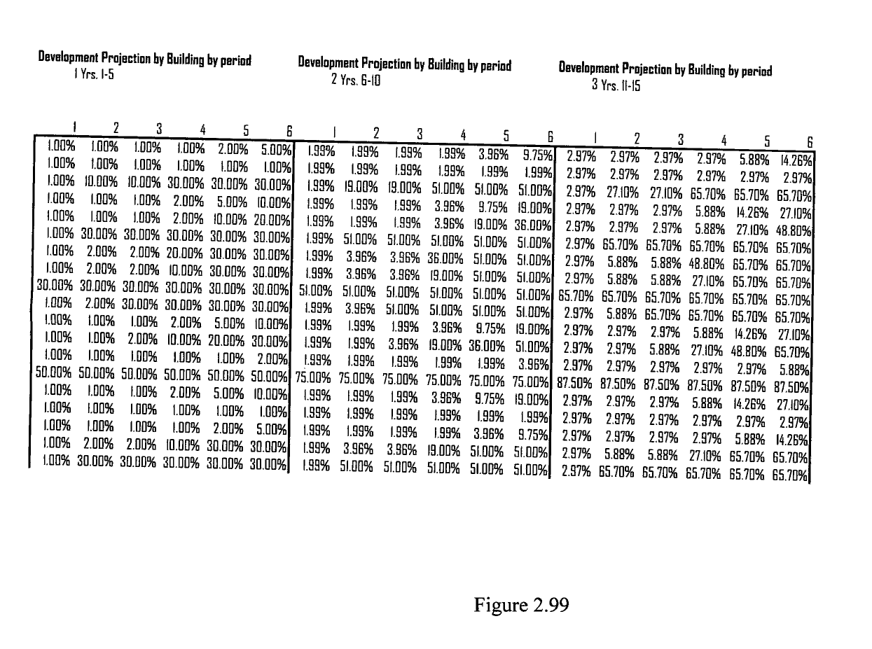

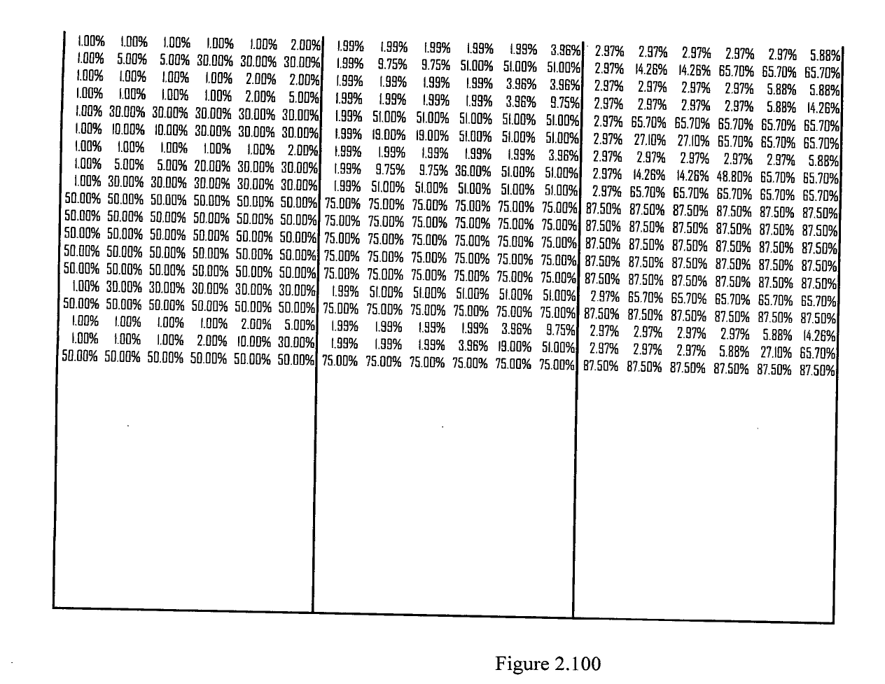

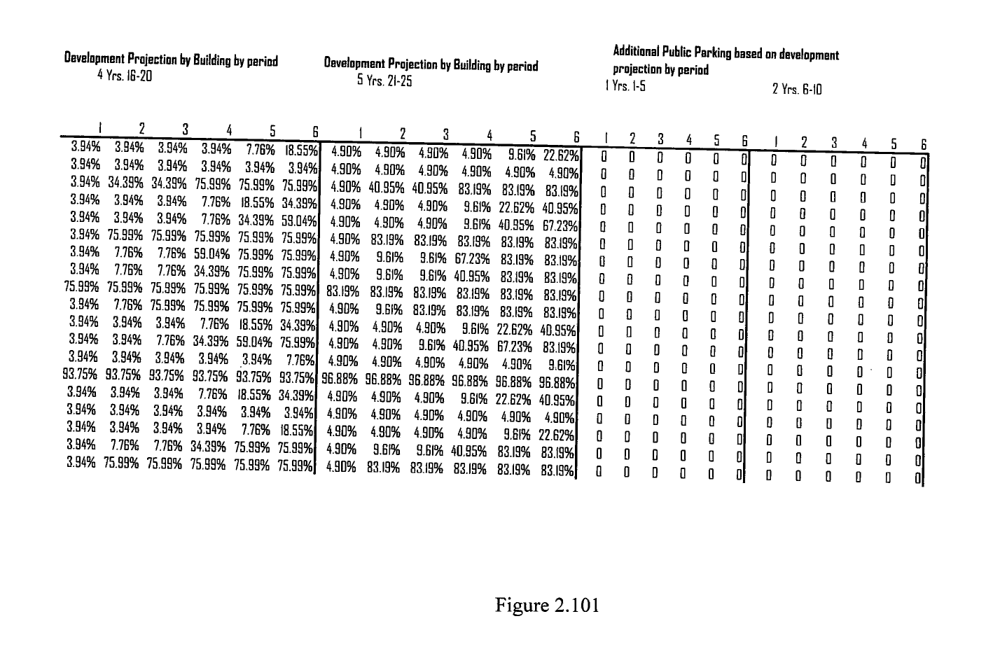

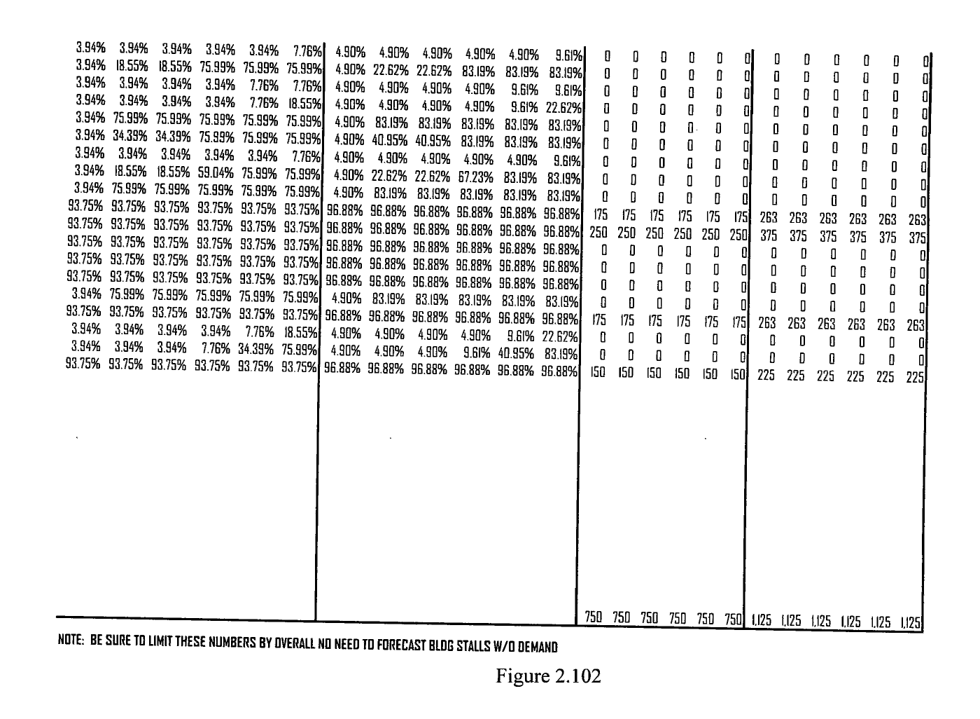

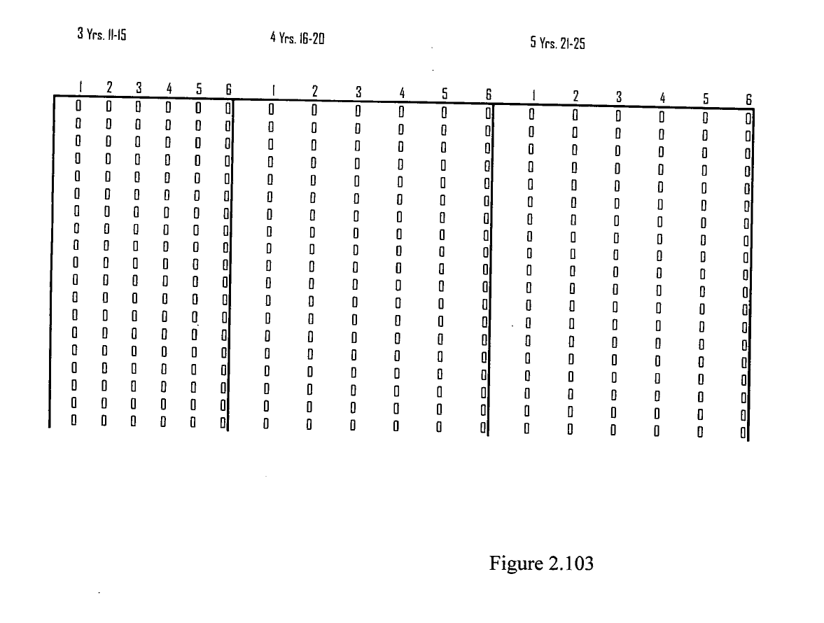

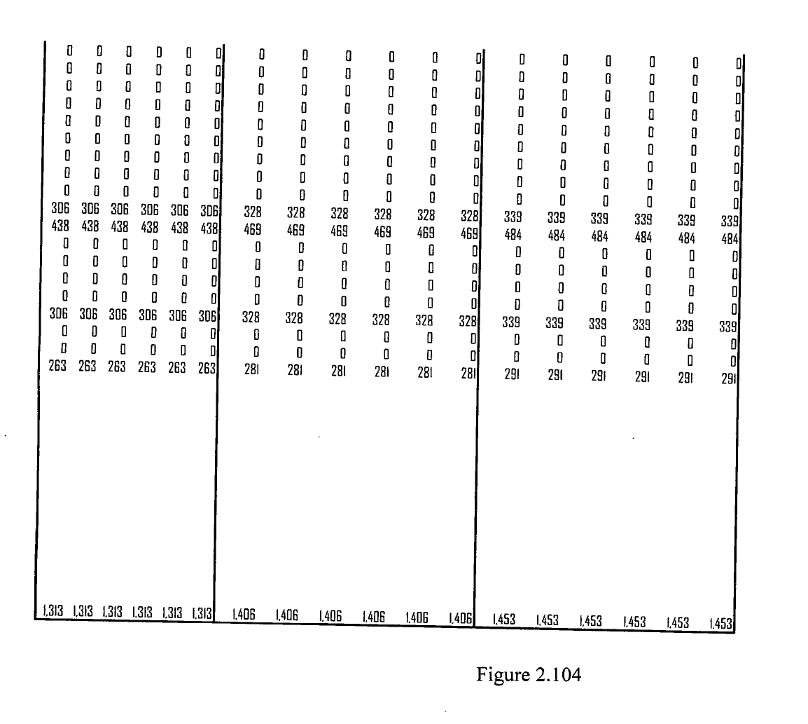

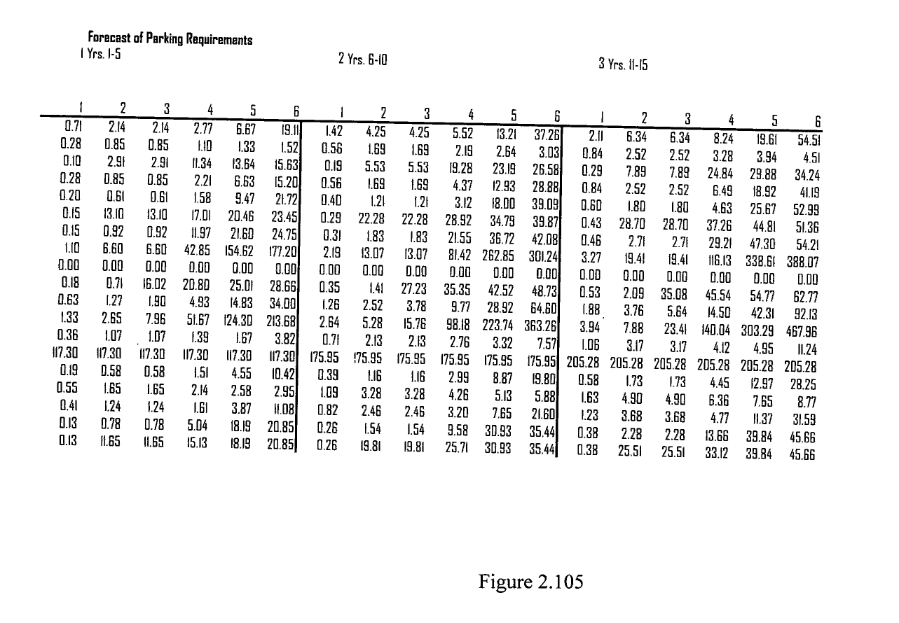

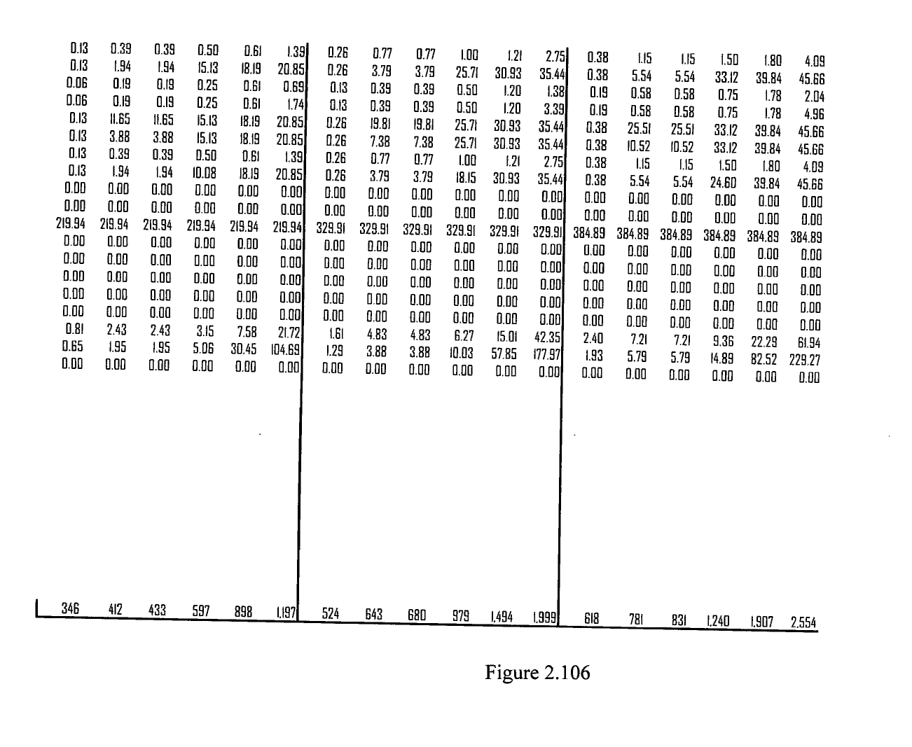

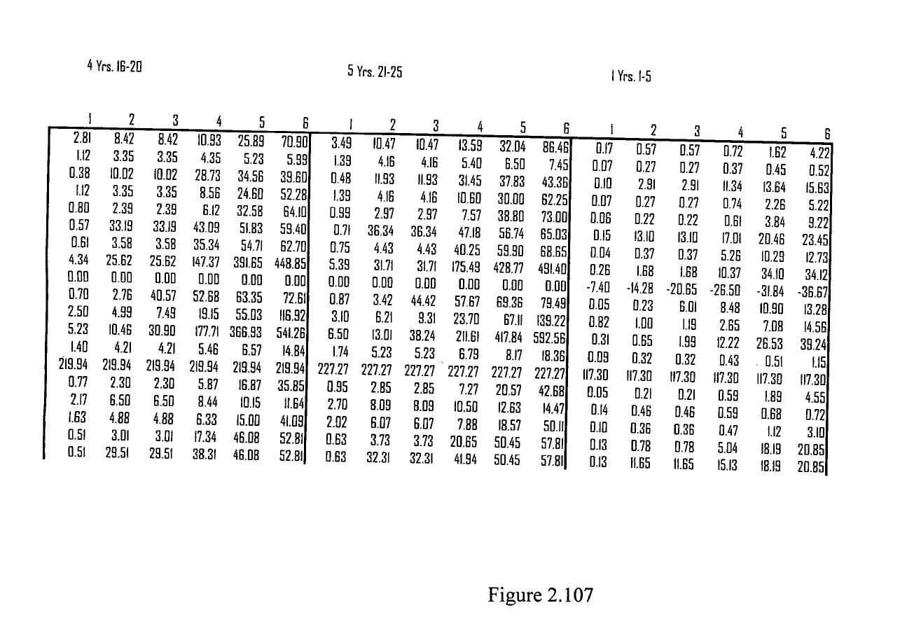

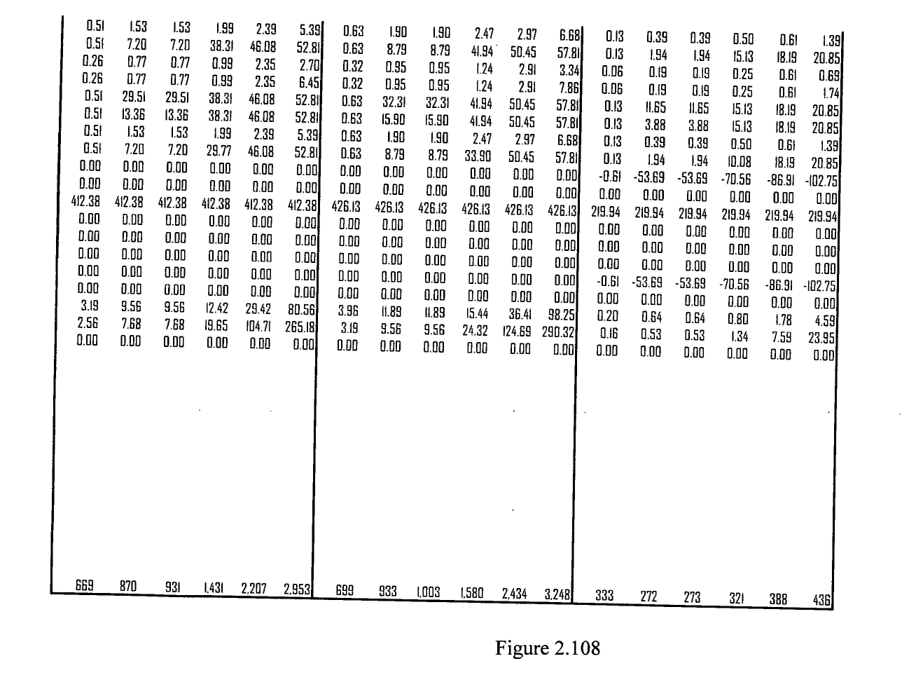

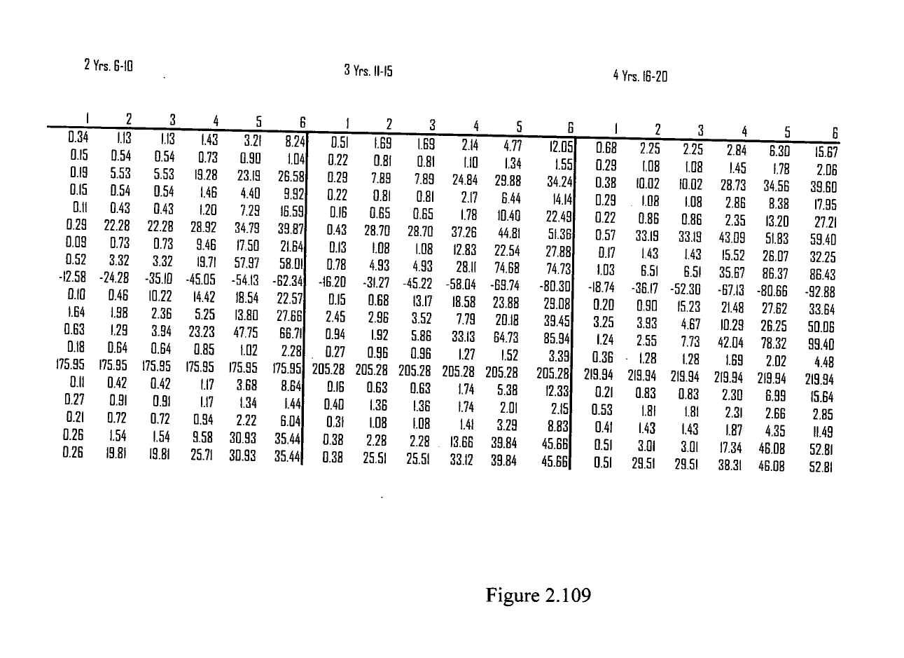

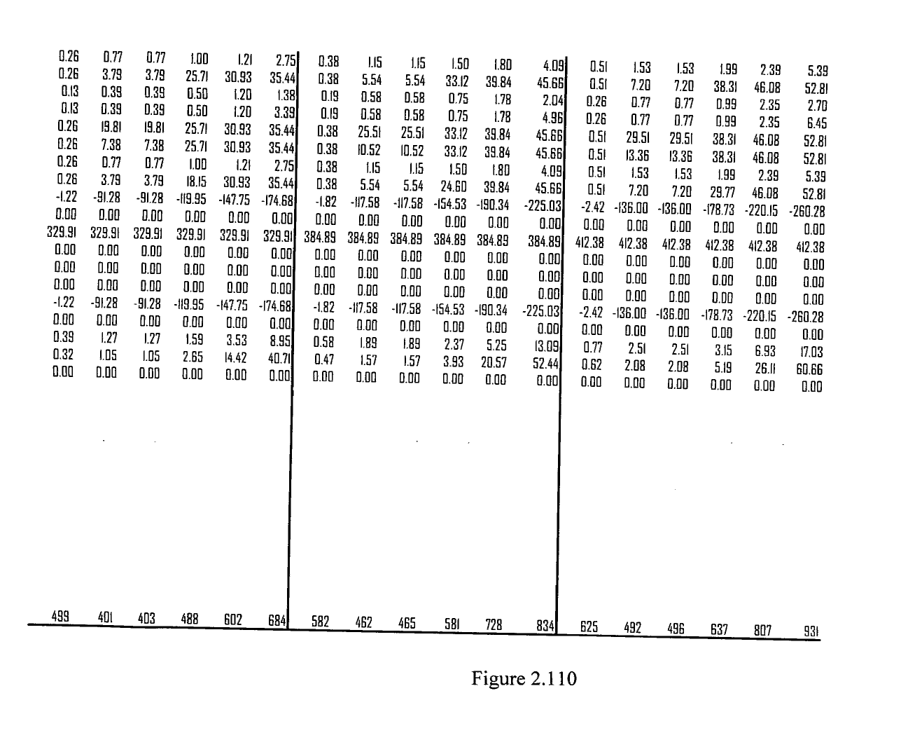

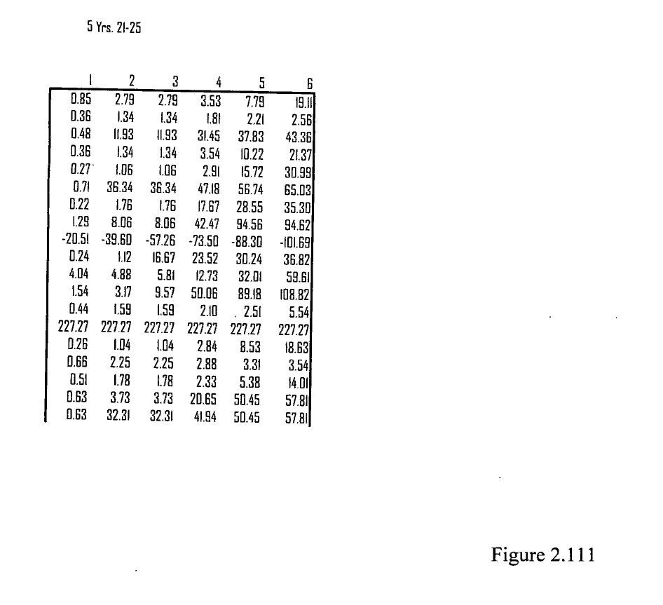

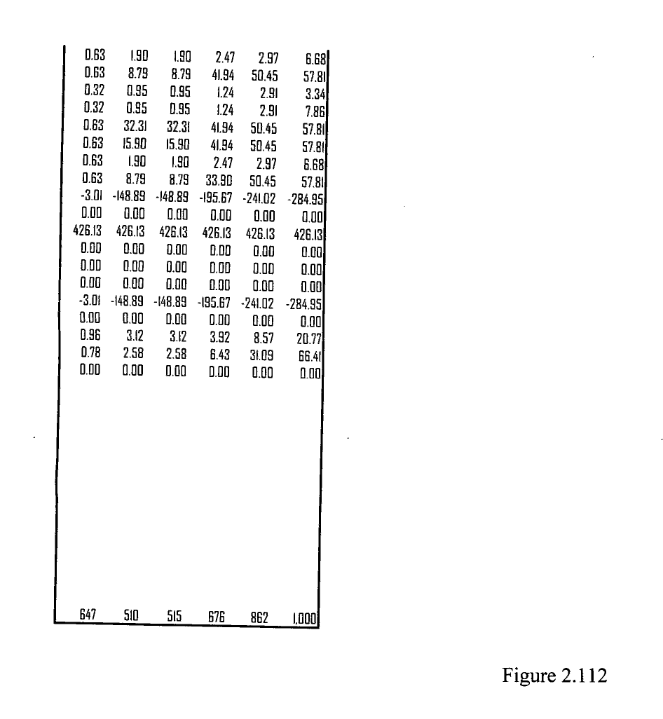

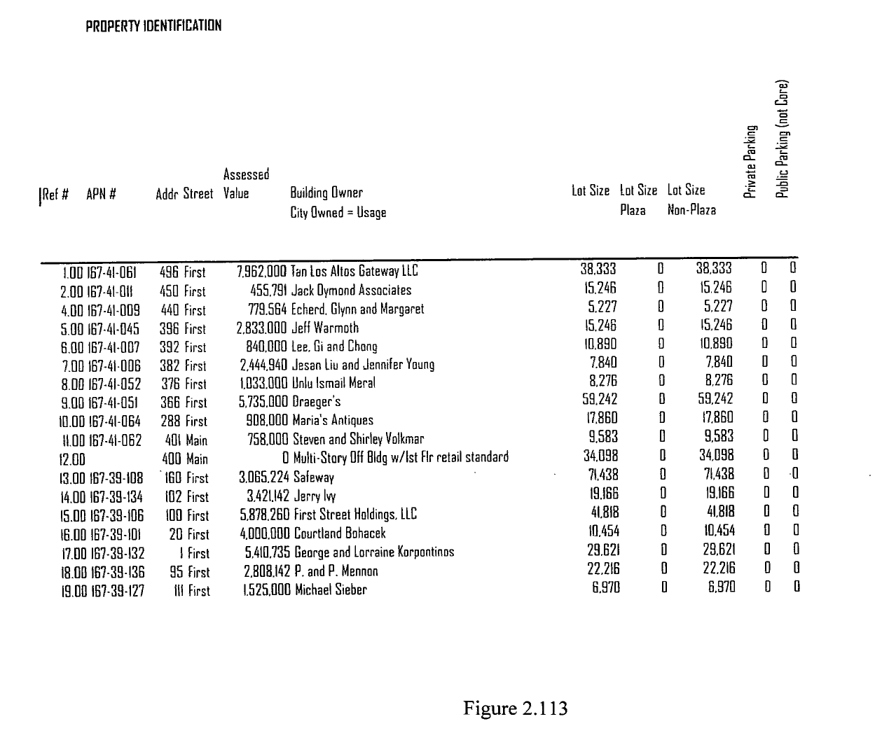

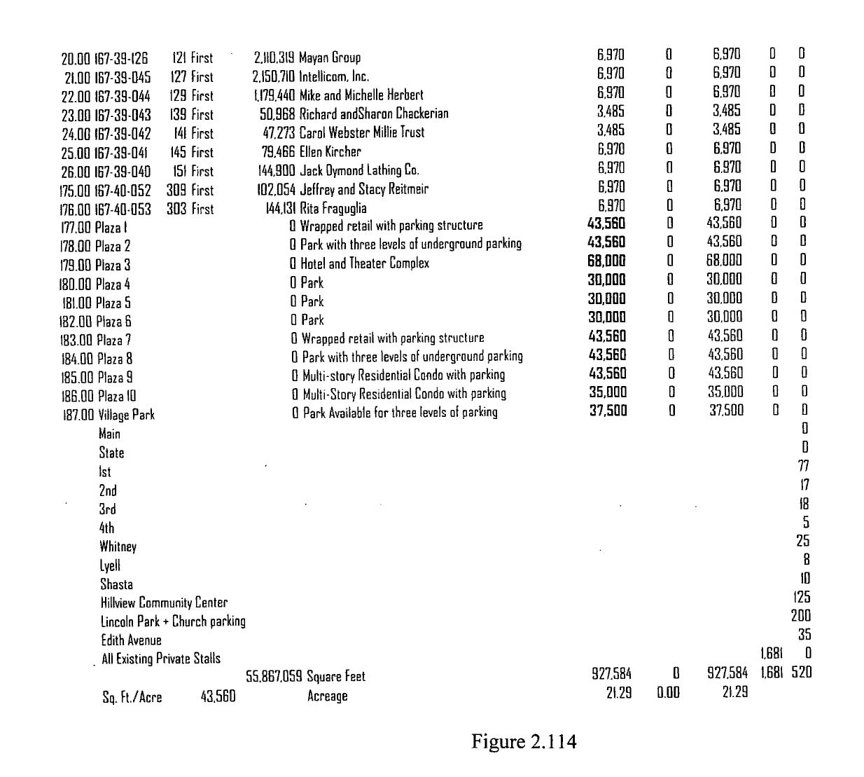

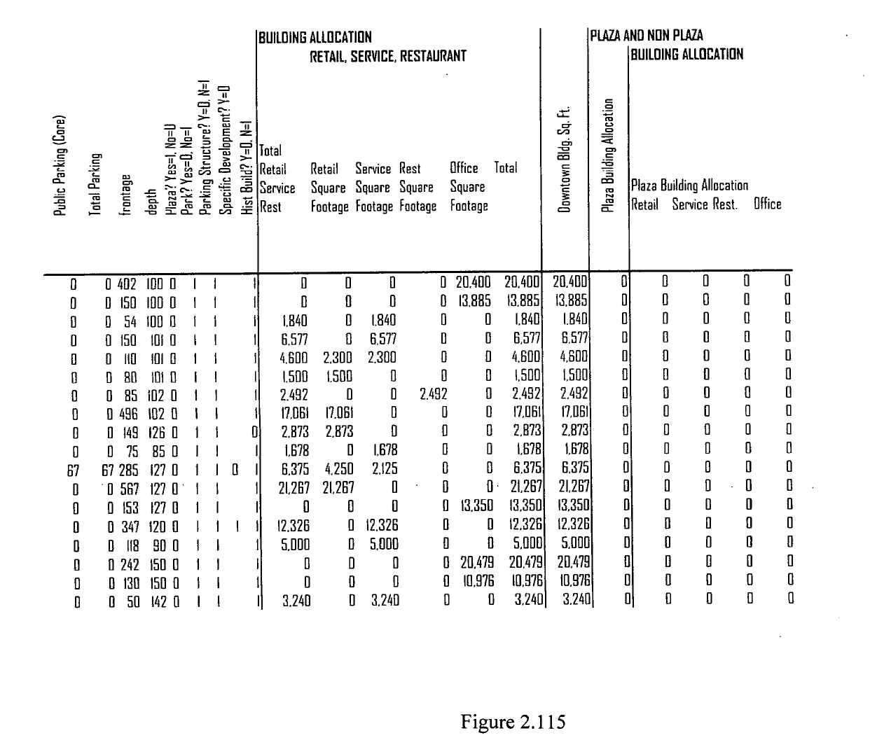

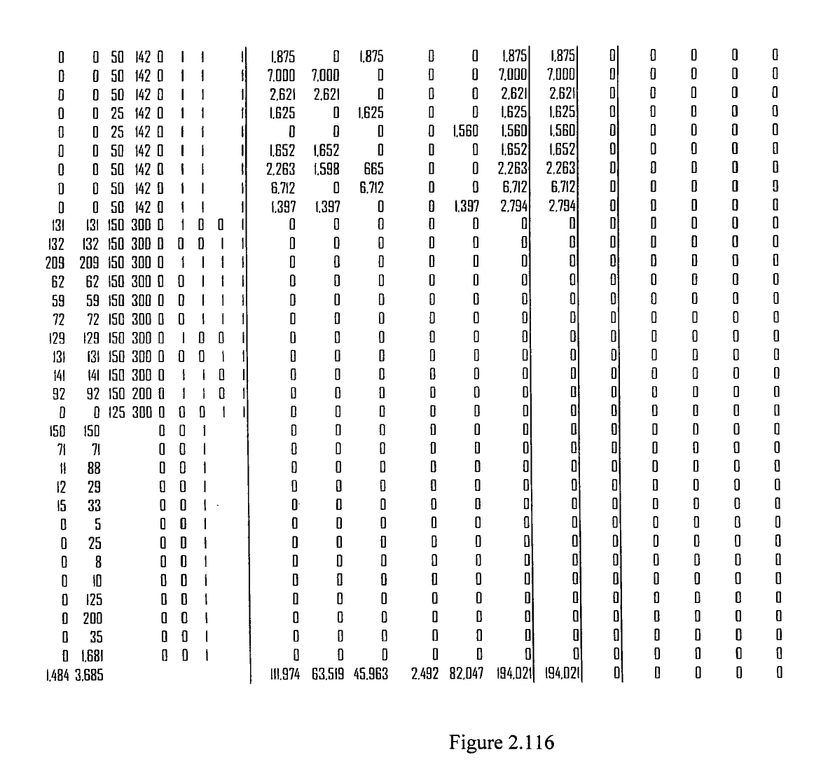

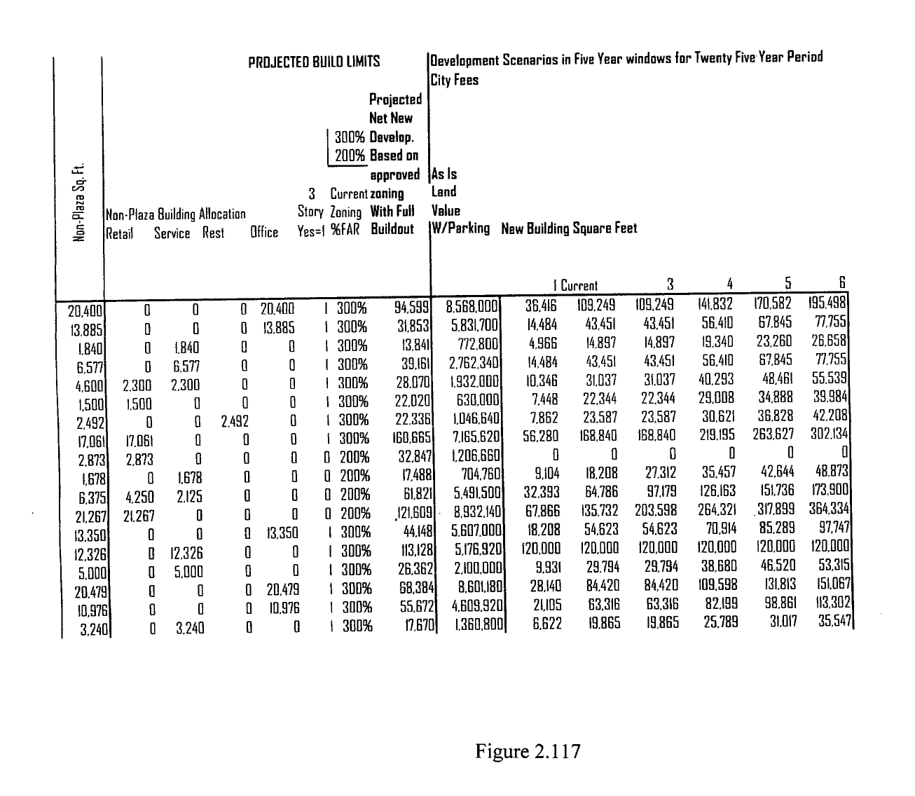

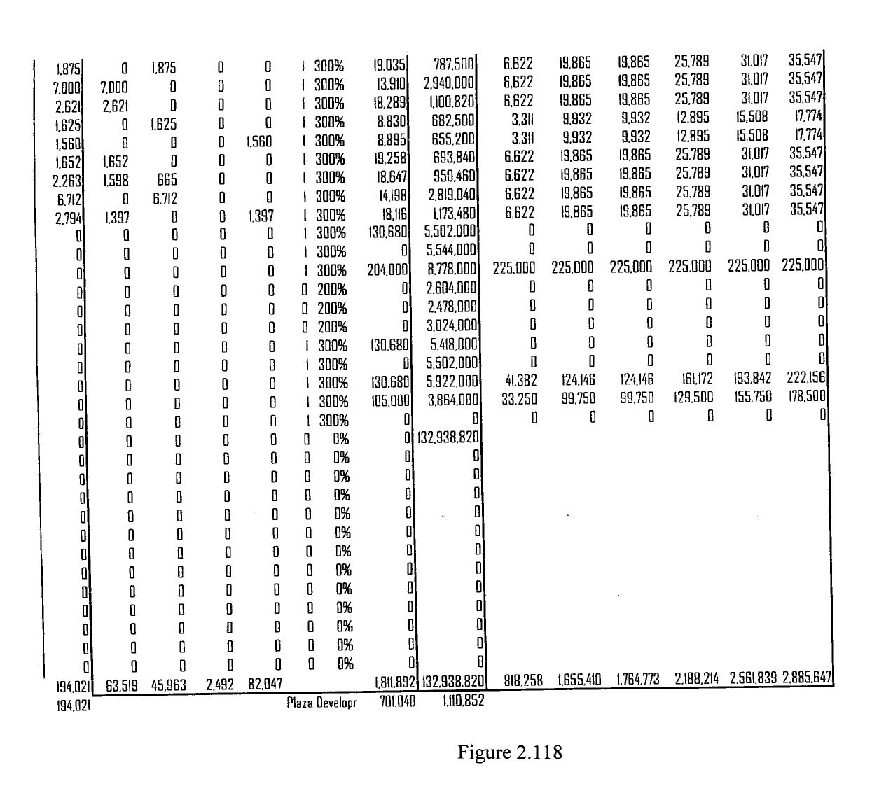

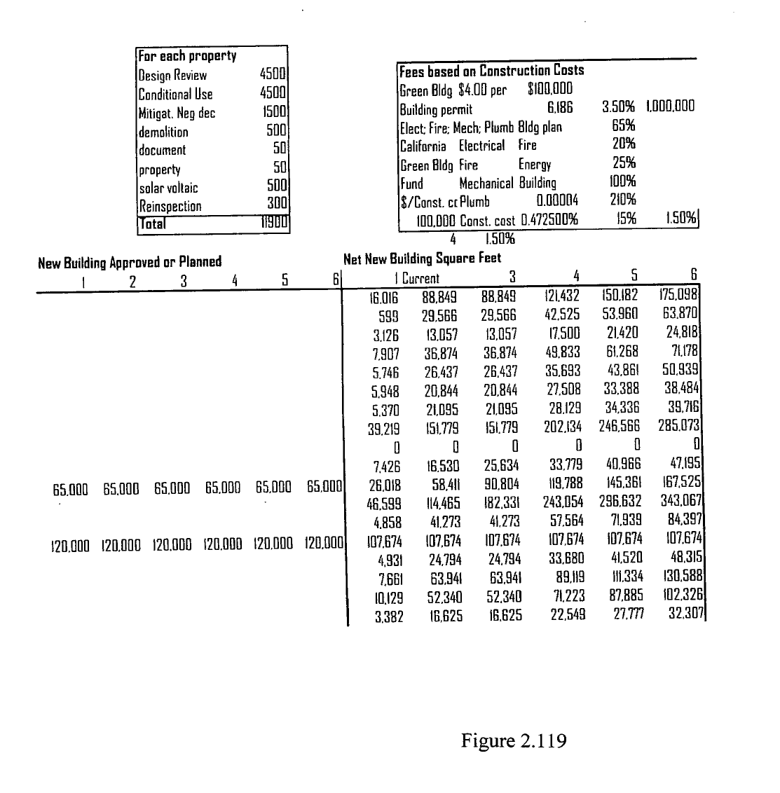

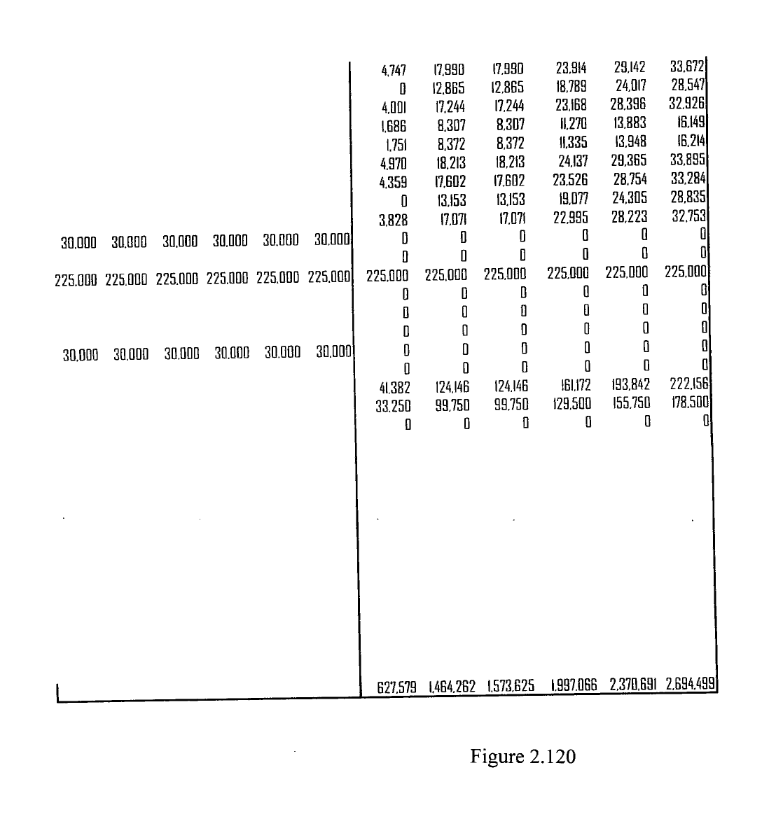

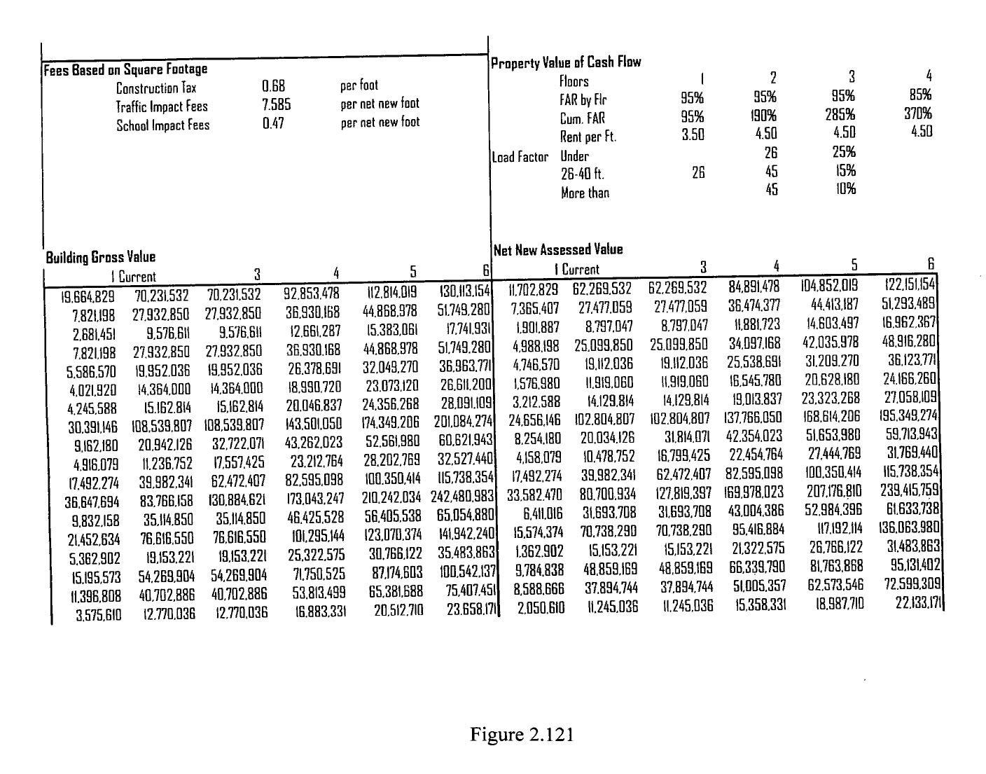

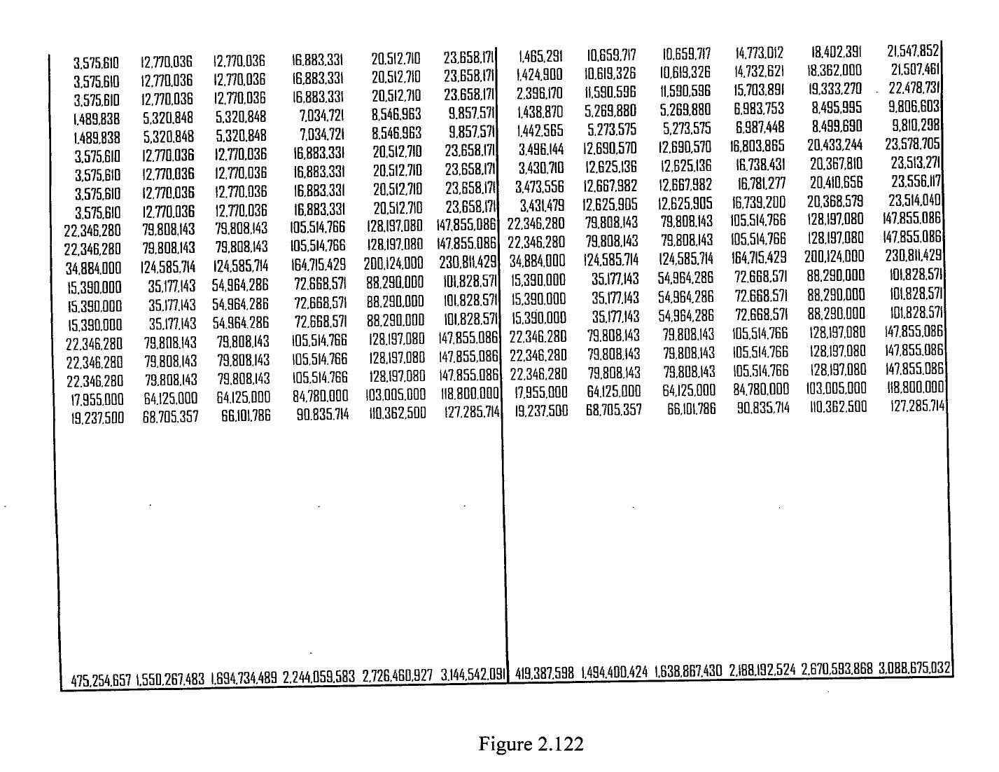

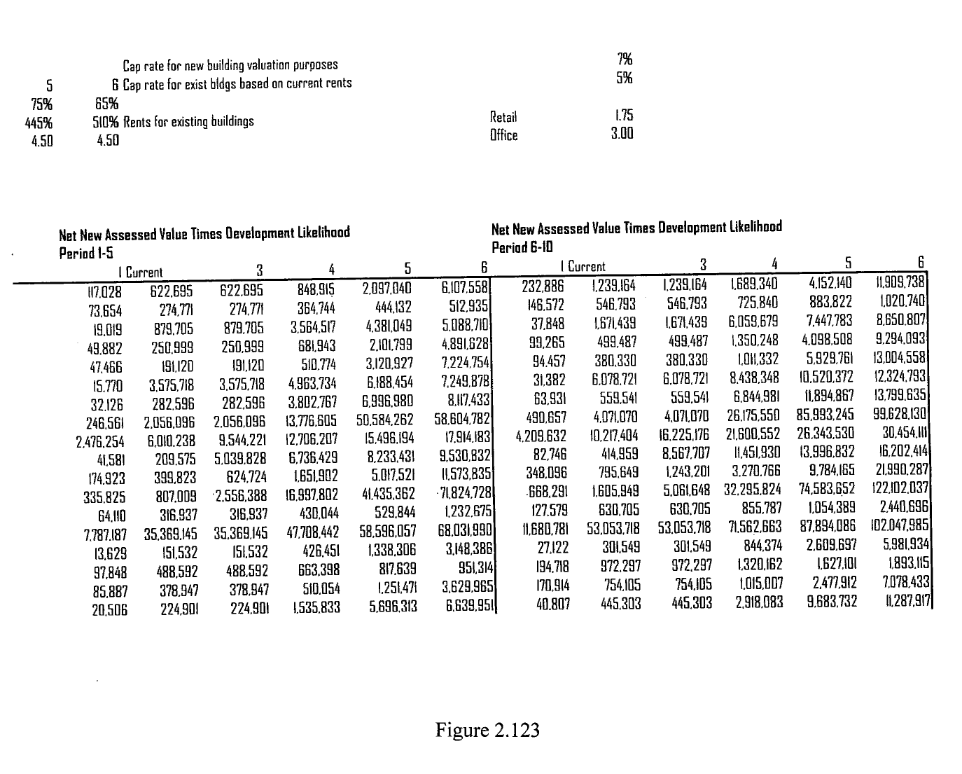

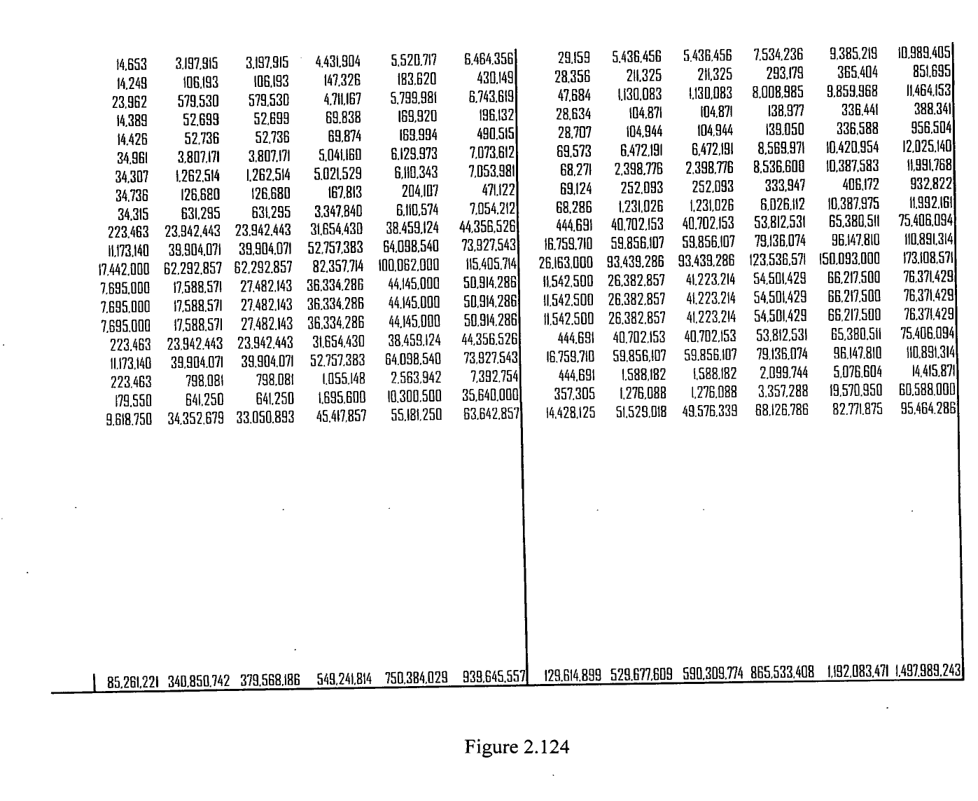

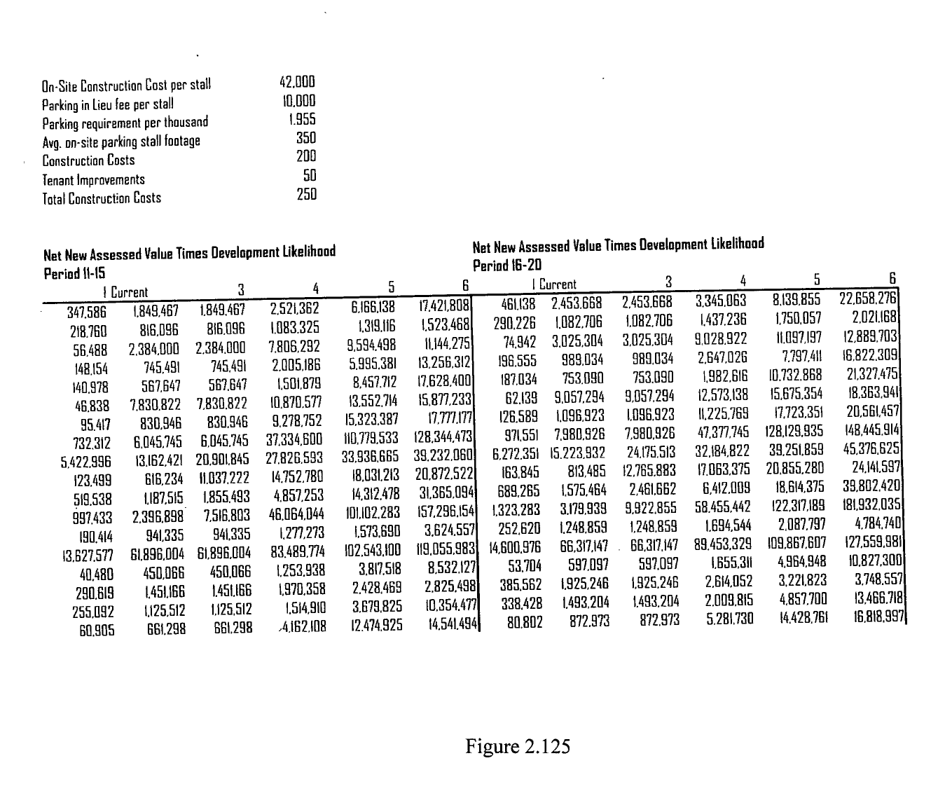

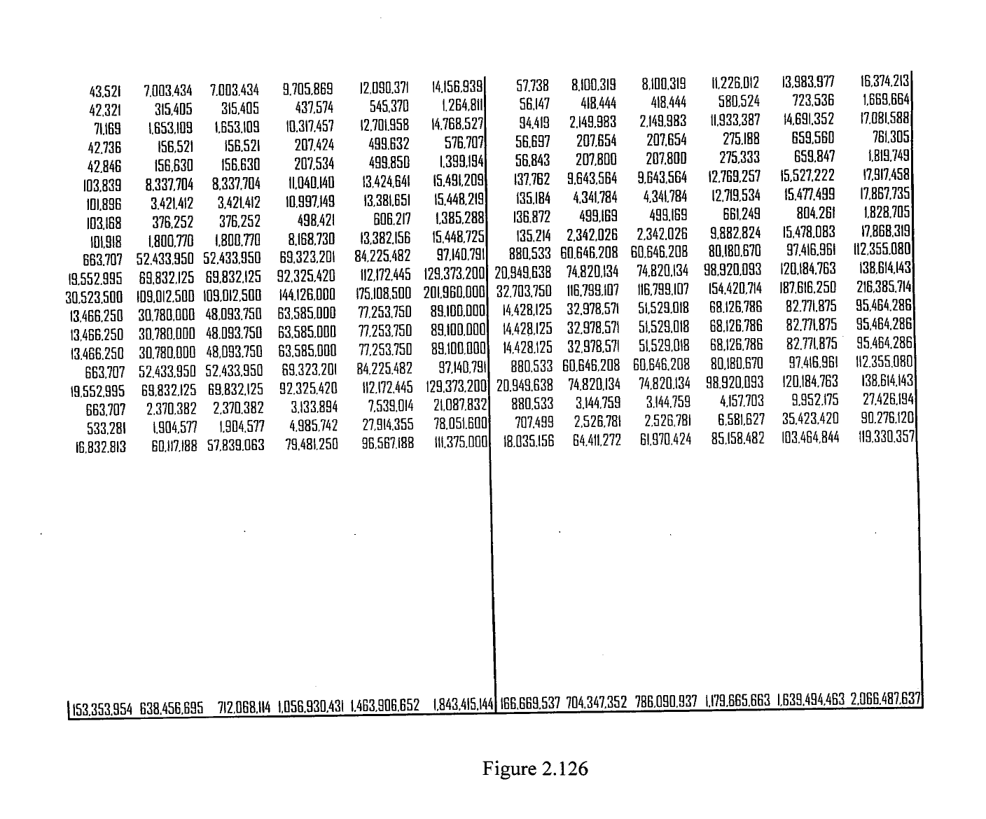

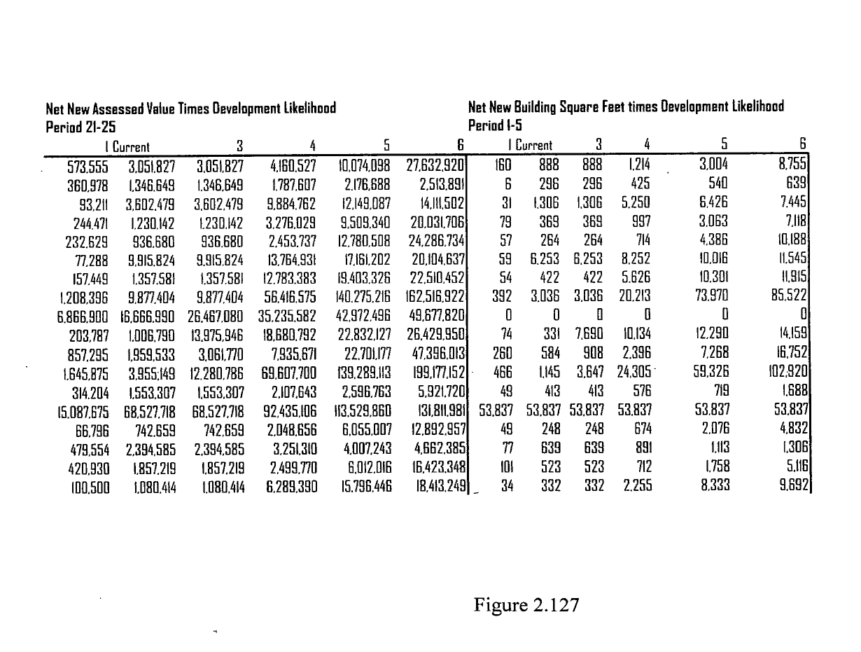

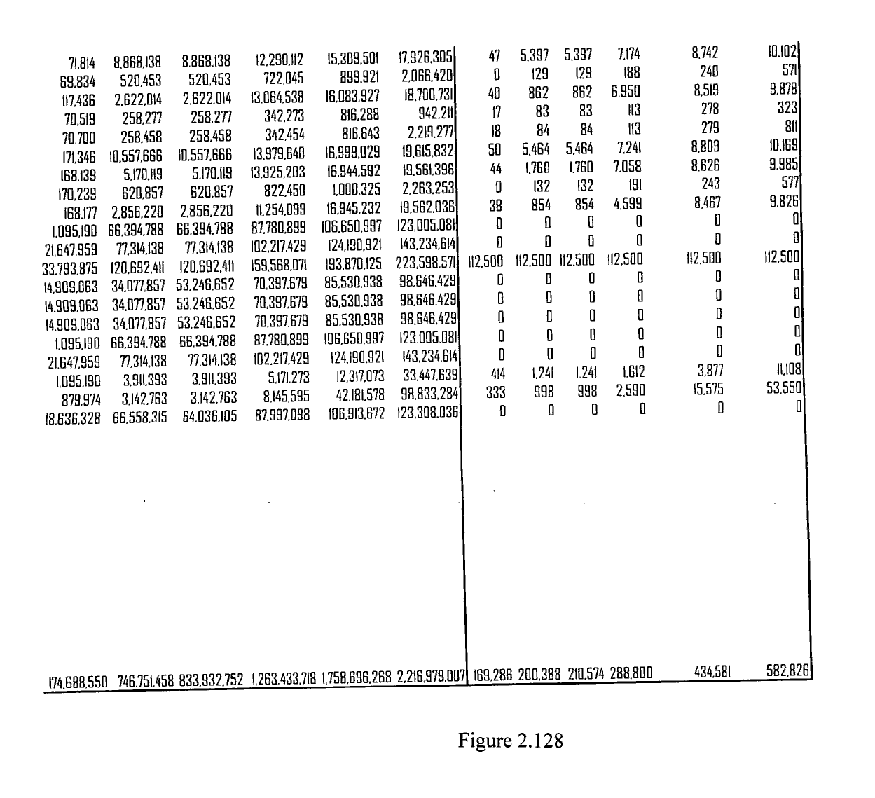

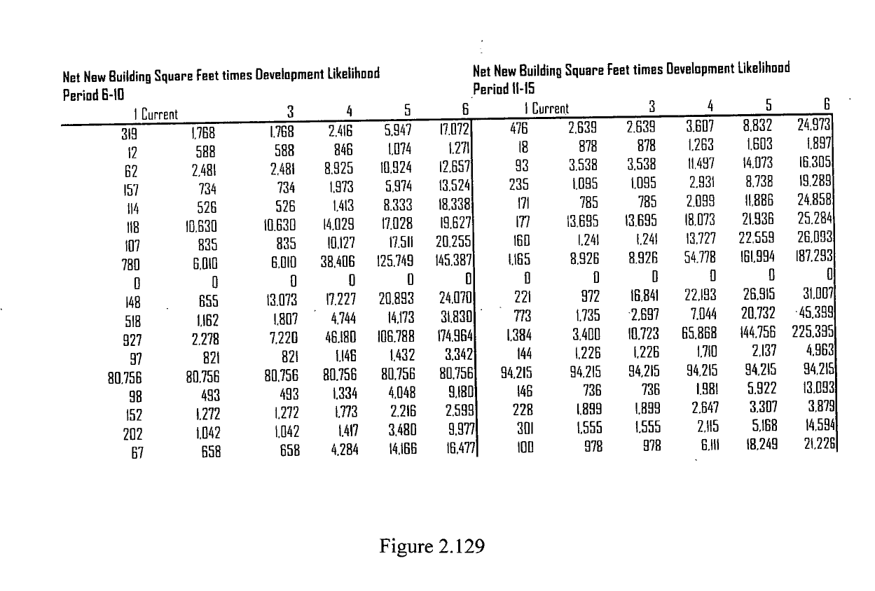

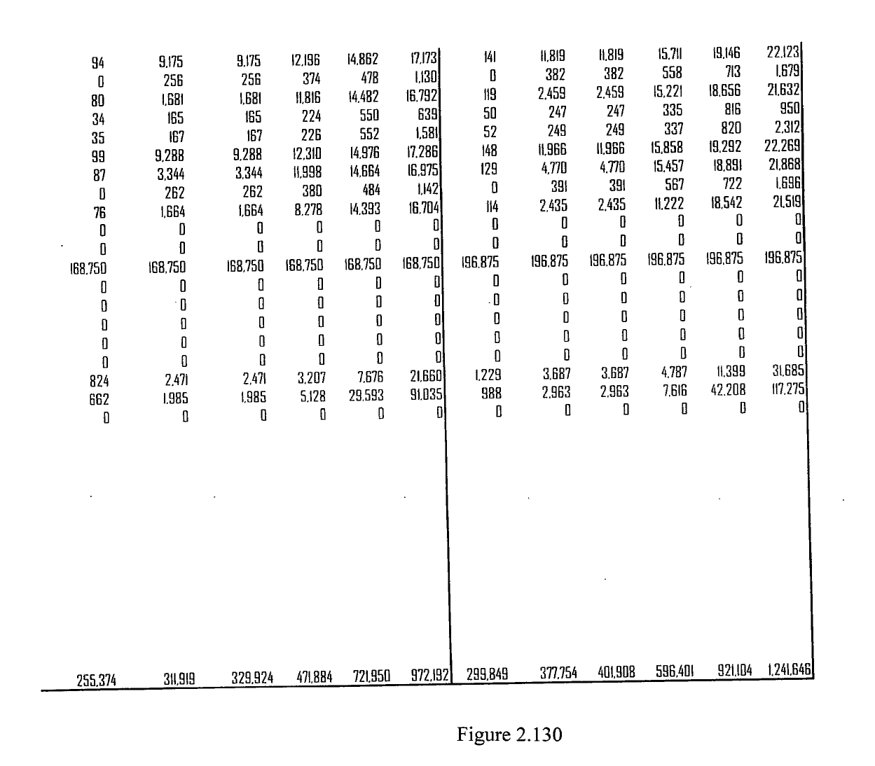

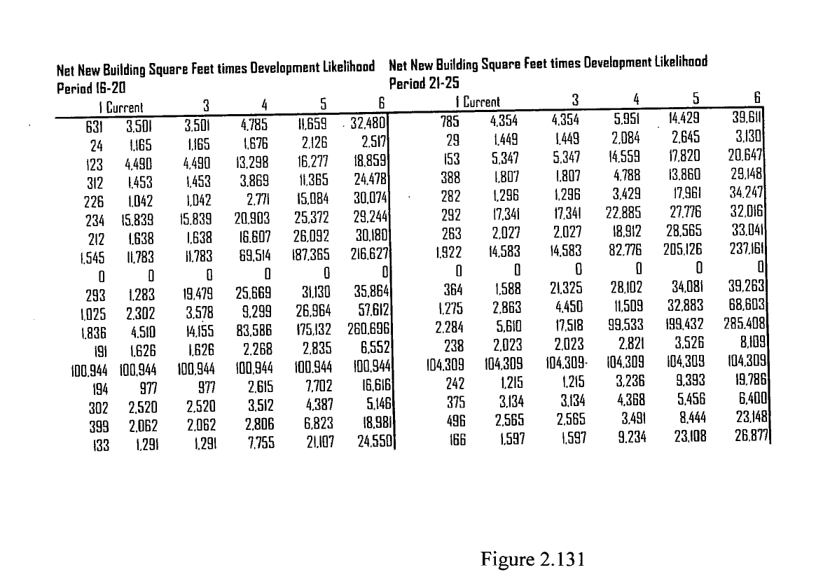

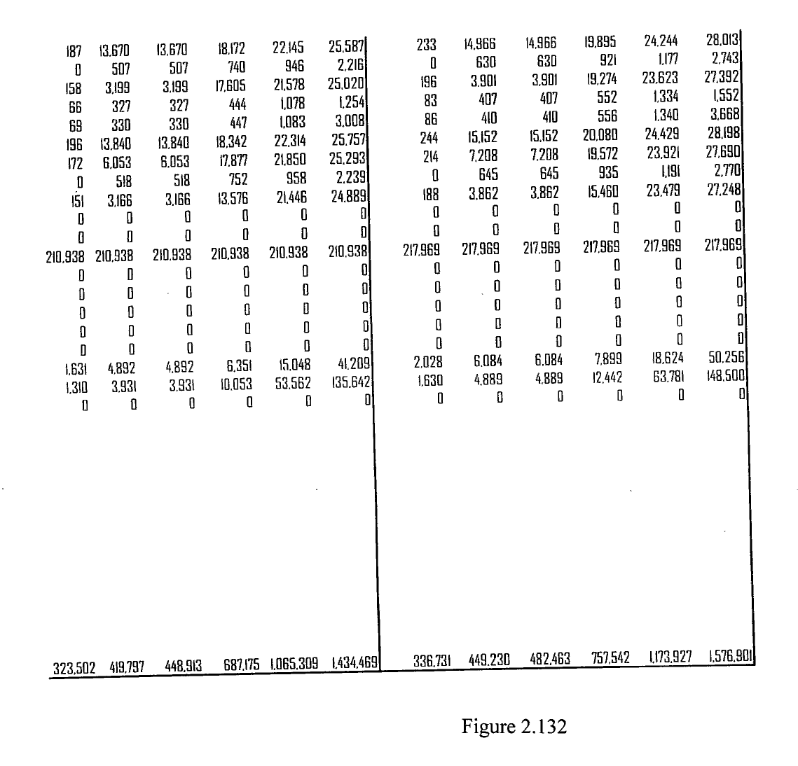

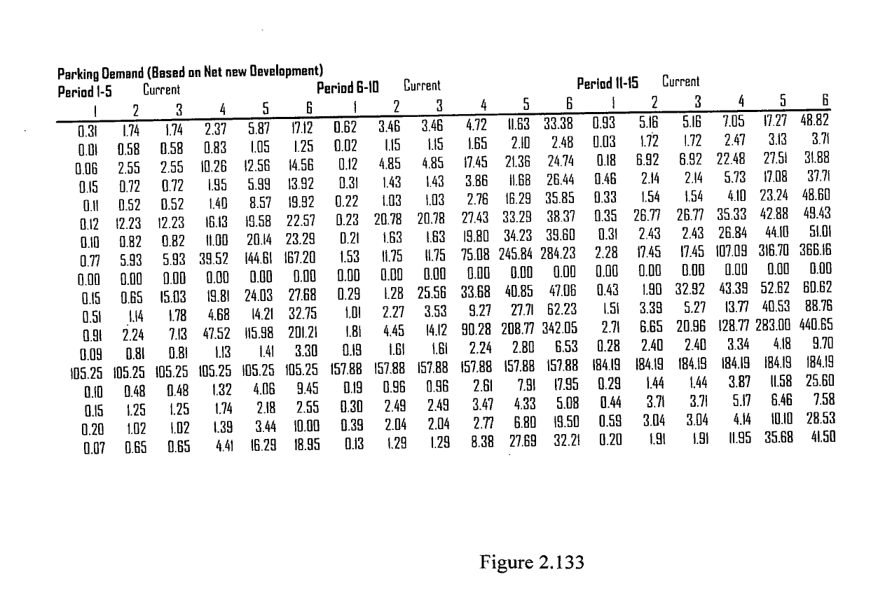

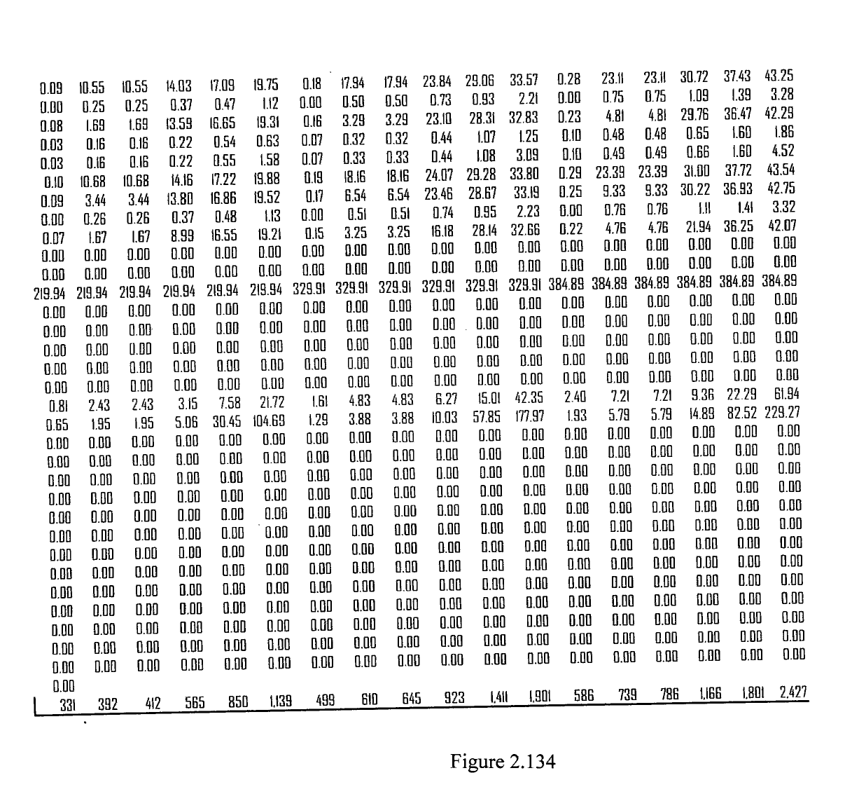

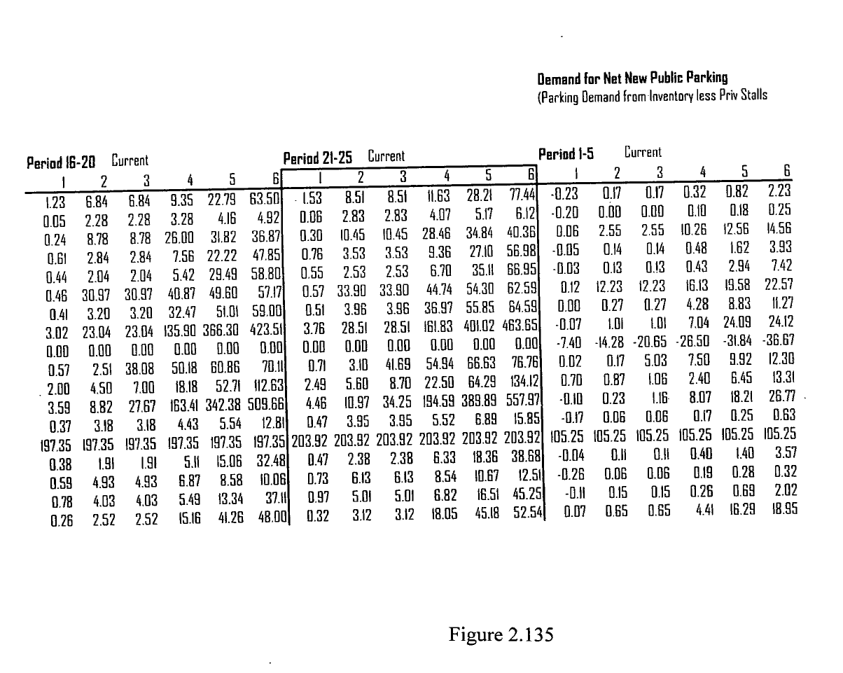

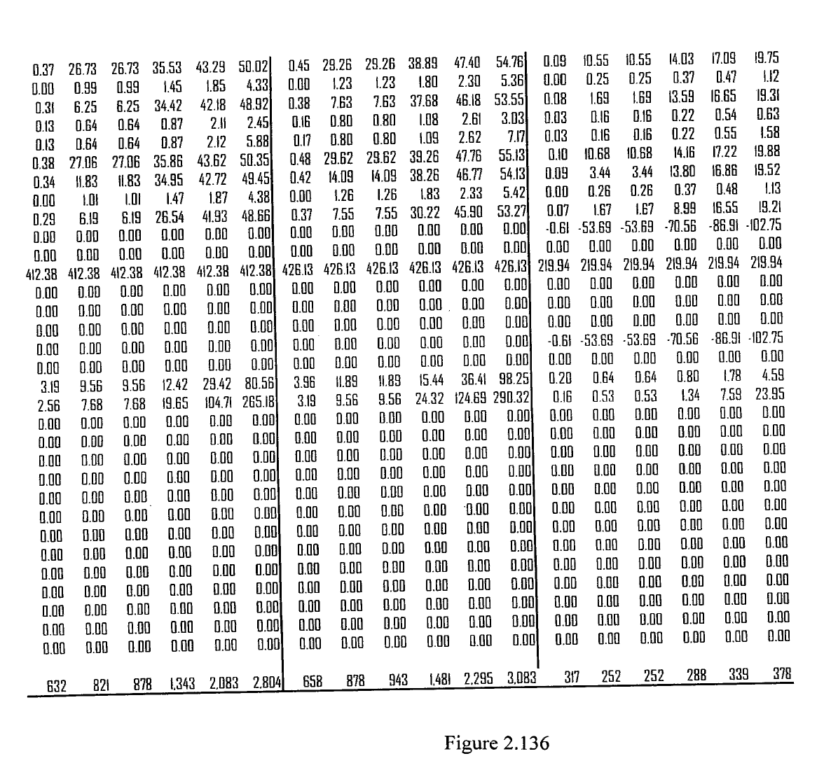

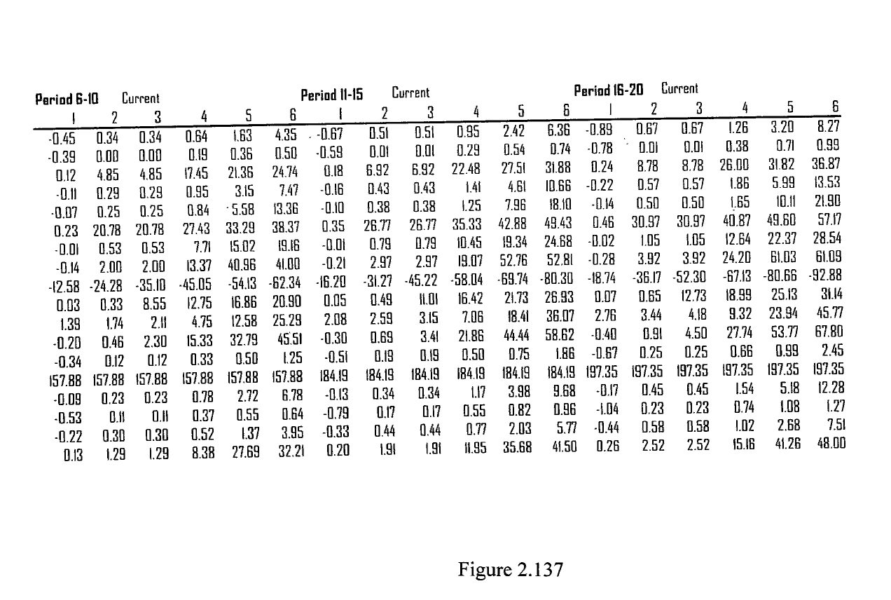

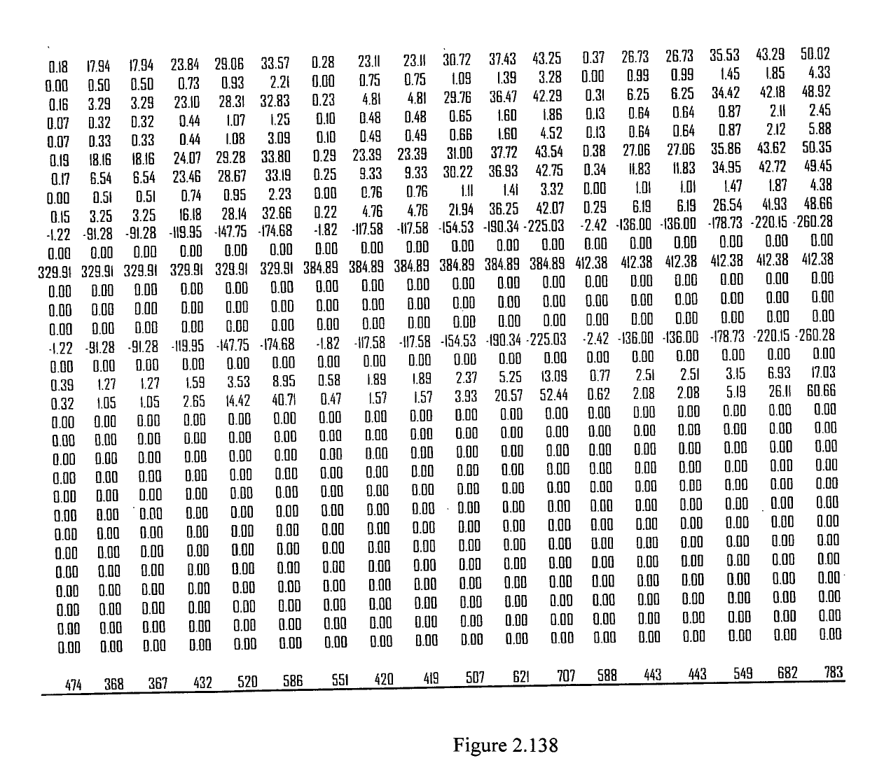

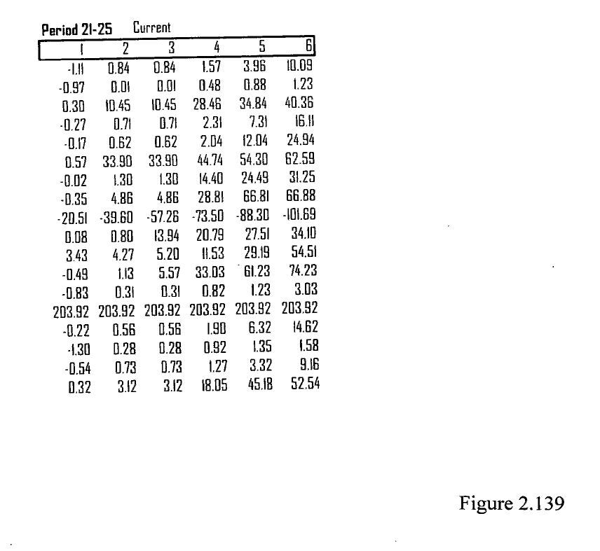

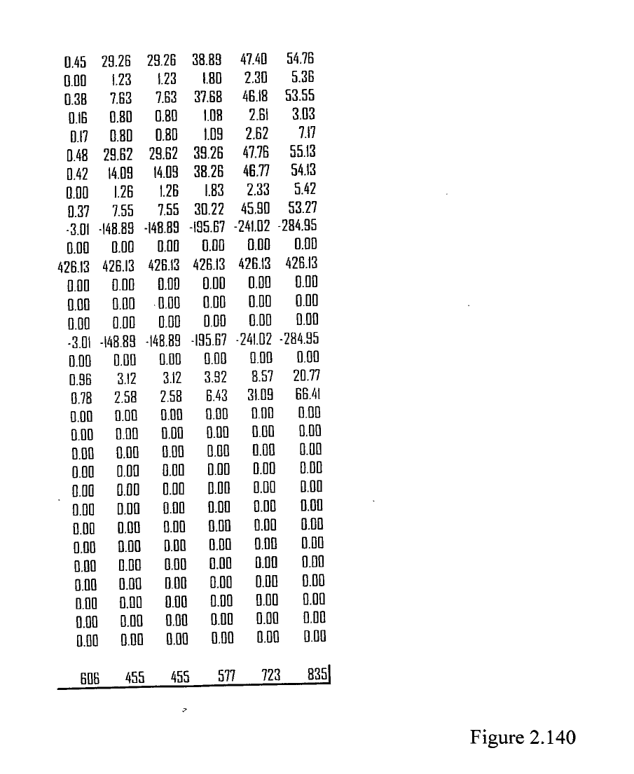

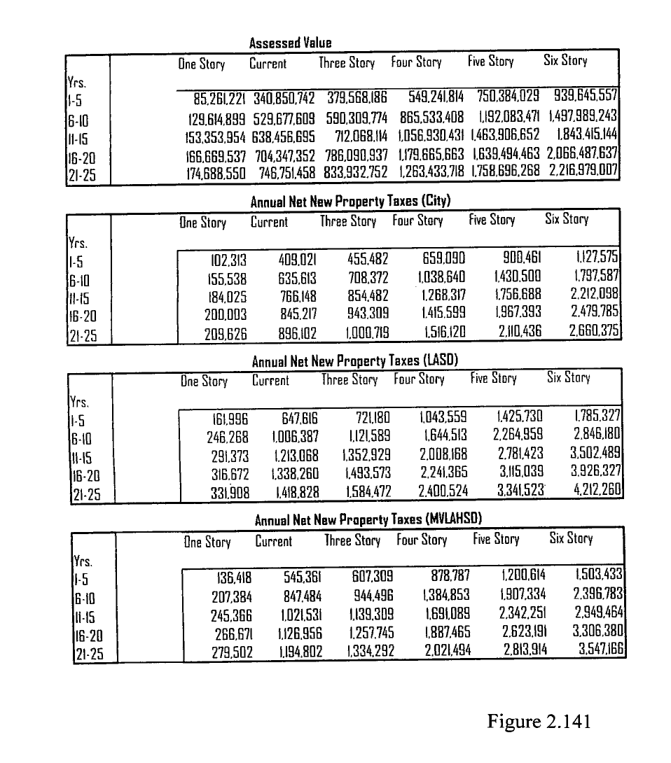

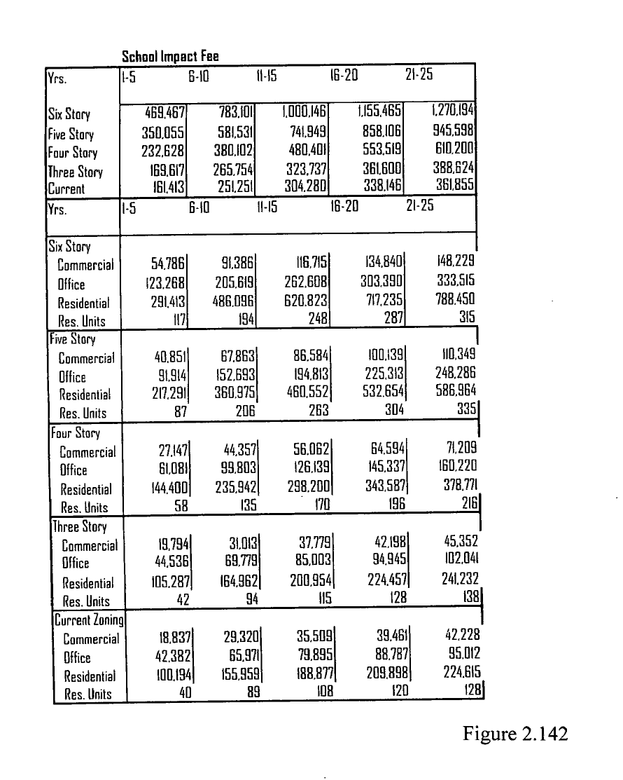

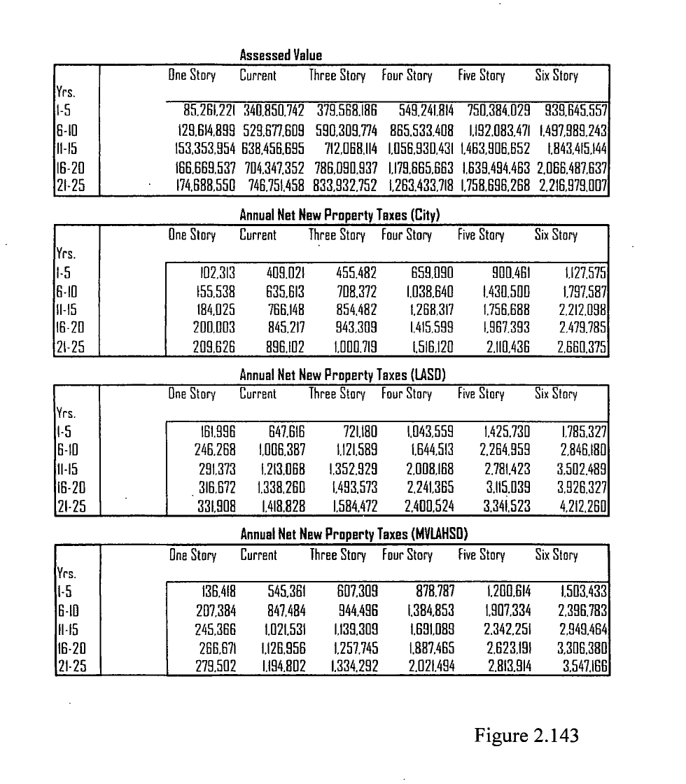

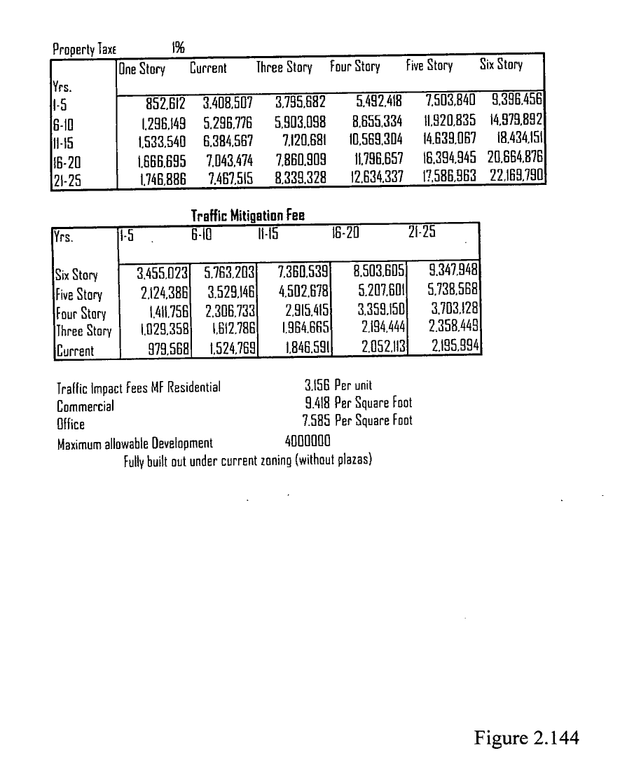

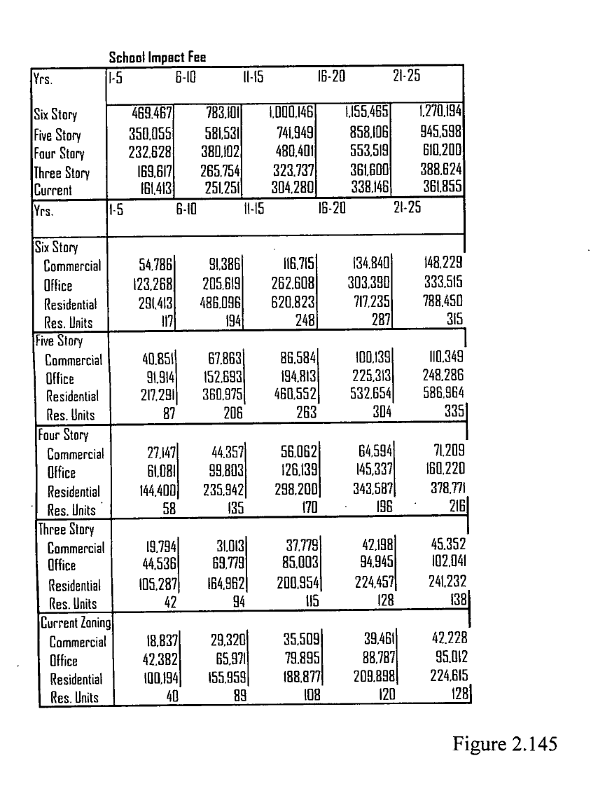

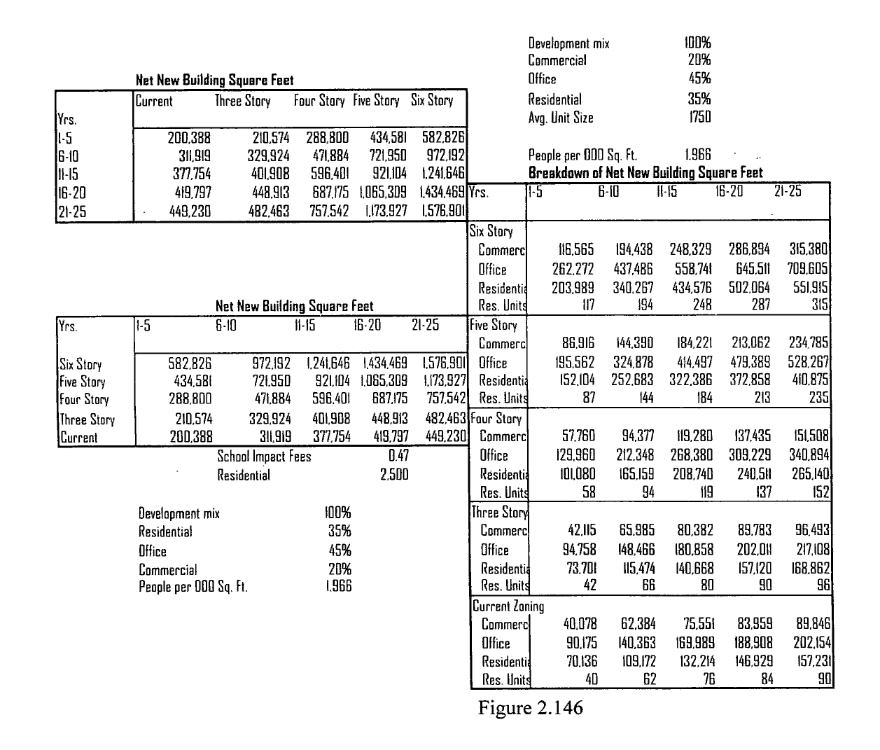

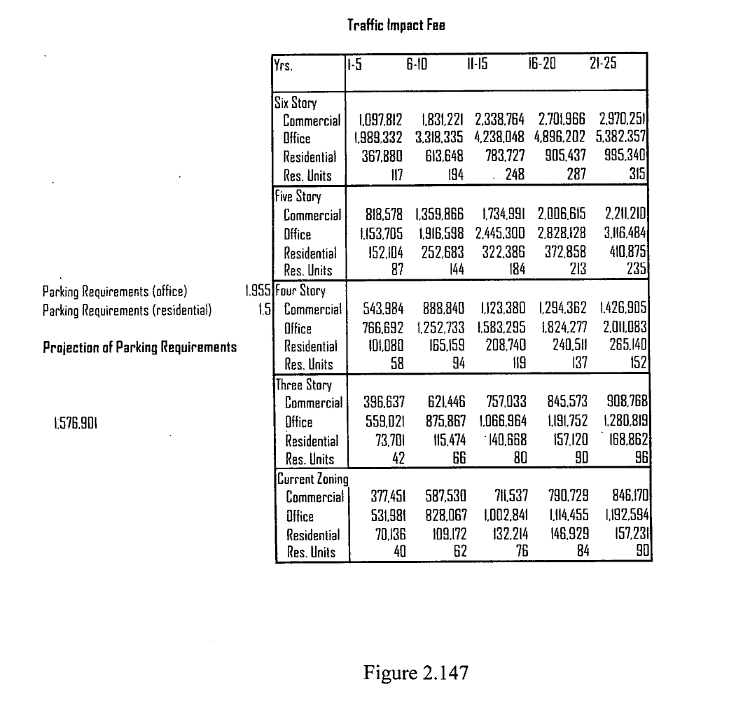

Once the property record or database is established, a pre-development land value and a post-development land value planning tool is used to analyze the data. The one page spreadsheet shown in FIG. 1 displays this relationship. FIG. 1 is a one-at-a-time analysis of an individual property. This example (with some exceptions) can be used to apply to every single property in a database, as shown in FIG. 2.

The planning tool preferably comprises various software modules implemented using a spreadsheet application developed by applying formulas and probabilities to the property record or database. It is contemplated that each of these modules may be separately commercialized.

For programming purposes, the planning tool can use these modules to answer questions with Compass available from Proofpoint Systems, Inc. located in Los Altos, Calif. For example, a goal may be: “To increase assessed value of the zone by XX % in YY Years”. Or, another goal might be: “I want to assure that a minimum of 50% of all properties surveyed are developable”. Furthermore, using the Proofpoint Systems application, an interactive system may be configured, in which numerous users may be able to access the data and create numerous alternative regulations. From these, a number of different scenarios may be developed. Using the Proofpoint Systems application, a town or group of “stakeholders” will be able to quickly develop a consensus as goals and regulations are considered in context. That is, some regulations do not permit agreed goals to be achieved. Thus, the collective stakeholders will be able to evaluate trade-offs between these desired regulations and desired goals. Then, the planning tool can demonstrate how differences in regulatory policy will increase or decrease the number of properties where a Development Pressure Index (“DPI”) exceeds 1.5 (the approximate level at which development or redevelopment of a property or properties becomes feasible).

Considered in more detail, referring to FIGS. 1 and 2, one module of the planning tool determines the value of a pre-development property. This value is calculated by calculating the present net cash flow, capitalizing it, and adding in a calculation for replacement cost of public parking spaces.

Another module of the planning tool determines residual land value as a post-development property. This calculation is based on capitalizing the estimated value of rents for a new building and subtracting all estimated costs and expected profits. It is contemplated that each property can be analyzed based on multiple uses. For example, some possible uses are: commercial service, office, retail, industrial, restaurant, hotel, and residential. Once the market rents of these various uses are calculated, the probability of development or redevelopment feasibility should be applied to each parcel based on the relative value of the DPI.

An additional module of the planning tool calculates anticipated fees. Each applicable development fee is typically based on one of the following: (i) per property; (ii) as a function of cost (total construction costs); (iii) as a function of cost (a portion of total construction costs, for example, electrical, etc.); (iv) as a function of square footage; and (v) rooms. Some fees have allowances for existing development, while others must be estimated (such as the number of inspections, which may vary).

A further module comprising the planning tool calculates financing costs. These are generally based on the published prime interest rate plus 1% or plus 2%. Additionally, points are typically included and are charged based on the overall loan amount. These are generally 1 or 2 points. To calculate financing costs, equity requirements, return on equity, construction loan costs, months of construction, months to lease-up, and required profit are considered as factors.

Another module of the planning tool computes construction costs. These are generally uniform for four stories and below. Five stories and above typically requires a different structural approach, and costs can rise from the base to a slightly larger number. The construction cost module preferably accounts for this variation. Tenant improvements apply to new buildings and will be used as an allowance. One example used $50 per square foot. This is a rule of thumb for most geographical regions of the United States, but a user should be able to vary the amount. Often construction costs are available from databases as well.

An additional module comprising the planning tool computes the Development Pressure Index (“DPI”). This is the ratio between the developed property residual land value and the existing cash flow value of the existing property. It is expected that the output will yield (for each property) a value for the DPI. With this output, one can calculate the number of properties for which development or redevelopment is economically workable and the level of pressure on those properties to be developed/redeveloped. In the case of multiple properties as shown in FIG. 2, the DPI for an individual property can also be represented as a percentage of the whole in terms of properties and square footage, as shown in FIG. 1. By way of example, the property shown in FIG. 1 corresponds to the property in line 12 of the spreadsheet shown in FIG. 2.

The planning tool also preferably comprises a development projection module. By applying probability factors to varying Development Pressure Indexes, it is possible to project the overall development of a particular area. Parcels can be designated for development/redevelopment in the order of DPI (highest will develop soonest). Once this step is completed, the parcel is no longer part of the projection for the whole, but it is included as new development for calculating eventual development/redevelopment of the remaining area. Furthermore, development or redevelopment typically has a “limiter”. This is an overall limit on the rate of absorption of each type of construction. However, in Los Altos, Calif., for example, there is no effective limiter, because the city can grab market share from neighboring communities (such as Mountain View, Calif.). On the other hand, in many communities, the user will impose a limit on development to a given number of square feet per year of each type of construction based on the user's projection of development absorption.

A people projection module also comprises the planning tool. This module uses the development projections and the observed uses of current buildings existing on properties to project the census of people in the project area. “Synergistic” factors can also be applied, that will indicate an increase in activity when people level factors create a “draw” away from other nearby competing areas or from increased activity by those who are already present. Currently, this will be a factor based on observations of nearby areas, such as towns, shopping centers, and districts. As the database increases, one will be able to refine this quotient.

An additional module of the planning tool is the parking projection module. Parking generation rates can be based either on a projection in view of current database projections or they can be estimated based on the user's own observations which may be more accurate. For example, for each street segment and each parking lot, the user can take a one-day (or longer) survey on an hourly basis to determine hourly peak usage. Then, observations can be made at that peak time for each lot on a daily basis to determine usage. It is recommended that the largest 10 to 20 private lots for each use (retail or office or other) be surveyed for two to four weeks during peak usage times. For each use, the user adds the parking lots together to simulate one large parking lot for each use and then takes the 85^{th} percentile of the peaks on a consolidated basis, compares the demand to the square footage of the buildings, and, then, determines demand based on a 15% vacancy rate. This will generate a given demand for the particular use in a given zone. Once the parking generation rate is determined, the parking demand can be ascertained. Parking demand can be used to determine when a parking garage should be built. Also, by applying meter rates and prospective parking permit prices, as well as enforcement revenues, it is possible to project parking revenues.

The planning tool also comprises a sales tax projection module. The projected sales tax is based on current sales tax receipts adjusted upwardly based on the people projection described above.

A property tax projection module is also preferably incorporated in the planning tool. Property tax receipts are calculated based on the estimated increase in assessed value of the properties.

A projected cash flow module also preferably comprises the planning tool. This module analyzes, over a selected period, estimated revenues received and expenses incurred. In one example of the planning tool, this module may include only the cost of construction and estimates revenues of parking garages, but it can be extended to all facilities.

Another module that preferably comprises the planning tool is the synergistic effect module. This module applies a synergistic factor based on increases in people and sales tax caused by the city or other entity becoming a “draw”. Once numbers of people and amenities reach a certain level, then the area will act as a draw from neighboring areas resulting in additional revenues.

Although the above-described modules constitute one example, it is contemplated that other modules may be added. For example, one or more modules can be added to perform any other related calculations that can be tied to development or redevelopment and people projection and revenue projection. Other modules are also contemplated. For example, reductions in greenhouse gases can be calculated for communities using this data.

One example of the planning tool comprises a general database. This should preferably utilize one type of record combined, as property could move from public to private; and as property is developed, it will take on the characteristics of private property. Nonetheless, there are certain attributes that will only be for public properties, and some that will only be for private. These have been differentiated only for the purpose of highlighting the specifics of the different ownerships.

Considered in more detail, the property record or database preferably contains various data. This data preferably comprises the following.

Census of publicly owned properties. For each parcel or street the following is needed:
i. For each street segment, number of parking stalls, length (distance in feet), and right-of-way size (property edge to property edge).
ii. For each mixed-use parcel, building size, parking stalls and size, and other uses.
iii. For each park, square footage and development cost.
iv. A serial number assigned for each parcel.

2. Census of privately owned properties. For each parcel the following is needed:
i. Property owner.
ii. Parcel No. (assigned by the county).
iii. Serial No. (this is arbitrary and is assigned in a “walking around” mode by the user.
iv. Square feet of land. How big is the property?
v. Square feet of building. How big is the existing building?
vi. What are the existing rents (this is used in property valuation)?
vii. How many public parking stalls are present?
viii. How many private parking stalls are present?
ix. What is the actual use? There may be several different uses for each parcel (the planning tool preferably allows up to 200 different uses to account for shopping centers).
x. How is the use categorized? Retail, commercial, office, hotel, restaurant, or service?
xi. Sales tax revenue attributable to a particular use.
xii. What is the assessed value of the property?
xiii. Other information.

Additionally, one example of the planning tool receives various inputs (variables).
These variables preferably include the following.
1. Cap. Rate. Capitalization rate (there is preferably a default rate based on user observation and then a possibility of using specific cap rates for particular properties or uses).
2. Parking Stalls. This variable is the replacement cost of parking spaces. There are several different costs possible: (i) one for surface parking; (ii) one for structured parking above grade; (iii) one for structured parking one level below grade; (iv) two levels below grade; and (v) three levels below grade with a field for “extra” costs such as an extra thick concrete floor. Preferably, there is also a field for annual costs.
3. Parking Stall Allowance. This is an allowance for parking stalls. In one example of the planning tool, there is a switch for on or off the “plaza”. In the general case this is a placeholder and calculator for parking stalls that have already been prepaid by the owner. That is, they are allowed a certain number of stalls by the city or other governmental entity, as they have paid into a parking district or are part owner of an existing lot or structure. In this case, the allowance may be based on square footage of the land, square footage of the building, or an actual number of stalls.
4. Rents. For each floor of pre-development property and post-development property, a rental rate will need to be assigned. These rental rates will be used to calculate values. Typically, the rents are NNN (net of taxes, net of insurance, net of all other costs). That means that the rental returns are calculated based on the net receipts to the landlord/owner.
5. Load Factor. All buildings must allow for staircases and elevator lobbies, bathrooms, and hallways. Some of these are treated as amenities by tenants and can be added to the floor space for which rent is paid. Some, however, cannot be. This is where the term “Load Factor” arises. The Load Factor varies based on the building's frontage and shape. Various load factors may be used depending on the effective width of the parcel. Preferably, the planning tool smoothes out the curve and uses a function to calculate the Load Factor.

Additionally, the planning method is particularly adaptable to computer software executed by a computer for projecting regulated development or redevelopment outcomes, and it is in this context that the examples of the system in accordance with the present invention will be described. It will be appreciated, however, that the planning system in accordance with the present invention has greater utility, since the system may be used for other types of planning not specifically described herein. Accordingly, the examples of the planning system in accordance with the present invention is an example only, and is not intended to limit the scope of the present invention to projecting regulated development or redevelopment outcomes, as the principles of the present invention apply generally to planning any type of regulated project.

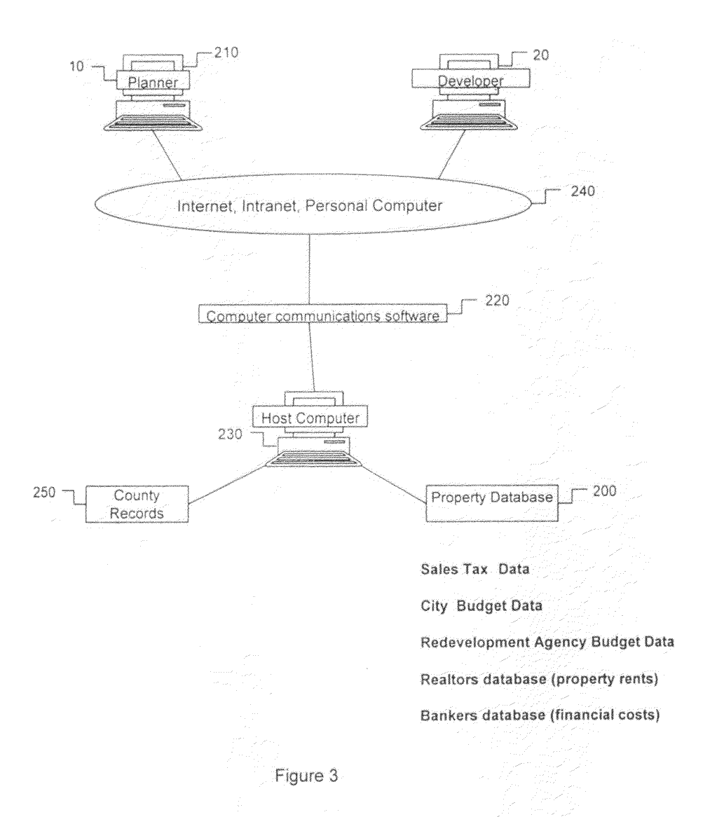

Referring now to FIG. 3, various components of an example of a planning system in accordance with the present invention are shown. Generally, the purpose of the planning system is to enable a planner to project the economic workability of a regulated development or redevelopment by having at least one property record and typically data for multiple properties in a database 200 pursuant to county records 250. As shown in FIG. 3, the database 200 may also store sales tax data, city budget data, and redevelopment agency budget data, and may additionally store property rents and financial costs (or the planning system may be provided with access to a Realtors database storing such property rents and a bankers database storing such financial costs). The planners 10 may include an individual(s) and/or a planning department who are responsible for administering regulations applicable to development or redevelopment projects. The planning system provides a platform which enables efficient projection of regulated development or redevelopment outcomes by a planner 10 and preferably also provides access to a potential developer or other interested person 20, as follows.

As shown in FIG. 3, a planner 10 may access and interact with the planning system by a communication medium such as the Internet (including the World Wide Web) or intranet and personal computer 210, or any other electronic techniques and devices that have communication capability with Internet, intranet, or television, for example, such as personal computers, personal data assistants (PDA's), cellular telephones, and other personal communication equipment and computer communications software 220 that interfaces the planner and a host computer 230.

The planning system preferably comprises a software application operating on the host computer 230, as shown in FIG. 3. For example, the host computer 230 may be any personal computer having at least 256 megabytes of random access memory and preferably includes one gigabyte of random access memory. The planning system in accordance with one exemplary implementation of the present invention is a 32-bit software application compatible with a Microsoft Windows 2000 or Windows NT or later operating system available from Microsoft Corporation located in Redmond, Wash. The host computer 230 also preferably comprises a hard disk drive having at least 40 gigabytes of free storage space available. The host computer 230 is provided with the Internet or World Wide Web or intranet connection 240 for connection to one or more planners 10. The connection 240 comprises a high-speed connection, for example, a DSL or greater connection, and is preferably a T1 or faster connection. In one example of the planning system, planners 10 can be ported to the Internet or World Wide Web or intranet and development or redevelopment economic feasibility analyses and other transactions may be performed by the host computer 230. In another example of the planning system, development or redevelopment economic feasibility analyses and other transactions may be preformed by personal computers 210 associated with planners, such as posting of notices, regulations, requests for bids, or the like.

As mentioned earlier, the planning system also comprises computer software or code comprising various modules described above. In the one example, the planning system computer software or code can be a hosted application that runs on the host computer 230. In an alternative example, the software or code can comprise a client installed on or downloaded to the personal computers 210 of the planner 10 and executed locally. Thus, the computer software or code may be initially supplied to planners 10 on a CD-ROM or other electronic medium or downloadable over the Internet or World Wide Web or intranet 240.

In accordance with one example of the planning system of the present invention, the software or code may additionally comprise other software applications such as word processing as well as spreadsheet application software. One example of a word processor that can be utilized in the various examples of the planning system in accordance with the present invention is Word, and one example of a spreadsheet is Excel, both commercially available from Microsoft Corporation. Also, the planning methodology may be implemented using ASP (the programming language used by Proofpoint Systems)

While the foregoing description has been with reference to particular examples of the present invention, it will be appreciated by those skilled in the art that changes in these examples may be made without departing from the principles and spirit of the invention. For example, the issue of designated public spaces can be included in an analysis in the spreadsheets. That is, the planning method and system can be modified to be able to designate publicly owned property for a particular outcome. For instance, streets will generally remain streets (but at times they may be converted to developable property). Parking lots may become parking structures or surface parks or may be a combination of a parking structure and building. In general, these designated public improvements will be “scheduled” based on the availability of cash from a variety of sources (mixed use public properties will have cash available to assist in the development, but it may not be sufficient by itself). It will be up to the user to prioritize the construction of various public parcels. The planning method and system may also simulate the development or redevelopment of the city or other area by assigning particular parcels to develop based on the highest DPI. For example, if the development of at least 200,000 square feet is forecast over the next year, then one should conclude that a 150,000 square foot building will be developed if it has the highest DPI. Accordingly, the scope of the present invention can only be ascertained with reference to the appended claims.

What is claimed is:

1. In a method for planning in which a city or other governmental entity has adopted a number of regulations that affect the development potential for land within its boundaries, the improvement comprising the steps of examining the effect of regulations on each parcel of land, and determining whether changing the regulations can cause each individual parcel to be more likely to be developed with a new use.

2. A planning method comprising the steps of examining attributes comprising one or more attributes selected from among the group of attributes consisting of cash flow, parking, dimensions, street frontage, or other specific attributes of each individual parcel in a city or other governmental entity; analyzing current financial markets and trade value of recent property transactions; and determining an appraisal value of existing uses of selected property.

3. A planning method to determine the residual land value to a prospective developer, even if that value is to the existing landowner who intends to develop the property himself, by examining existing regulations and fees of a city or other governmental entity, other fees, the financial markets, local construction costs, prevailing required developer returns, and other related matters relating to development or redevelopment costs.

4. The planning method of claim 3, further comprising determining a relative value by which the residual land value must exceed an appraisal value of existing uses of property before there is real impetus to redevelop property by examining transaction costs to an owner, including state and Federal capital gains taxes, brokerage fees, closing costs, and other related costs, as well as risk of entering into any transaction.

5. The method of claim 1, further comprising projecting a range of values that a city or other governmental authority can apply to its regulations that affect property values by surveying existing data.

6. The planning method of claim 4, further comprising determining the likelihood of any particular parcel being redeveloped in any given year by applying experience data, applying probability theory, and assigning probabilities to the likelihood of redevelopment of a parcel over a given period of time based on the assigned probabilities.

7. The planning method of claim 6, further comprising the steps of assigning probabilities to multiple parcels in a given area and projecting, over time, a likely development scenario for the given area.

8. The planning method of claim 2, further comprising projecting the number of people in an area examined and the progression of tax and parking revenues to a city or other governmental entity, local school districts, and other applicable taxing entities based on development projections and an applicable “synergy” factor.

9. The planning method of claim 2, further comprising projecting a rate at which amenities such as parks, parking garages, and other public benefits will be generated based on tax and parking revenues.

10. The planning method of claim 1, further comprising creating alternative scenarios for development or redevelopment of property based on different regulations that may be imposed by a city or other governmental entity.
